(19) United States
(12) Patent Application Publication
(10) Pub. No.: US 2013/0298006 A1
(43) Pub. Date: Nov. 7, 2013

(54) SYSTEM AND METHOD FOR PROVIDING SOFTWARE TOOLS WITHIN AN ONLINE PLATFORM FOR ORGANIZING GROUPS AND COMMUNICATING WITH MEMBER CLIENTS OF GROUP

(71) Applicant: OurGroup, Inc., (US)

(72) Inventors: Bradley Lawrence Good, Pasadena, CA (US); Markus Hagen, Glendale, CA (US)

(73) Assignee: OurGroup, Inc., Pasadena, CA (US)

(21) Appl. No.: 13/801,521

(22) Filed: Mar. 13, 2013

Related U.S. Application Data
(63) Continuation-in-part of application No. 13/553,575, filed on Jul. 19, 2012.
(60) Provisional application No. 61/510,016, filed on Jul. 20, 2011.

(51) Int. Cl. G06F 17/22

(52) U.S. Cl. CPC G06F 17/2247
USPC 715/234

(57) ABSTRACT

A system and method for providing software tools within an online platform for organizing groups and facilitating communications among member clients of the groups are disclosed. Sub-groups can be created hierarchically below an umbrella group, where information associated with a sub-group is automatically shared with the umbrella group. A standardized set of tools is provided to facilitate philanthropic efforts by volunteer organizations, groups, companies, schools, and individuals.

### CROSS-REFERENCES TO RELATED APPLICATIONS

This application is a continuation-in-part of U.S. patent application Ser. No. 13/553,575, entitled “SYSTEM AND METHOD FOR PROVIDING SOFTWARE TOOLS WITHIN AN ONLINE PLATFORM FOR ORGANIZING GROUPS AND COMMUNICATING WITH GROUP MEMBERS”, filed Jul. 19, 2012, which in turn claims priority to U.S. provisional application No. 61/510,016, entitled “SYSTEM AND METHOD OF PROVIDING AN ONLINE PLATFORM FOR GROUP FUNDRAISING CAMPAIGNS”, filed Jul. 20, 2011.

### BACKGROUND

Non-profit organizations, volunteer organizations, companies, and other groups often have an online presence in order to facilitate awareness of the groups' goals and communication among member clients of the group and to increase operational efficiency. Traditionally, these groups invest in an information technology department that provides technical support and maintains the group's online presence. However, the software tools available to manage and administer the groups can be limited or very expensive. By providing access to emails and notifications for the registered client on any webpage supported by the online platform, there are fewer requests to the server for transmitting webpages. It would be preferable for groups to have access to highly functional and useful technical tools that perform this function without having to maintain the tools.

### SUMMARY

In one scenario, a registered client of an online platform requests webpages supported by the online platform. Additionally, other registered clients can email the first registered client, or the system can send notifications to the first registered client. On each webpage transmitted to the registered client, the online platform server displays an indication of a number of unread emails that have been sent to the registered client, an indication of a number of new notifications sent to the registered client, and/or an indication of a number of new requests for the registered client. Upon request by the registered client, the server provides access to the unread emails, new notifications, and new requests while the registered client is accessing the currently transmitted webpage.

In a first aspect, a method of providing access to information intended for a registered client of an online platform to the registered client on each webpage associated with the online platform transmitted to the registered client is disclosed. The method includes receiving one or more emails at a server of the online platform for the first registered client from one or more other registered clients of the online platform; upon receiving by the server login information from the first registered client for logging into the online platform, causing to be displayed a personalized dock, wherein the personalized dock is displayed on each webpage of the online platform transmitted to the first registered client, and further wherein the personalized dock provides an indication of a first number of unread emails that have been sent to the first registered client from other registered clients and a first clickable button for viewing emails; and upon receiving an indication by the server of a click at the first registered client on the first clickable button, causing be displayed at least some of the first registered client's unread or previously read emails in a dropdown format overlaid on a current webpage of the online platform being transmitted to the first registered client.

The method further includes upon receiving an indication by the server of a click at the first registered client on one of the emails in the dropdown format, providing the first registered client with a menu of email options for the one of the emails. The dropdown format includes a clickable option to see all email messages for the first registered client on a separate webpage.

The method of claim further includes receiving one or more notifications at the server for the first registered client of the online platform, wherein a notification is a result from one or more other registered clients of the online platform on content the first registered client posted to the online platform, wherein the personalized dock further includes an indication of a second number of new notifications for the first registered client and a second clickable button for viewing notifications; and upon receiving an indication by the server of a click by the first registered client on the second clickable button, causing to be displayed at least some of the first registered client's new or previously read notifications in the dropdown format overlaid on the current webpage of the online platform being transmitted to the first registered client. The dropdown format includes a clickable option to see all notifications for the first registered client on a separate webpage.

The method further includes receiving one or more requests at the server for the first registered client of the online platform, wherein a request includes a connection request from another registered client of the online platform or a group membership request to join a particular group associated with the online platform, wherein the personalized dock further includes an indication of a third number of new requests for the first registered client and a third clickable button for viewing the requests; and upon receiving an indication by the server of a click at the first registered client on the third clickable button, causing to be displayed at least some of the first registered client's new or previously read requests in the dropdown format overlaid on the current webpage of the online platform being transmitted to the first registered client. The dropdown format includes a clickable option to see all requests for the first registered client on a separate webpage.

The method further includes receiving by the server profile information from the first registered client, wherein profile information includes a name of the first registered client; generating by the server a profile page associated with the online platform for the first registered client; causing to be displayed by the server on the personalized dock the name of the first registered client; and upon receiving an indication by the server of a click at the first registered client near the name on the personalized dock, causing to be displayed the profile page.

In another aspect, a server for providing access to information intended for a registered client of an online platform to the registered client on each webpage associated with the online platform transmitted to the registered client is disclosed. The server includes an email receiving module configured to receive one or more emails for the first registered client from one or more other registered clients of the online platform; a dock display module configured to cause to be displayed a personalized dock upon receiving login information from the first registered client for logging into the online platform, wherein the personalized dock is displayed on each webpage of the online platform transmitted to the first registered client, and further wherein the personalized dock provides an indication of a first number of unread emails that have been sent to the first registered client from other registered clients and a first clickable button for viewing emails, wherein the dock display module is further configured to cause to be displayed at least some of the first registered client's unread or previously read emails in a dropdown format overlaid on a current webpage of the online platform being transmitted to the first registered client upon receiving an indication of a click at the first registered client on the first clickable button.

The server further includes a dock email menu module configured to, upon receiving an indication by the server of a click at the first registered client on one of the emails in the dropdown format, provide the first registered client with a menu of email options for the one of the emails. The dropdown format includes a clickable option to see all email messages for the first registered client on a separate webpage.

The server further includes a notifications receiving module configured to receive one or more notifications for the first registered client of the online platform, wherein a notification is a result from one or more other registered clients of the online platform on content the first registered client posted to the online platform, wherein the personalized dock further includes an indication of a second number of new notifications for the first registered client and a second clickable button for viewing notifications, wherein the dock display module is further configured to, upon receiving an indication of a click by the first registered client on the second clickable button, cause to be displayed at least some of the first registered client's new or previously read notifications in the dropdown format overlaid on the current webpage of the online platform being transmitted to the first registered client. The dropdown format includes a clickable option to see all notifications for the first registered client on a separate webpage.

The server further includes a request receiving module configured to receive one or more requests for the first registered client of the online platform, wherein a request includes a connection request from another registered client of the online platform or a group membership request to join a particular group associated with the online platform, wherein the personalized dock further includes an indication of a third number of new requests for the first registered client and a third clickable button for viewing the requests, wherein the dock display module is further configured to, upon receiving an indication by the server of a click at the first registered client on the third clickable button, cause to be displayed at least some of the first registered client's new or previously read requests in the dropdown format overlaid on the current webpage of the online platform being transmitted to the first registered client. The dropdown format includes a clickable option to see all requests for the first registered client on a separate webpage.

The server further includes a profile receiving module configured to receive profile information from the first registered client, wherein profile information includes a name of the first registered client; a profile page generation module configured to generate a profile page associated with the online platform for the first registered client, wherein the dock display module is further configured to cause to be displayed on the personalized dock the name of the first registered client, and further wherein the dock display module is further configured to, upon receiving an indication of a click at the first registered client near the name on the personalized dock, cause to be displayed the profile page.

### BRIEF DESCRIPTION OF THE DRAWINGS

Examples of an online platform that provides standardized software tools for organizing groups and facilitating communications among member clients of groups are illustrated in the figures. The examples and figures are illustrative rather than limiting.

FIG. 1A illustrates a diagram of an example system where a host server provides tools for organizing groups and facilitating communications among member clients of groups.

FIG. 1B-1 depicts a block diagram illustrating an example of components of the host server.

FIG. 1B-2 depicts a block diagram illustrating an example of components of the registration module of the host server.

FIG. 1B-3 depicts a block diagram illustrating an example of components of the crisis center module of the host server.

FIG. 1B-4 depicts a block diagram illustrating an example of components of the dock module of the host server.

FIG. 1B-5 depicts a block diagram illustrating an example of components of the email module of the host server.

FIG. 1B-6 depicts a block diagram illustrating an example of components of the notifications module of the host server.

FIG. 1B-7 depicts a block diagram illustrating an example of components of the request module of the host server.

FIG. 1B-8 depicts a block diagram illustrating an example of components of the profile module of the host server.

FIG. 1B-9 depicts a block diagram illustrating an example of components of the control center module of the host server.

FIG. 1B-10 depicts a block diagram illustrating an example of components of the collaboration module of the host server.

FIG. 1B-11 depicts a block diagram illustrating an example of components of the resource contribution module of the host server.

FIG. 1C depicts a block diagram illustrating an example of databases accessed by the host server.

FIG. 2 shows an example platform home page.

FIG. 3 shows an example of an umbrella organization relative to organizations situated within the umbrella group.

FIG. 4 shows an example home page for a validated umbrella group.

FIG. 5 shows an example sub-group registration form.

FIG. 6 shows a screenshot where example basic sub-group information is entered.

FIG. 7 shows an example screenshot where the administrator module of the sub-group can import names of individuals to invite for joining the sub-group.

FIG. 8 shows an example screenshot of a page where the administrator module of the sub-group can create the invitation message to be sent to the previously selected individuals.

FIG. 9 is a flow diagram illustrating an example process for registering a child under 14 years old.

FIG. 10 shows example parental controls settings.

FIG. 11 shows example magnified views of a dock.

FIG. 12 is a flow diagram illustrating an example process for registering an adult as a member of the online platform.

FIG. 13 shows an example online registration form.

FIG. 14 is a flow diagram illustrating an example process for registering a child under between 14 and 18 years old.

FIG. 15 is a flow diagram illustrating an example process for registering a group by an individual member client.

FIG. 16 shows an example screenshot for a first step in registering a group by an individual member client.

FIG. 17 shows an example screenshot for a second step in registering a group by an individual member client.

FIG. 18 shows an example screenshot of account information maintained by the online platform that can be entered and/or edited by the member client.

FIG. 19 shows an example screenshot of queries asked by the system when a member client attempts to connect with another member client of the online platform.

FIG. 20 shows an example email sent by the system to a member client who requested a connection with a member client of the online platform who agreed to the connection.

FIG. 21 shows an example screenshot of the connections of a member client.

FIG. 22 shows an example landing page for a registered group.

FIG. 23 shows an example groups center web page.

FIG. 24 shows an example individual member client center web page.

FIG. 25 shows an example supporter page.

FIG. 26 shows an example events center page where upcoming and past events are listed.

FIG. 27 shows an example events page for a registered group.

FIG. 28 shows an example screenshot for a first step in providing resources.

FIG. 29 shows an example tribute wall.

FIG. 30 shows an example volunteer center page.

FIG. 31 shows an example listing with more information about a volunteer opportunity.

FIG. 32 shows an example sponsor center web page.

FIG. 33 shows an example web page with a project that can be supported.

FIG. 34 shows an example knowledge center page.

FIG. 35 shows an example of a general landing page that has not been customized.

FIG. 36 shows an example of a photos center web page for a registered individual.

FIG. 37 shows an example control center web page listing the available tools for managing a group.

FIG. 38 shows an example control center web page with statistics pertaining to credits and revenue for a group.

FIG. 39 shows an example control center web page with permissions given to administrator modules managing a group.

FIG. 40 shows an example screen shot where a member client is prompted regarding the sites for sharing content with.

FIG. 41 shows an example screen shot for reporting abuse.

FIG. 42 shows part of an example profile page where the member client is posting a message to the member's activity feed.

FIG. 43 shows part of an example newsfeed on a member client's profile page with a feedback bar.

FIG. 44 shows an example comment with a feedback bar.

FIG. 45 shows an example dock with unread email messages shown in a dropdown format.

FIG. 46 shows an example dock with new notifications shown in a dropdown format.

FIG. 47 shows an example of a notifications page.

FIG. 48 shows an example dock with new requests shown in a dropdown format.

FIG. 49 shows an example of a requests web page.

FIG. 50 shows an example volunteer summary page.

FIG. 51 shows an example report card itemizing a member's volunteer hours with various groups.

FIG. 52 shows an example resource contribution listing page.

FIG. 53 shows an example report card itemizing a member's resource contributions to various groups.

FIG. 54 shows an example screenshot for querying an individual member client setting up a tribute page.

FIG. 55 shows an example screenshot used to email information about a tribute page.

FIG. 56 shows an example of a tribute page.

FIG. 57 shows a content review webpage.

FIG. 58 shows an example summary of invitations sent by a group administrator module.

FIG. 59 shows a listing of recipient member clients to whom a particular invitation was sent.

FIG. 60 shows an example of a stories page for an individual.

FIG. 61 shows an example of a crisis center page for the online platform.

FIG. 62 shows an example page where profile information associated with a member client is listed.

FIG. 63 shows an example webpage provided by the content review module where an administrator module can send a message to a submitter of content regarding the administrator's review.

FIG. 64 shows an example webpage that provides an assistance link.

FIG. 65 shows a preview of a link included in an example quick message.

FIG. 66 shows an example webpage that allows an administrator module to select whether a group is moderated or unmoderated.

FIG. 67 shows an example window that facilitates the sending of a new invitation or the re-sending of a previously sent invitation to member clients.

FIG. 68 shows an example webpage where links are provided to a member client for connecting the member client's account with the online platform to the member client's account of the appropriate third party social networking site.

FIG. 69 depicts a flow diagram illustrating an example process performed by the host server of the online platform for permitting a first administrator module of an umbrella group to validate over a communication network a request by a subgroup to join the online platform under the umbrella group.

FIG. 70 depicts a flow diagram illustrating an example process performed by the host server of the online platform for aggregating and filtering information received from member clients of a plurality of groups registered with the online platform, wherein at least some of the groups are hierarchically organized.

FIG. 71A depicts a flow diagram illustrating an example process performed by the host server of the online platform for providing access to emails intended for a registered client of an online platform to the registered client on each webpage associated with the online platform transmitted to the registered client.

FIG. 71B depicts a flow diagram illustrating an example process performed by the host server of the online platform for providing access to notifications intended for a registered client of an online platform to the registered client on each webpage associated with the online platform transmitted to the registered client.

FIG. 71C depicts a flow diagram illustrating an example process performed by the host server of the online platform for providing access to requests intended for a registered client of an online platform to the registered client on each webpage associated with the online platform transmitted to the registered client.

FIG. 72 depicts a flow diagram illustrating an example process performed by the host server of the online platform for selecting one or more groups registered with an online platform for highlighting on a crisis center webpage associated with an external event.

FIG. 73 shows a diagrammatic representation of a machine in the example form of a computer system within which a set of instructions, for causing the machine to perform any one or more of the methodologies discussed herein, may be executed.

### DETAILED DESCRIPTION

A system and method for providing software tools as part of an online platform for organizing groups and facilitating communications among group member clients are disclosed. Sub-groups can be created hierarchically below an umbrella group, where information associated with a sub-group is automatically shared with the umbrella group. A standardized set of tools is provided to facilitate philanthropic efforts by volunteer organizations, groups, companies, schools, and individuals. Tools provided by the platform perform the following non-limiting functions: setting up and customizing a groups web page; listing individuals involved with a group who want to be known; listing information associated with the individual, such as resources contributed, volunteer hours, sponsored projects, ratings, and/or profiles; listing supporters of a cause; listing events planned by an organization; facilitating collaboration between individuals and groups, such as through the use of discussion and scheduling tools; providing an online location for individuals to contribute resources to volunteer organizations; providing a listing for volunteer needs; providing a knowledge center for sharing information; and providing the ability to upload photos and videos related to campaigns. Once a sub-group has been approved to join an umbrella group, the entire tool set provided by the online platform is available to the administrator module of the sub-group to customize the home page of the sub-group within the online platform and to run and manage online the sub-group's activities and members of the sub-group can use the non-administrative tools provided by the platform.

The platform provides a set of online tools that enable groups to easily and quickly set up, move existing members online, grow membership virally, involve and engage future members, and then conduct targeted marketing initiatives. The ease of use and integration of highly visual social networking capabilities facilitates individual interaction and collaboration among groups. The formation of sub-groups underneath an umbrella group fosters greater communication and coordination. As members of groups move online, these groups will have access to valuable user profile information that can be used to conduct focused campaigns for accumulating credit.

Various aspects and examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in this Detailed Description section.

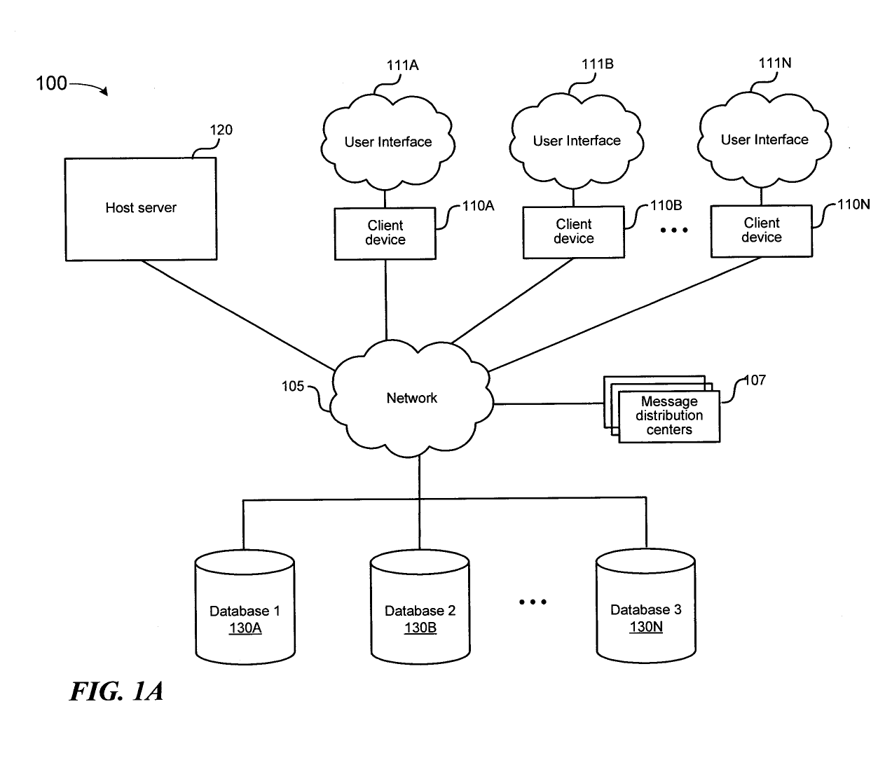

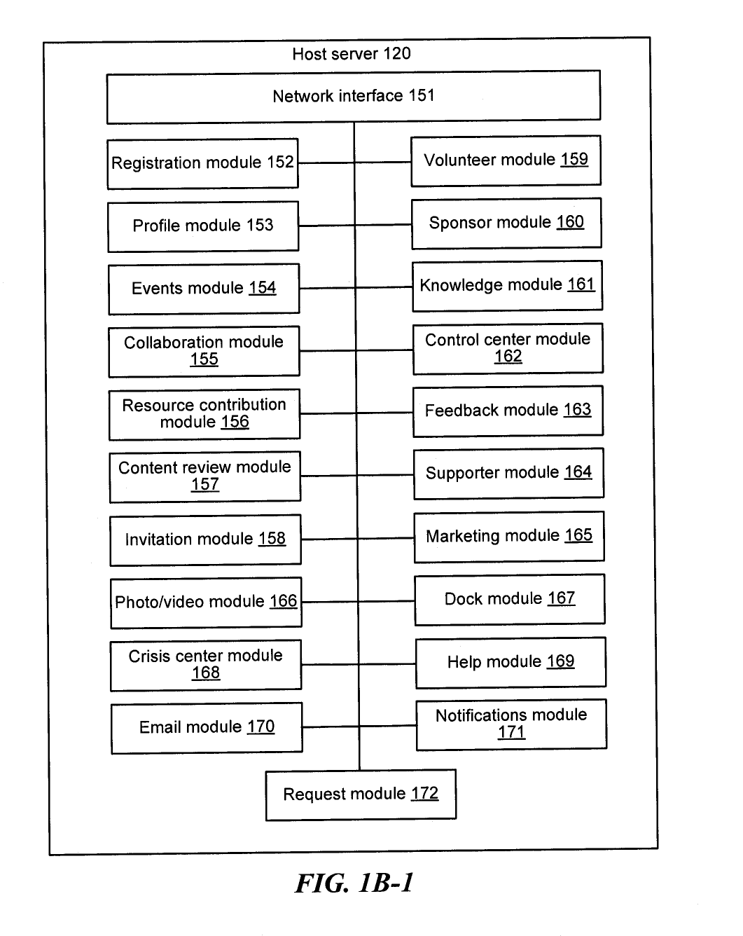

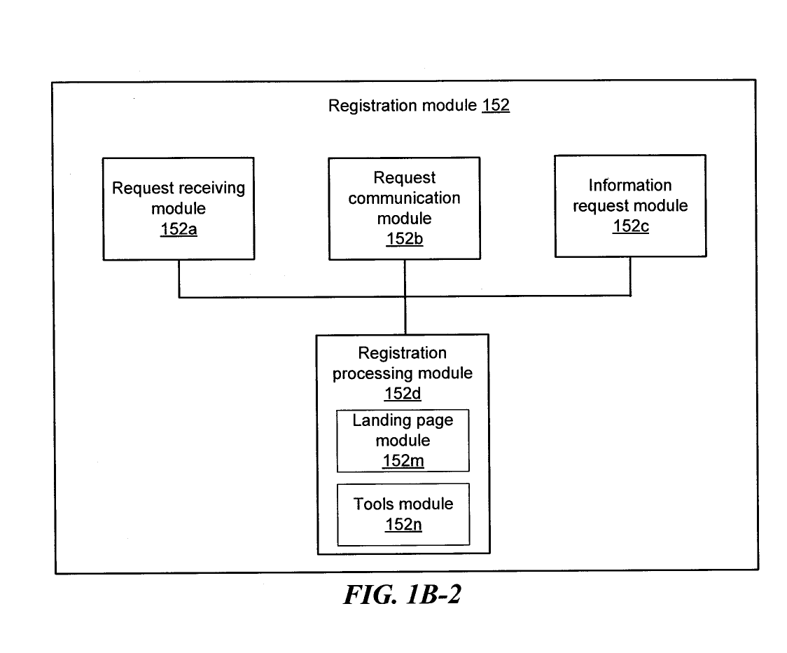

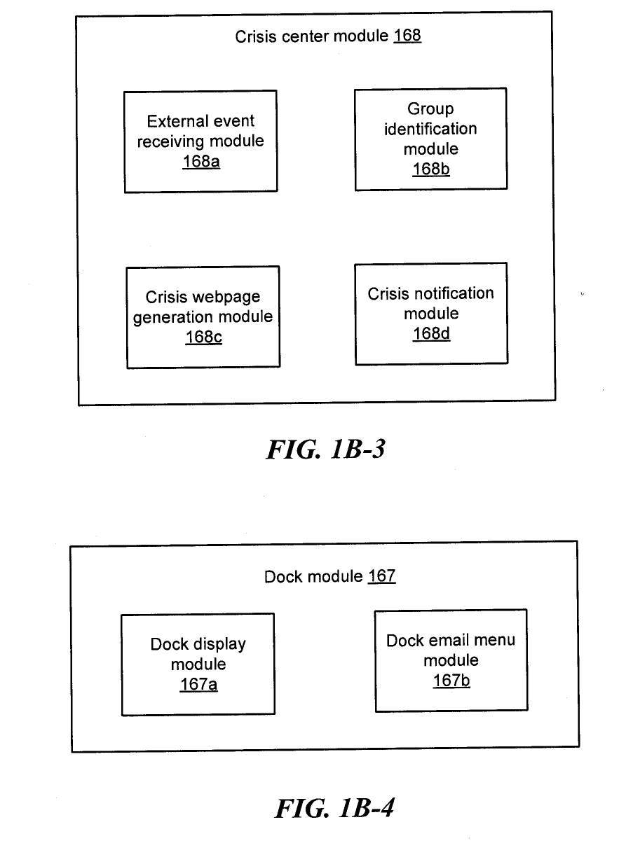

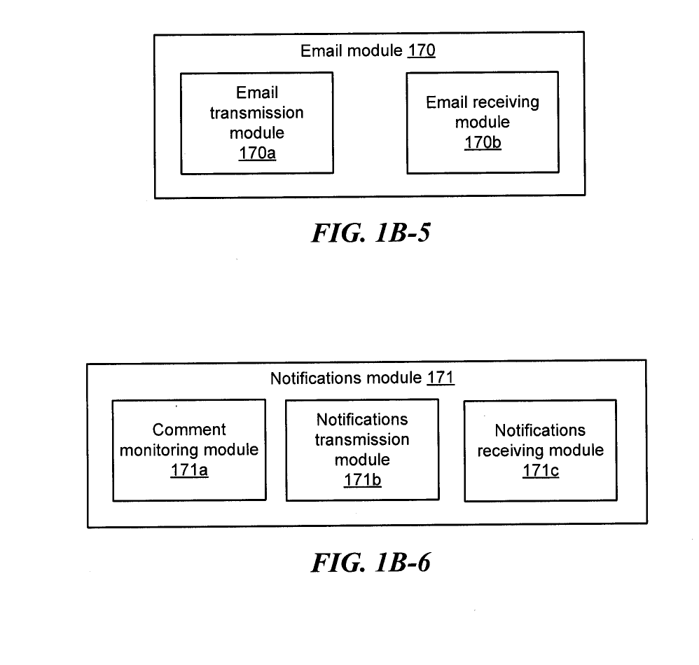

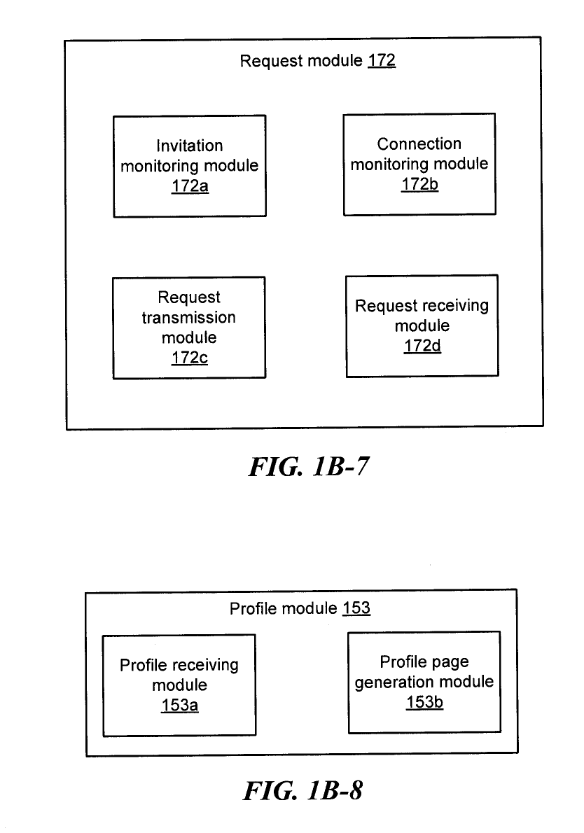

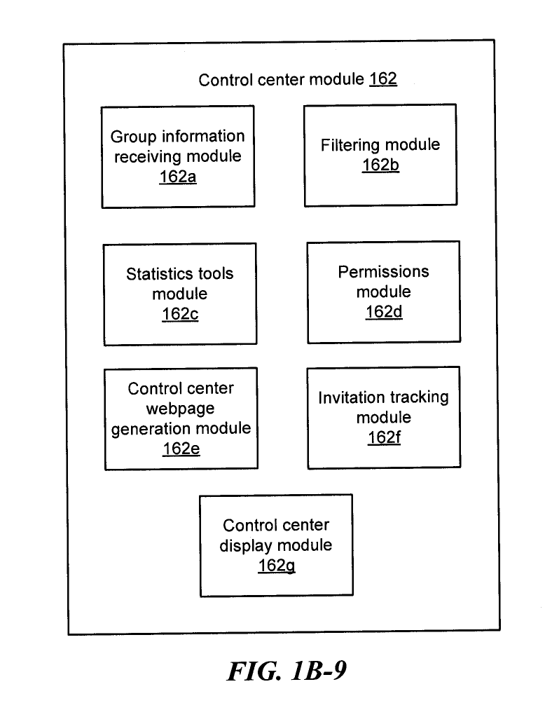

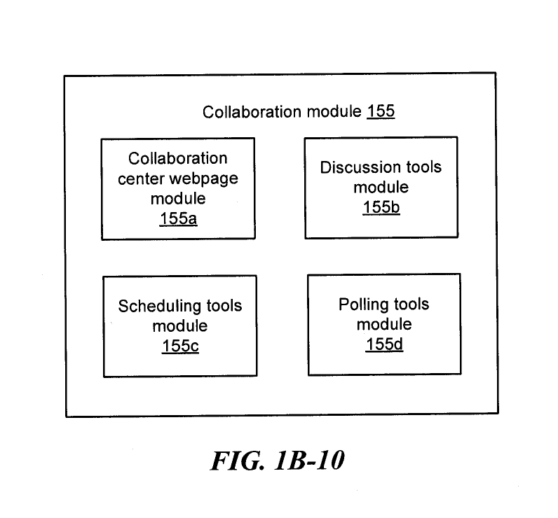

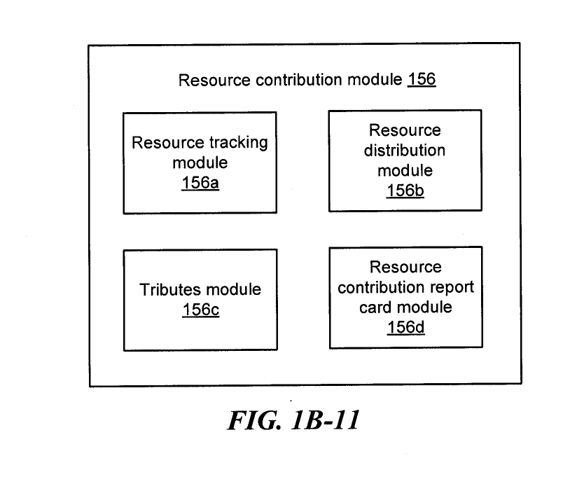

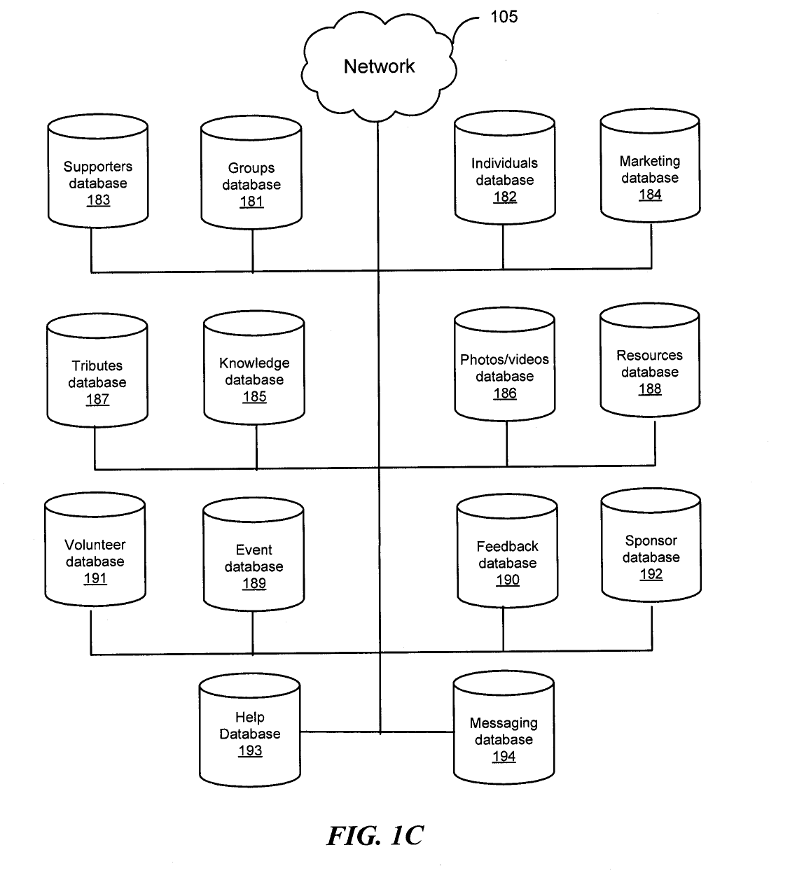

FIG. 1A illustrates a block diagram of a general environment in which an online platform that provides tools for organizing groups and facilitating communications among group member clients can be implemented. Example client devices 110A-N with user interfaces 111A-N, a host server 120, and various databases 130A-N are coupled to a network 105. More than one host server 120 can be coupled to the network 106. Only one host server is shown in FIG. 1A for clarity.

The client devices 110A-N can be any system and/or device, and/or any combination of devices/systems that is able to establish a connection with another device, a server and/or other systems. The client devices 110A-N typically include display or other output functionalities to present data exchanged between the devices and the host server 120 to a user. For example, the client devices 110 A-N can be, but are not limited to, a server desktop, a desktop computer, a computer cluster, a mobile computing device such as a notebook, a laptop computer, a handheld computer, a mobile phone, a smart phone, a PDA, etc. In some embodiments, the client devices 110A-N are coupled to a network 105. In some embodiments, the client devices may be directly connected to the host server 120.

The host server 120 can be any combination of software agents and/or hardware modules for running the online platform, either individually or in a distributed manner with other host servers 120. The online platform organizes groups hierarchically using the concept of umbrella groups. The online platform provides a home page that resides at the top of the hierarchy and functions as the overarching root umbrella under which all other groups, volunteer organizations, general organizations, companies, and individuals are established. All groups that register with the online platform are associated with one or more umbrella groups that reside below the root umbrella.

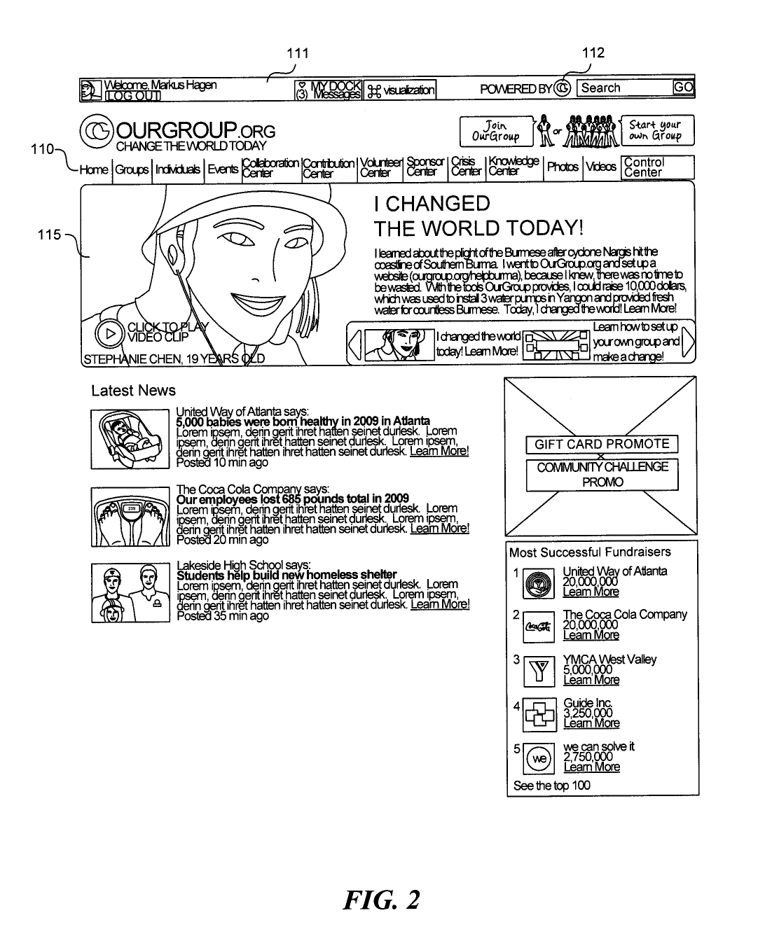

FIG. 2 shows an example platform home page where any of the groups associated with the online platform can be accessed. Near the top of the home page, is a bar 110 with links to web pages that provide information associated with registered groups and registered individuals. Below the bar 110 on the home page is an area 115 that can be used to highlight a particular individual or group. In some embodiments, on the left side of the bottom of the home page in the example of FIG. 2, the latest news from groups registered with the online platform is listed in a sortable format, and shown as a dynamic newsfeed, while on the right side, advertisements from an associated group can be shown as well as a listing of the most successful campaigns to accumulate credit. Essentially, the home page provides an index to the latest happenings related to groups and individuals associated with the online platform.

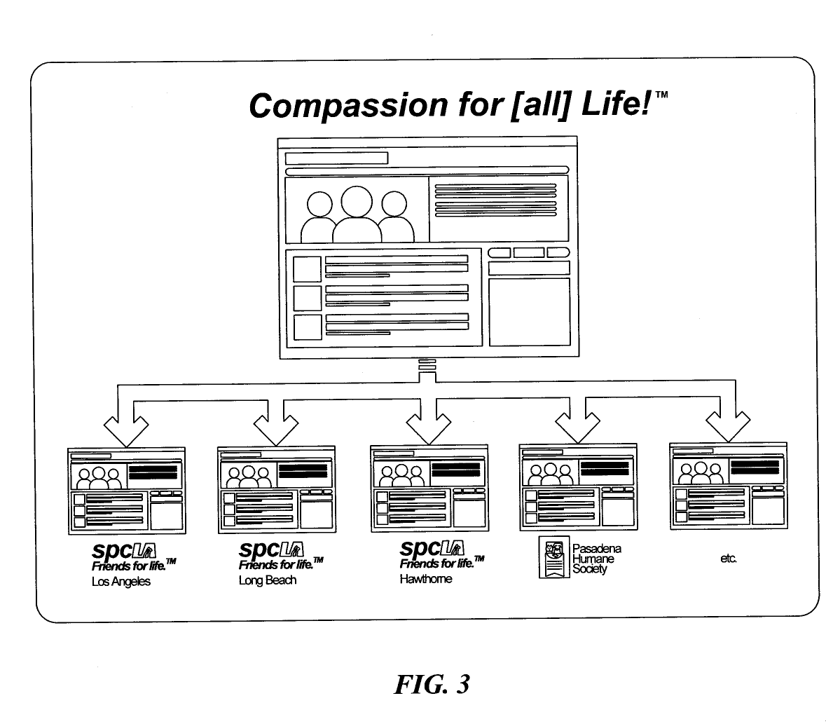

Umbrella groups that are situated at the first level beneath the root umbrella are validated by the system and/or an administrator module of the system and can be used to categorize other groups. Some examples of umbrella groups that can be situated at the first level beneath the root umbrella include animal-related organizations such as the Humane Society and organizations for veterans. In some embodiments, the first-level umbrella group can be an existing organization, such as the United Way which is a non-profit organization that works with other volunteer organizations to pool efforts in accumulating credit to serve the community. In some embodiments, an administrative umbrella group can be formed to organize other groups focused on similar goals. The first level umbrella groups are validated by the administrator module of the online platform, and subsequent groups that wish to join under a first level umbrella group can be selected and validated by the administrator module of the first level umbrella group. FIG. 3 shows an example of an umbrella organization relative to organizations situated under or within the umbrella group. At the top is the first level umbrella group, and five second level groups are shown below. Each of the second level groups can each be an umbrella group for other, third level groups, and so on for subsequent levels of groups.

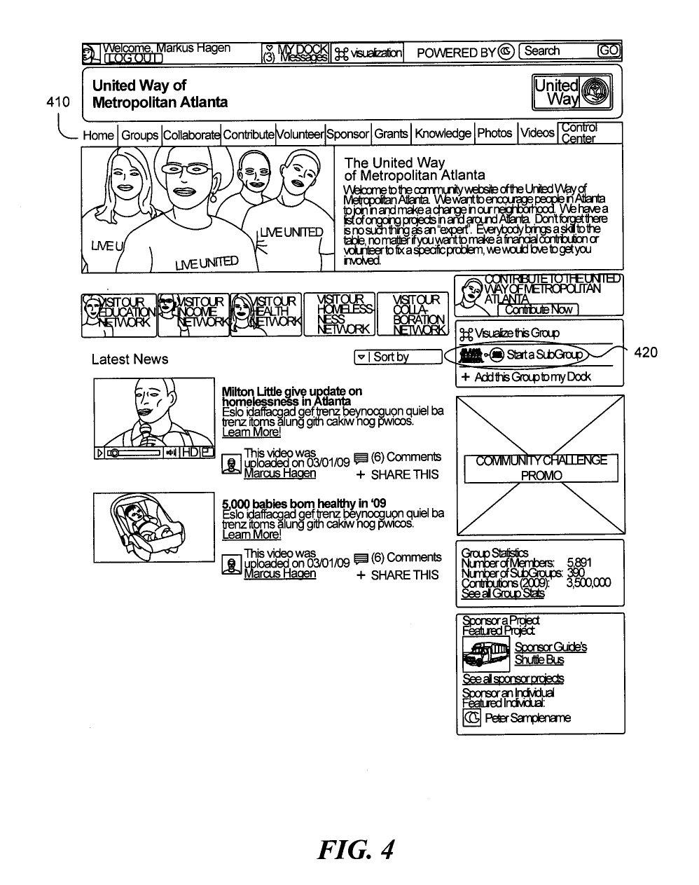

A group that falls under a higher level umbrella group has the advantage of being associated with marketing initiatives and campaigns spearheaded by the higher level umbrella group. Each higher level umbrella group has a group home page or landing page that is similar to the home page for the online platform. FIG. 4 shows an example home page for the United Way of Metropolitan Atlanta. Similar to the online platform's home page, there is a bar 410 near the top of the page that provides access to sub-groups under this umbrella group and sections on the page where the latest news from any of the organizations that are grouped under the United Way of Metropolitan Atlanta as well as information pertaining to those groups, such as group statistics, are displayed. The use of the online platform's tools and the hierarchical organization of groups with the online platform are particularly useful for highly fragmented volunteer organization sectors.

The online platform is suitable for use by any type of group, including volunteer organizations and groups with a common goal. In some embodiments, to provide a high level of confidence to companies and individuals that the online platform permits only credible volunteer organizations to register with the platform, the services of a reputable third party vendor, such as Dun & Bradstreet, can be commissioned to certify volunteer organizations that apply to register with the online platform. Volunteer organizations can be ranked using different criteria. For example, category 5 can correspond to the highest rating for a most validated volunteer organization; and category 4 can correspond to a reputable but unvalidated volunteer organization that has been reviewed by, for example, Charity Navigator, is recognized by the government as a 501(c)(3) nonprofit organization, has a reasonable operational expense ratio, and received good volunteer reviews. In some embodiments, umbrella organizations can pay to obtain a review and certification by Dun & Bradstreet, and umbrella groups who do not obtain certification will receive a lower rating. By becoming validated as a 501(c)(3) nonprofit organization, individuals who contribute resources to the organization will know that their contributions are tax-deductible.

Alternatively or additionally, GuideStar can be commissioned by umbrella organizations to monitor its sub-groups on a regular basis to ensure that the umbrella group is credible.

Further, the online platform's administrators, such as a Board of Directors, can engage reputable third parties to conduct annual audits on its own security, finance, and member information confidentiality. The audits can be published to assure clients and contributors that the online platform is trustworthy.

The online platform also offers an integrated set of tools for organizing groups, such as targeting a philanthropic goal or running a campaign with a simple way to attract supporters to help raise awareness and support for charity organizations. Functions and techniques performed by the host server 120 are described in detail with further reference to the example of FIG. 1B-1.

The network 105, to which the client devices 110A-N and host server 120 are coupled, may be a telephonic network, an open network, such as the Internet, or a private network, such as an intranet and/or the extranet. For example, the Internet can provide file transfer, remote log in, email, news, RSS, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 105 may be any collection of distinct networks operating wholly or partially in conjunction to provide connectivity to the client devices, and may appear as one or more networks to the serviced systems and devices. In some embodiments, communications to and from the client devices 110A-N may be achieved by, an open network, such as the Internet, or a private network, such as an intranet and/or the extranet. In some embodiments, communications may be achieved by a secure communications protocol, such as secure sockets layer (SSL), or transport layer security (TLS). In addition, communications can be achieved via one or more wireless networks.

The client devices 110A-N can be coupled to the network (e.g., Internet) via a dial-up connection, a digital subscriber loop (DSL, ADSL), cable modem, and/or other types of connection. Thus, the client devices 110A-N can communicate with remote servers (e.g., web server, host server, mail server, instant messaging server) that provide access to user interfaces of the World Wide Web via a web browser, for example.

The databases 130A-N store information utilized by components of the host server 120 for operating the online platform. The databases 130A-N can be managed by a database management system (DBMS), for example but not limited to, Oracle, DB2, Microsoft Access, Microsoft SQL Server, PostgreSQL, MySQL, FileMaker, etc.

The databases 130A-N can be implemented via object-oriented technology and/or via text files, and can be managed by a distributed database management system, an object-oriented database management system (OODBMS) (e.g., ConceptBase, FastDB Main Memory Database Management System, JDOlnstruments, ObjectDB, etc.), an object-relational database management system (ORDBMS) (e.g., Informix, OpenLink Virtuoso, VMDS, etc.), a file system, and/or any other convenient or known database management package. The databases are described in detail with reference to the example of FIG. 1C.

FIG. 1B-1 depicts a block diagram illustrating an example of components of the host server 120. The host server 120 can include, for example, a network interface 151, a registration module 152, a profile module 153, an events module 154, a collaboration module 155, a resource contribution module 156, a content review module 157, an invitation module 158, a volunteer module 159, a sponsor module 160, a knowledge module 161, a control center module 162, a feedback module 163, a supporter module 164, a marketing module 165, a photo/video module 166, a dock module 167, a crisis center module 168, a help module 169, an email module 170, a notifications module 171, and/or a request module 172. Additional or fewer components or modules can be included in the host server 120 and each illustrated component.

FIG. 1C depicts a block diagram illustrating an example of databases accessed by the host server. The databases can include, for example, a groups database 181, an individuals database 182, a supporters database 183, a marketing database 184, a knowledge database 185, a photos/videos database 186, a tributes database 187, a resources database 188, an event database 189, a feedback database 190, a volunteer database 191, a sponsor database 192, a help database 193, and/or a messaging database 194. Although these databases are identified as separate databases, in some embodiments, all or some of each of these database can be combined with other databases and/or separated out into separate databases.

The network interface 151 can be a networking module that enables the host server 120 to mediate data in a network with an entity that is external to host server 120, through any known and/or convenient communications protocol supported by the host and the external entity. The network interface 151 can include one or more of a network adaptor card, a wireless network interface card (e.g., SMS interface, WiFi interface, interfaces for various generations of mobile communication standards including but not limited to 1G, 2G, 3G, 3.5G, 4G, LTE, etc.,), Bluetooth, a router, an access point, a wireless router, a switch, a multilayer switch, a protocol converter, a gateway, a bridge, bridge router, a hub, a digital media receiver, and/or a repeater.

As used herein, a “module,” or an “engine” includes a general purpose, dedicated or shared processor and, typically, firmware or software modules that are executed by the processor. Depending upon implementation-specific or other considerations, the module or engine can be centralized or its functionality distributed. The module or engine can include general or special purpose hardware, firmware, or software embodied in a computer-readable (storage) medium for execution by the processor. As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, to name a few), but may or may not be limited to hardware.

In some embodiments, the host server 120 includes the registration module 152 which can request and receive registration information to register groups and individuals with the online platform. FIG. 1B-2 depicts a block diagram illustrating an example of components in the registration module 152. The registration module can include, for example, a request receiving module 152a, a request communication module 152b, an information request module 152c, and/or a registration processing module 152d.

Registering a Group Under an Existing Umbrella Group

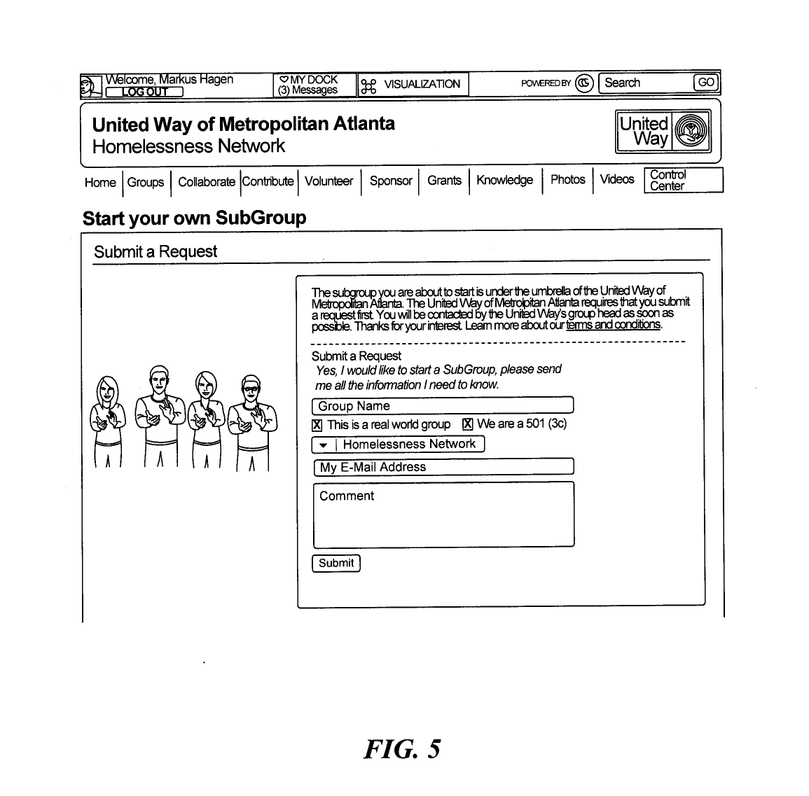

In some embodiments, an umbrella group's administrator module can require that a group seeking to be categorized under the umbrella group register and be validated by the umbrella group's administrator module prior to being permitted to be associated with the umbrella group. The example of FIG. 4 shows a button 420 on the home page of the United Way of Metropolitan Atlanta umbrella group that is linked to a sub-group registration form. An example sub-group registration form is shown in FIG. 5. The registration forms for groups, sub-groups, and individuals request registration information for joining the online platform and are provided by the information request module 152c In this example, a user client desiring to start a sub-group under the United Way of Metropolitan Atlanta umbrella group enters a desired group name and contact information. Information provided in response to the registration forms is received by the request receiving module 152a. Subsequently, the request communication module 152b sends the information to the administrator module of the United Way of Metropolitan Atlanta umbrella group, and the administrator module can determine whether the sub-group should be validated. Criteria that can be used by the administrator module for validation can include goals of the sub-group and whether the sub-group's goals are compatible with the umbrella group's goals.

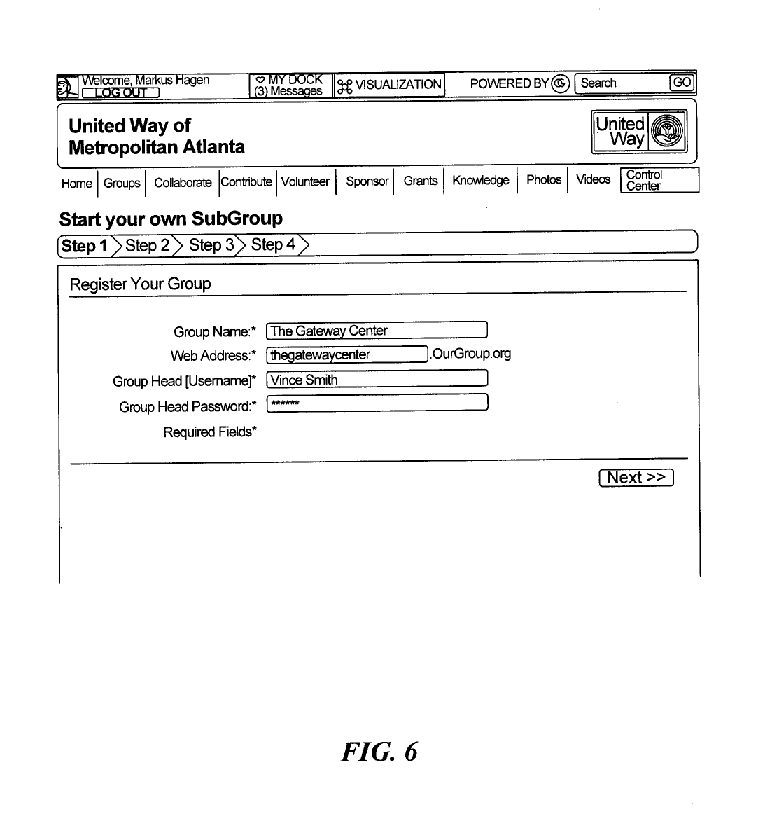

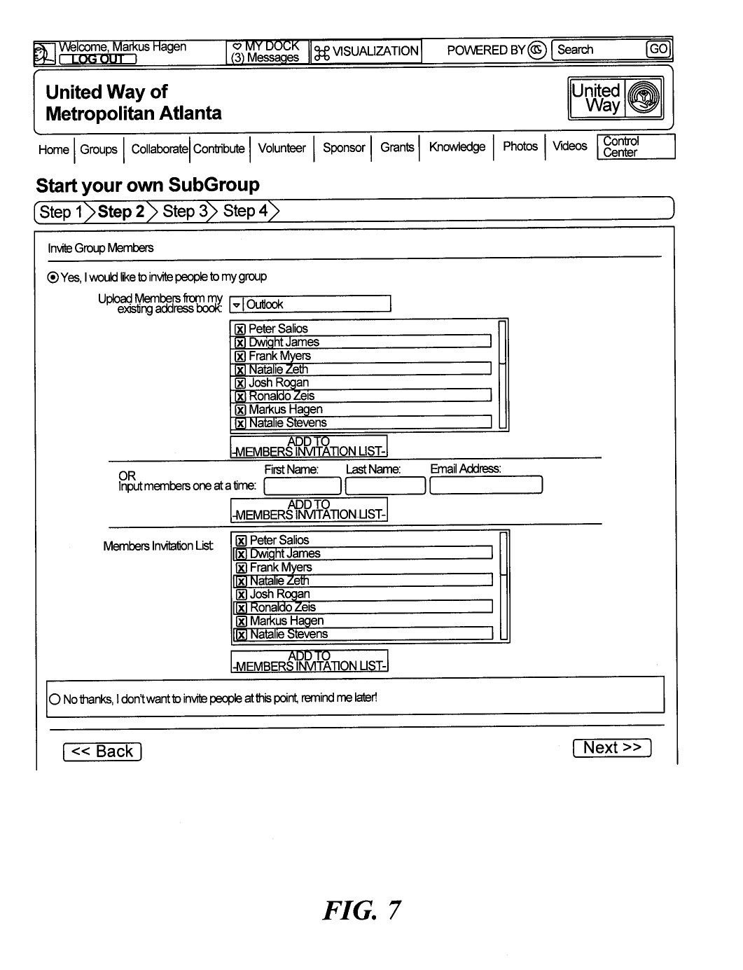

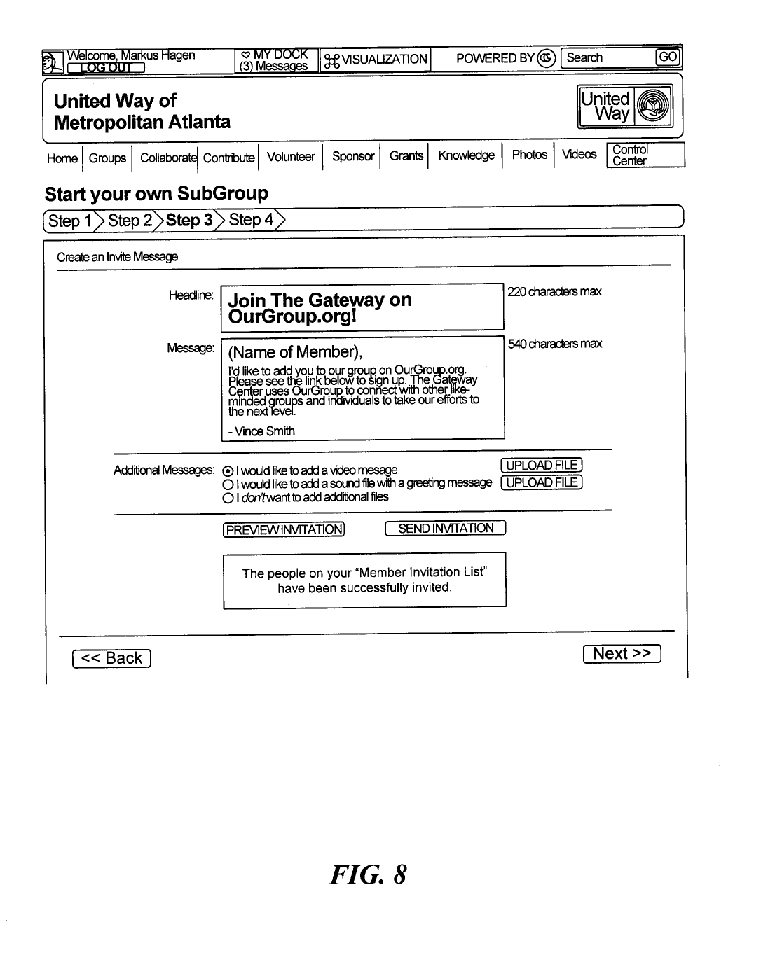

Once approval has been granted by the administrator module of the umbrella group and communicated to the request communication module 152b, the administrator module of the sub-group can be provided a link by the information request module 152c that requests information about the sub-group. The example of FIG. 6 shows a screenshot where basic sub-group information is entered and provided to the request receiving module 152a, such as the group name, a web address name, an administrator or head of the sub-group, and a password. The example of FIG. 7 shows a screenshot where the administrator module of the sub-group can import names of individuals to invite for joining the sub-group. Names can be imported from an email address book. The example of FIG. 8 shows a screenshot of a page where the administrator module of the sub-group can create the invitation message to be sent to the previously selected individuals. The invitation can include a customized headline, written text message, video message or sound file with a greeting message. In some embodiments, information pertaining to all registered groups is stored in the groups database 181.

Once the administrator module of the sub-group has provided the requested information about the sub-group, the registration processing module 152d processes the information. The registration processing module 152d can include a landing page module 152 m and/or a tools module 152n. The landing page module 152m provides a link from the umbrella group's webpage or landing page hosted by the online platform to a new landing page for the newly registered sub-group.

Further, the tools module 152n enables member clients of the new sub-group to use software tools available for facilitating communication of information among member clients of the new sub-group and to member clients of the umbrella group by providing active links to webpages with group-related information. The webpages can include links to a groups page that provides information received about the sub-group and sub-groups that may be organized under the sub-group as an umbrella organization, an individuals page that provides information about members involved with the sub-group, an events page that provides information about events associated with the sub-group, a collaboration page that provides software tools for collaborating among member clients, a contribution page that allows member clients to contribute resources, a volunteer page that provides information on volunteer opportunities associated with the sub-group, a sponsor page that provides information on projects and individuals that member clients can sponsor in conjunction with the sub-group, a knowledge page that provides received information useful to the sub-group, a photos page that displays photos related to the sub-group, and a video page that displays videos related to the sub-group. Further, the software tools permit authorized member clients of the sub-group to edit the information provided in these webpages or add new information.

Group Landing Page

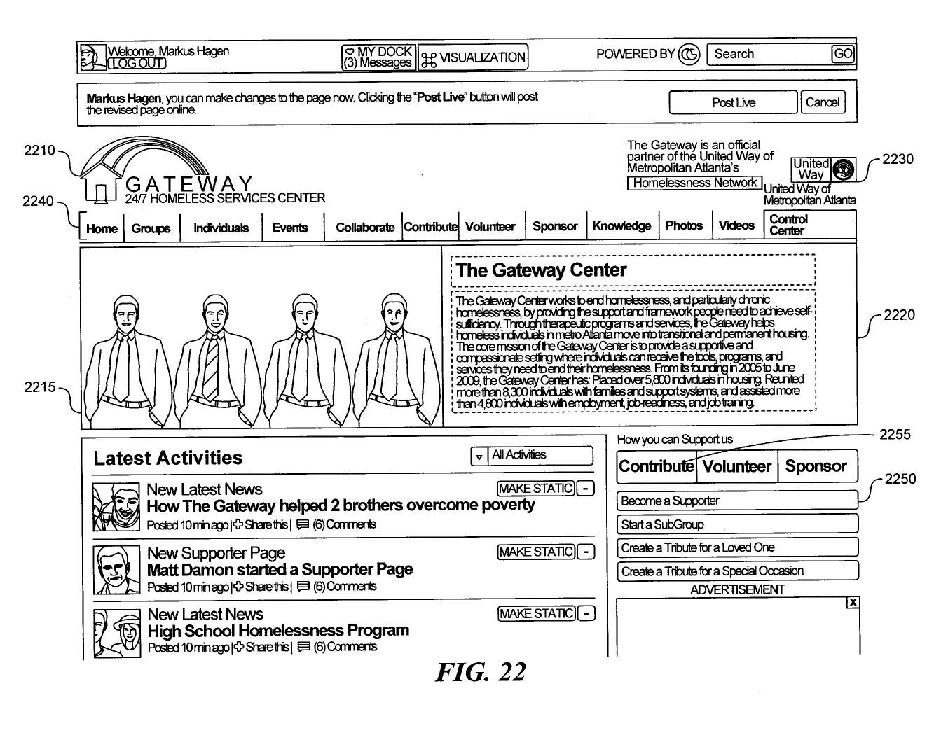

Once a group has been registered, the administrator module of the newly registered group can immediately customize a landing page for the group, using a standardized webpage provided by the online platform via the landing page module 152m. As shown in the example of FIG. 22, the administrator module can enter a logo 2210, pictures 2215, and a group description 2220 for display on the landing page for the group. The landing page module 152m prompts the administrator module for the various elements. The information is received by the landing page module 152m which then generates the group's customized landing page accordingly. Other non-limiting examples of ways that the landing page can be customized by an administrator module of the group include selecting a color scheme that includes a color for the text and a background color. No technical knowledge is needed by the administrator module to generate the customized landing page, as the landing page module 152m is configured to generate the customized landing page based upon input from the administrator module.

In the example of FIG. 22, the sub-group name is The Gateway, and this group has been formed under the umbrella of United Way. The United Way logo 2230 is automatically placed by the online platform on the home page of the sub-group when the sub-group is authorized. The umbrella logo indicates to users viewing The Gateway's webpage that the group is associated with the umbrella group United Way. In most instances, the umbrella group will be better known than the sub-group. Thus, the umbrella group's logo may serve to lend an aura of authenticity and reliability to the sub-group.

A standard set of tools are available on each group's landing page and provided by the tools module 152n. The toolbar 2240 on the home page provides access to the set of tools. If the user clicks the ‘Home’ button on the left of the toolbar 2240 from anywhere within the group's webpages, it will bring the user back to the landing page of the group.

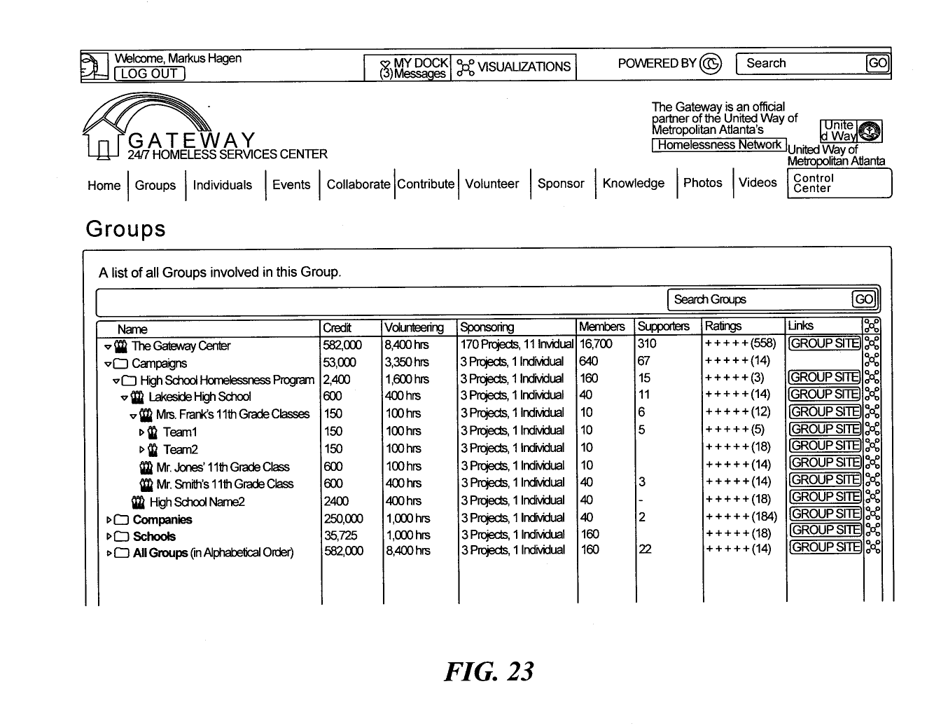

Clicking on the ‘Group’ button on the toolbar 2240 takes the user to a groups center web page that shows the sub-groups authorized under The Gateway. Thus, if The Gateway is an umbrella group for sub-groups, those sub-groups will be shown in the groups center, and the activity within those sub-groups roll up to The Gateway. The example of FIG. 23 shows groups center web page that includes a listing of the sub-groups under The Gateway, categorized under headings such as campaigns, companies, schools, or uncategorized. Each sub-group under The Gateway can have its own sub-groups. For example, the sub-Group High School Homelessness Program has several sub-groups, Lakeside High School, High School Name2, High School name3, and High School Name4. Next to each sub-group and each of the sub-groups under those sub-groups, is a listing of information associated with the group, such as total resources provided, number of volunteer hours, sponsorship, members, supporters, ratings, and links that are associated with that particular group. Each of the sub-groups also has access to the same tools as the umbrella group.

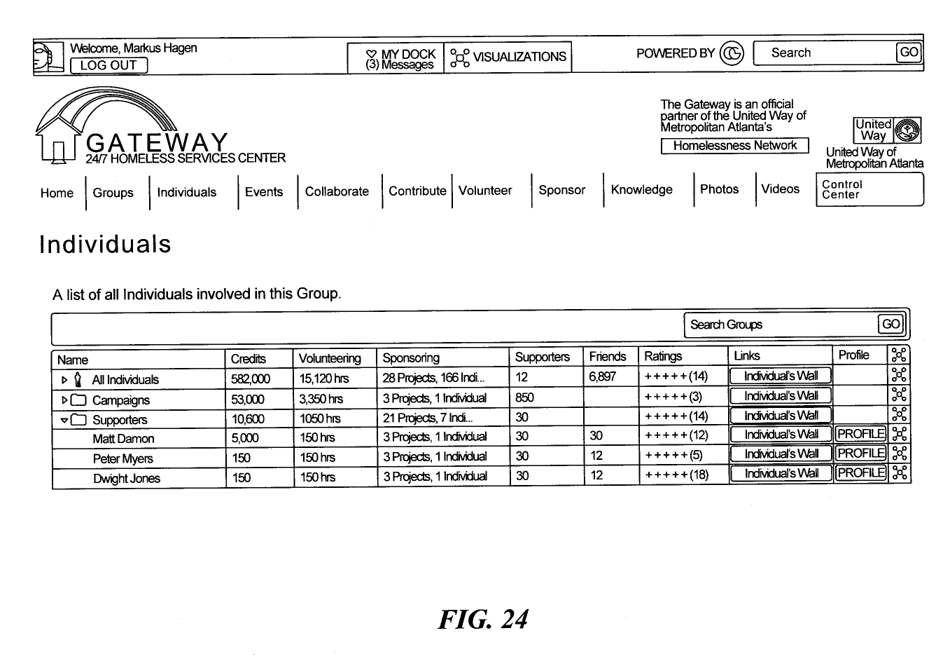

Clicking on the ‘Individuals’ button on the toolbar 2240 takes the user to an individuals center web page for a group that lists all members involved with the group or sub-groups under that group, where the listed members have elected to be listed. The example of FIG. 24 shows a listing of the individuals who are members of The Gateway and categorized by all individuals, campaigns, and supporters. The center also lists information associated with the member, such as resources provided, volunteer hours, projects and individuals sponsored by the member, number of supporters, number of friends, ratings, links to the member's supporter page, tribute page, and/or profile page. The web page can also provide a way to search for individuals associated with the group.

The toolbar 2240 lists other clickable buttons including events, collaborate, contribute, volunteer, sponsor, knowledge, photos, and videos. Also, a group's landing page includes a clickable button ‘Become a supporter’ 2250 in FIG. 22. By clicking on this button, a client can become a supporter and create a supporter page on the online platform using a supporter page template. The functionality of each of these buttons will be described below.

Registering a Group by an Individual

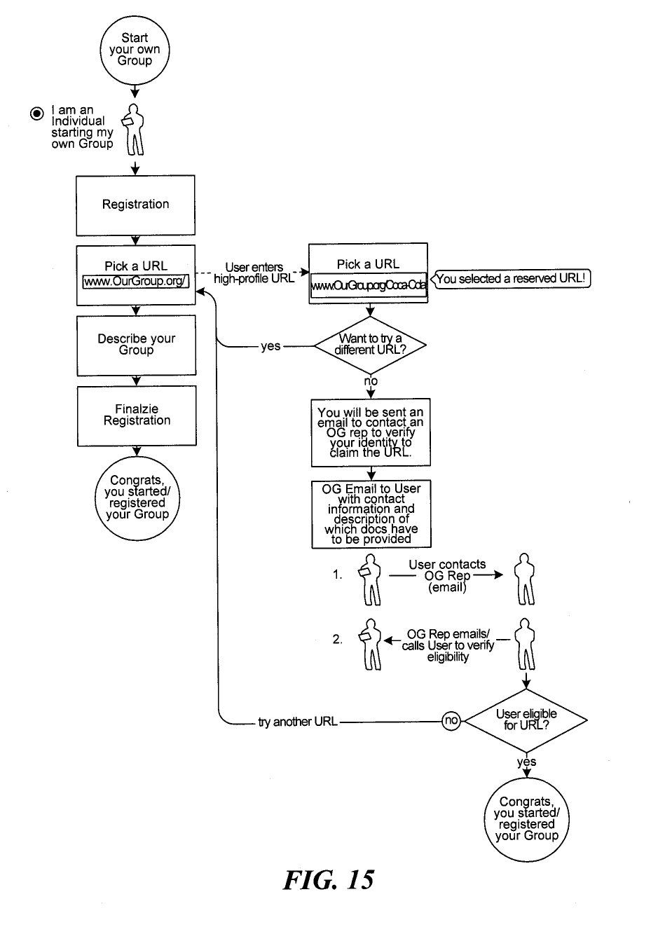

FIG. 15 is a flow diagram illustrating an example process for registering a group by an individual. The individual user client registering the group must be logged in to the online platform, using the person's registered username and password, to interact with the registration module 152 to start a group. However, the individual does not need to be a validated member. A registered group can be associated with an umbrella group, or it can choose to not be associated with any umbrella group. Groups that choose to be associated with an umbrella group must be approved by the umbrella group, as discussed above.

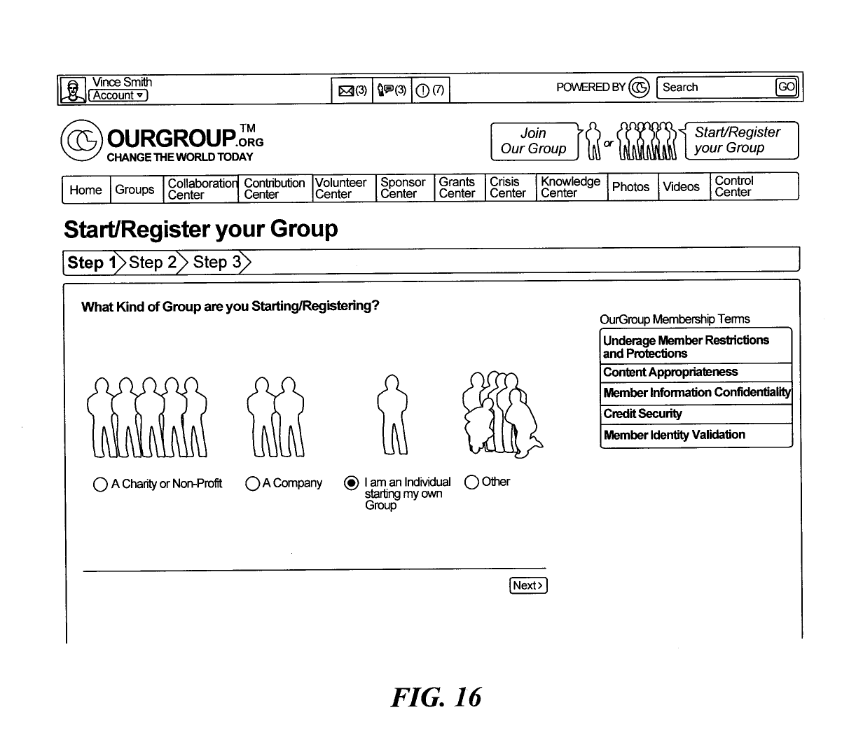

The first step in registering a group, as shown in FIG. 16, is for the registering user client to indicate the kind of group that is being registered, for example, a volunteer or non-profit organization, a company, an individual starting a new group, or other.

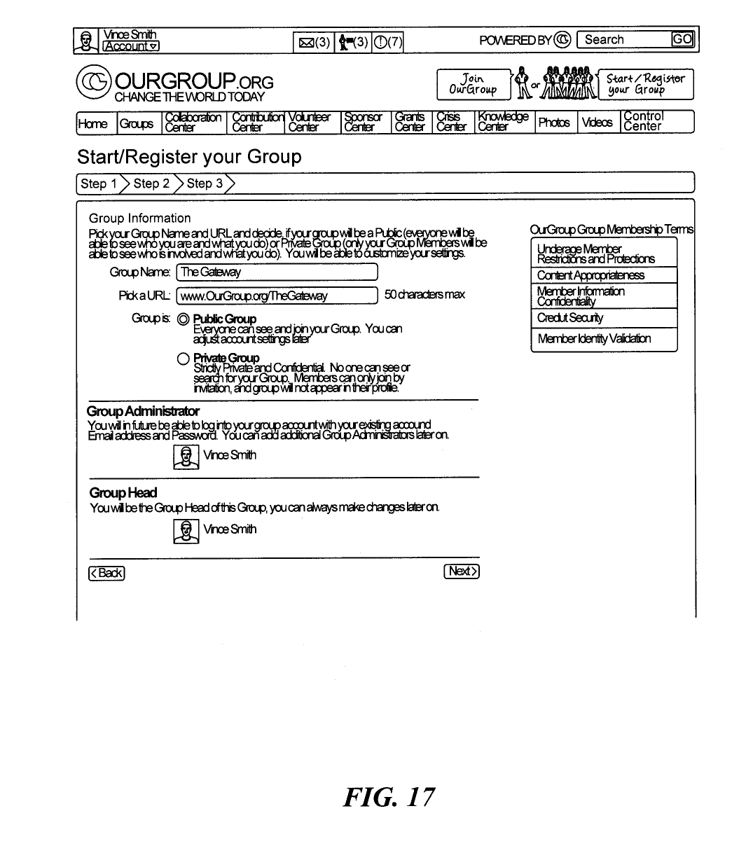

Next, basic information for the group is requested, as shown in FIG. 17, for example. The name of the group and a URL are selected by the registering user client. In some embodiments, the URL indicates the overarching umbrella organization of the online platform. If the registering user client selects a high-profile URL, such as the name of a large corporation, for example Coca-Cola or company that is associated with that name. Further, the registering user client will also be informed administrator module of the online platform should be contacted to claim the particular URL that is requested to finalize registration of the group. Otherwise, the registering user client can select another URL.

The registration module 152 also requests during registration whether the group will be a public group or a private group. With a public group, everyone can access the group to see information about the group and what the group did, and everyone can join the group. With a private group, no client can see or search for the group, members can only join by invitation, and the group does not appear in members' profiles. During registration, a group administrator and a group head are selected. The group administrator can log into the group's account, and the group head manages the group. Additional administrators can be added later, and the group head can also be changed later.

Finally, the group's mission is selected from a list of choices, such as animal related; arts, culture and humanities; civil rights, social action and advocacy; community improvement and capacity building; crime and legal-related; employment; diseases, disorders and medical disciplines; education; environment; food, agriculture and nutrition; foreign affairs and national security; health care; housing and shelter; human services; medical research; mental health and crisis intervention; mutual and membership benefit; philanthropy, volunteerism and grantmaking foundations; public and societal benefit; public safety, disaster preparedness and relief; recreation and sports; science and technology; social science; youth development; or other.

After the registration module 152 receives the above information from the registering user client, the registration module 152 stores the group information in the groups database 181, and the group is registered. At this point, the registering user client can use the online platform and perform activities such as edit the group site, invite group members, adjust account settings.

The Home Page for the Online Platform

When a user of the online platform clicks on the platform logo 112, shown for example in FIG. 2, the user will be taken to the online platform's home page which is the overarching umbrella under which all other groups that register with the online platform fall. The information from the other groups flow up to the home page, for example, members' group membership information, posted content, resources provided, volunteer hours provided, etc. FIG. 2 shows an example online platform home page.

Clicking on the ‘groups’ button on the online platform home page takes the user to a groups center web page that provides information about umbrella groups and sub-groups registered with the online platform, for example the top groups, e.g., the group that received the most total resource contributions, the group that has the largest number of volunteers, the fastest growing groups in members and/or resources provided, the largest groups, the groups with the most members, the groups that have been searched the most, etc. Similarly, clicking on the ‘individuals’ button on the home page takes the user to an individuals center page that provides information about individuals registered with the online platform, for example, members with the most contacts, members who have contributed the most resources and/or volunteer hours, etc. Groups on the groups center web page and individuals on the individuals center web page can both be searched.

Clicking on the ‘events’ button on the home page takes the user to an events center web page that provides information about events listed with the online platform by umbrella groups and sub-groups. Individuals can search for any event by country, city, topic, date, etc. The online platform also coordinates groups to enhance their prominence during special events or days, for example, global earth day and AIDS day. Further, the events center page lists information about events, such as the top events, fastest growing events, largest events, the events with the most participation, and top searched events.

The online platform home page is the only entity within the online platform that has a clickable ‘crisis center’ button, located, for example, towards the middle of the toolbar 110 of FIG. 2 and realized by the crisis center module 168. FIG. 1B-3 depicts a block diagram illustrating an example of components in the crisis center module 168. The crisis center module 168 can include, for example, an external event receiving module 168a, a group identification module 168b, a crisis webpage generation module 168c, and/or a crisis notification module 168d.

When an external event, such as a crisis, occurs anywhere in the world, the external event receiving module 168a receives the information about the external event. In some embodiments, the external event receiving module 168a can automatically monitor search trends for keywords associated with crises, for example, earthquake and tsunami. Search trends may be aggregated by search websites, and the external event receiving module 168a monitors these trends. Alternatively or additionally, the external event receiving module 168a can automatically monitor online social networking services, such as TWITTER®, for the same list of keywords. Upon identifying any of the keywords, the external event receiving module 168a can automatically generate a webpage with the identified events.

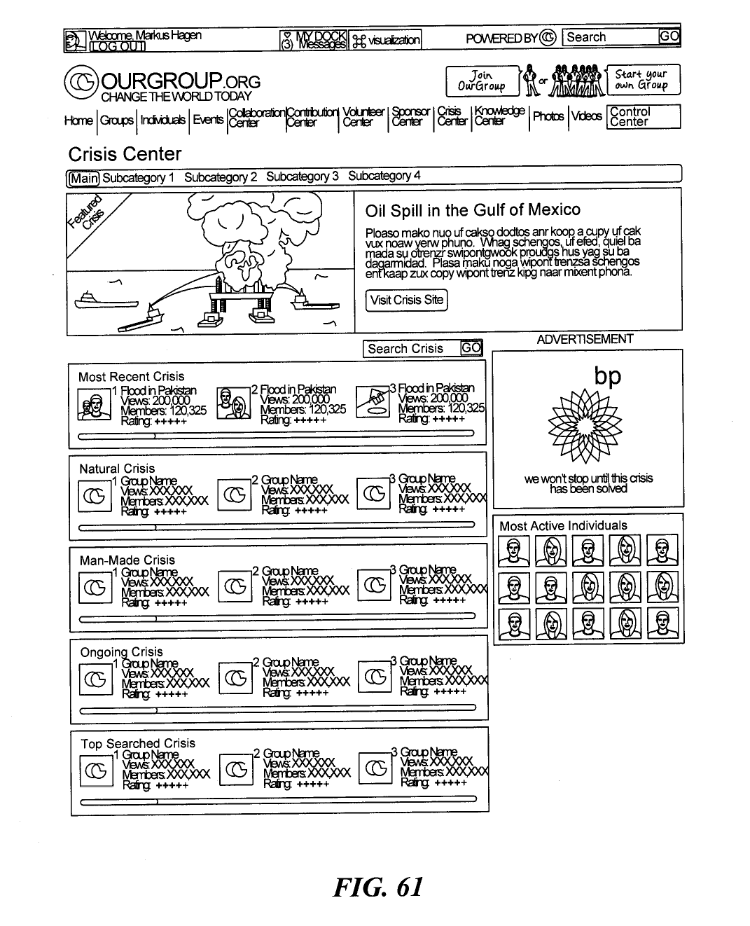

After receiving external event information, the group identification module 168b identifies one or more groups registered with the online platform that has a goal related to ameliorating the effects caused by the external event, such as homelessness or hunger, due to a natural catastrophe, such as a flood, earthquake, or tornado. The crisis webpage generation module 168c works in conjunction with the external event receiving module 168a and the group identification module 168b to make the most credible and/or relevant groups highly visible on the online platform crisis center page, as shown, for example, in FIG. 61.

Further, the crisis notification module 168d will, via a communication network, notify various message distribution centers 107 that information for helping to ameliorate the effects of the external event is available at the crisis center webpage and that individuals can visit the online platform's crisis center page to help out the people impacted by the crisis. The crisis center page also lists information about crises, such as the most recent crisis, natural crisis, man-made crisis, ongoing crisis, and top searched crisis.

The registration module 152 can also register individuals for the online platform. Different categories of registration are available including: child under 14 years of age, child between 14 and 18 years of age, and adult.

Registering an Adult as a Member

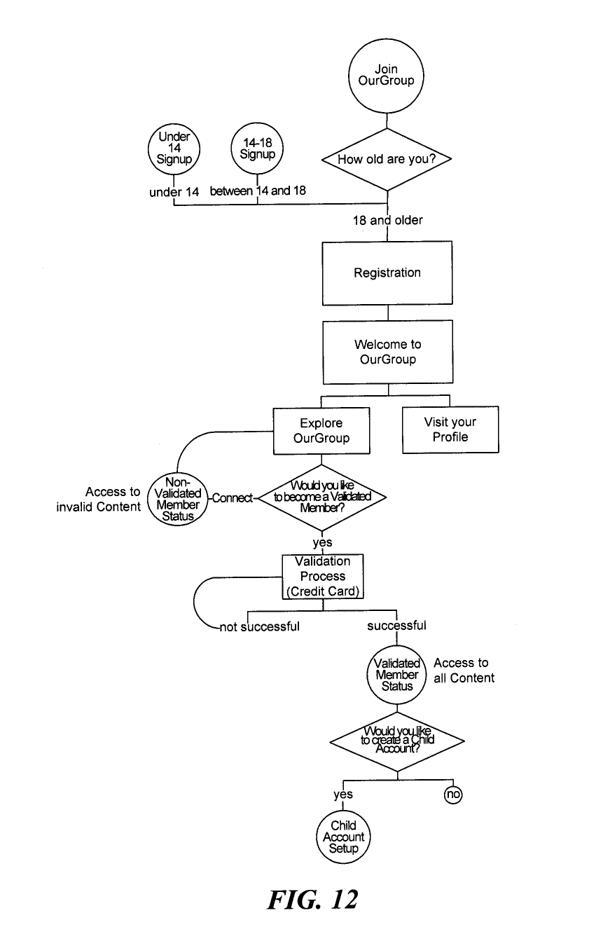

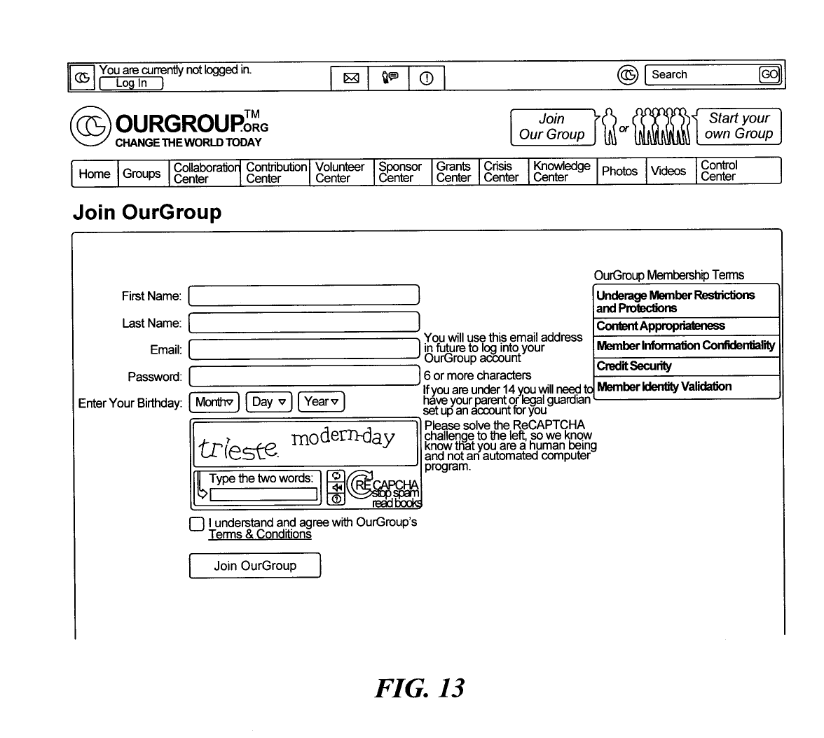

FIG. 12 is a flow diagram illustrating an example process for registering an adult as a member of the online platform. The registration module 152 presents the registering person with the online registration form, an example of which is shown in FIG. 13. For example, the registration module 152 can request that the person provide a first name, last name, an email address to be used as a username for logging in to the person's account on the online platform, a password, and the registrant's birthday. The birth day information is used for age verification purposes. If the person is under 18, there are different registration requirements to ensure that minors accessing the online platform are protected. Children under the age of 14 need parental consent to start an account. Individuals between the ages of 14 and 18 can set up an account, but they are asked to review terms of use with their parents or legal guardian.

Once the registrant submits the information requested, the registrant will be prompted to check for an email from the registration module 152. The registration module 152 sends an email to the person at the email address provided to ensure that the email is real and working. The email prompts the person to finalize the registration. In some embodiments, the email includes a final registration button that the person can click on to complete registration. Upon finalizing registration, the person becomes a member of the online platform, and the member can enter information into a profile maintained for the member, as described below.

When the member client logs in to the online platform, the member client can go through a validation process to become a validated member. The online platform is designed to create a safe environment, where users can trust that people are who they say claim to be. In some embodiments, a member can become a validated member by providing a first and last name, a valid credit card number, and billing address information to the registration module 152. The registration module then charges the credit card a nominal amount and reimburses the charged amount to the user immediately. By charging the credit card, the registration module 152 is able to cross reference the registration information provided by the member to validate the member. Validation lasts as long as the credit card is valid. Alternatively, a member can be validated by providing a first and last name, the last four digits of the member's social security member, and answering one or more security questions, such as the name of the street that the member grew up on.

Once a member is validated, the member client can upload content to the online platform (along with an age appropriateness rating of the content), the member client has access to all content posted on the online platform rated up to (R) rating, and there will not be any limitations on joining or following any groups. Non-validated members only have access to (PG)-rated content and may be limited in joining and/or following groups and connecting with people. The validation process keeps minors safe within the online platform, and the system only provides age-appropriate content to them.

Further, validation of a member allows that member to collect resources through the online platform.

Registering a Child Under 14 Years Old

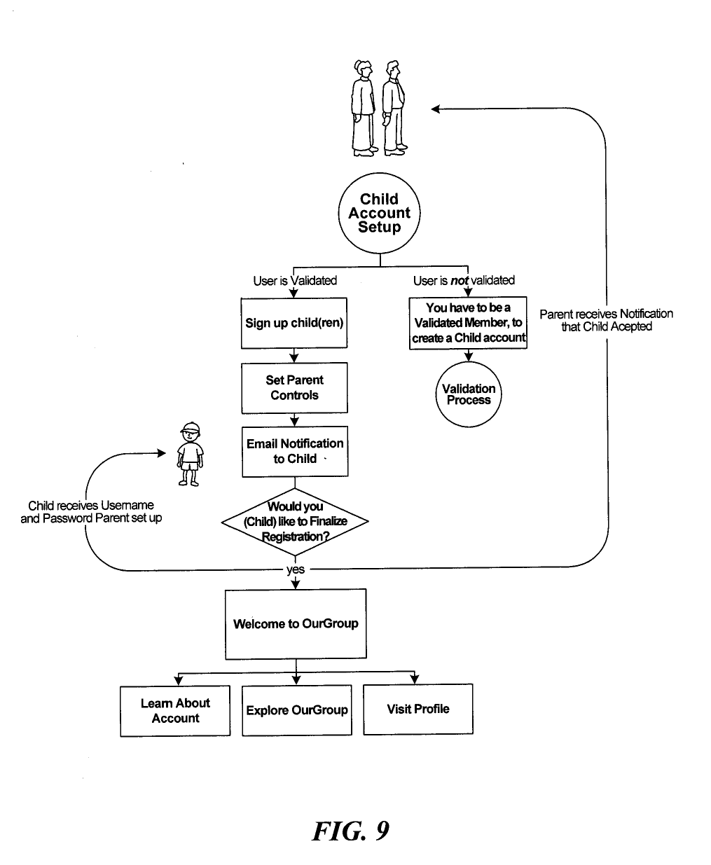

FIG. 9 is a flow diagram illustrating an example process for registering a child under 14 years old and creating a child account on the online platform. To help ensure the child's safety, the child must be registered by an adult who is a validated member of the online platform and is either the child's parent or legal guardian. The adult controls the content the child has access to, which groups the child can join, and who the child can interact with on the online platform. In some embodiments, the adult can immediately initiate registration of the child if the adult is a validated member of the online platform.

In some embodiments, if the child tries to register himself, the child will not be permitted to if the child is under 14 years of age, but the child can be given the option to have an email sent to a parent or legal guardian requesting that they register the child. If the child chooses to do so, the child enters the name of a parent or legal guardian. The registration module 152 can search the database of registered users to determine if the name is an existing member of the online platform and also whether the member is a validated member. If the named adult is not a member, the child is requested to enter an email address for the adult, and the adult is sent an email on behalf of the child requesting that a child account be set up for the child; the adult is also provided information on how to become a validated member of the online platform as only validated members can register a child. If the adult is a member, the registration module 152 can enter the email address on file and send the email request on behalf of the child.

If the adult is not a validated member, when the adult tries to register the child, the adult will be prompted to become validated, as described above. If the adult is a validated member, the adult is requested by the registration module 152 to provide the child's name, the child's email address which will be used as the child's username in the online platform, and a password. The adult must also indicate the relationship (parent or legal guardian) to the child being registered.

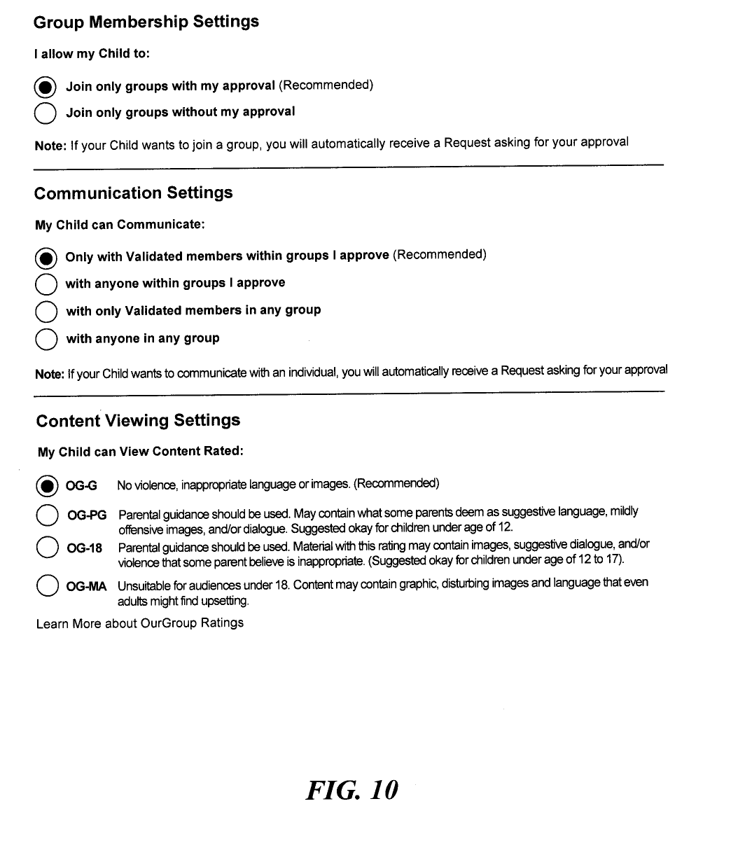

During the registration process, the adult also selects parental control settings. FIG. 10 shows example parental controls that the registration module 152 requests. For group membership settings, the adult can permit the child to join only groups with the adult's approval or join any group without the adult's approval. For communications settings, the child can be permitted to communicate only with validated members within groups approved by the adult, communicate with clients within groups approved by the adult, communicate with only validated members in any group, or communicate with clients in any group. For content viewing settings, the child can be permitted to view content rated G (general audiences), PG (parental guidance suggested), 18 or R (content that may not be appropriate for audiences younger than 18), or MA (unsuitable for audiences under 18).

Once parental controls have been established, an email is sent to the child by the registration module 152 on behalf of the parent that an account has been created for the child. The email includes the username and password set up by the adult, and the child completes the final registration of the account. In some embodiments, the email includes a final registration button that the child can click on to complete registration. Upon completion of registration by the child, the parent is informed by email, and the child becomes a member of the online platform. A child can also be validated using a similar process used to validate an adult member.

In some embodiments, the above description can apply to children under any designated age, not just 14 years old.

Registering a Child Between 14 and 18 Years Old

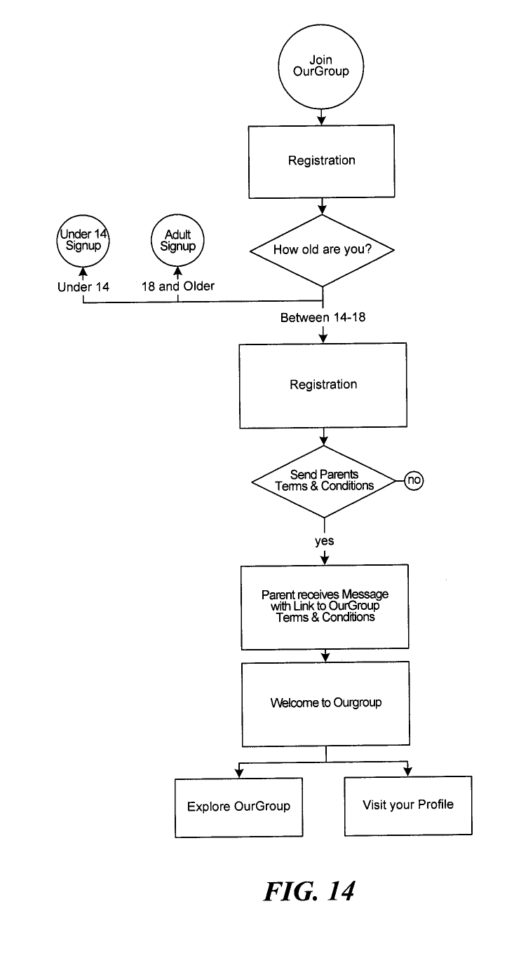

FIG. 14 is a flow diagram illustrating an example process for registering a child under between 14 and 18 years old and creating a child account on the online platform. In some embodiments, when the child tries to register himself, the child's birthday will be requested, as shown in the example registration form in FIG. 13. If the child is between 14 and 18 years old, the child is prompted to send the terms and conditions associated with becoming a member of the online platform by email to a parent or legal guardian and advised to review the terms and conditions together. The registration module 152 requests the first and last name of the adult and an email address if the adult is not a member of the online platform. The registration module 152 then sends the email to the adult with a message that recommends that the adult review the online platform's terms and conditions with the child. As another option, the child can choose to ignore the recommendation. In either case, the registration module 152 sends an email to the child at the email address provided during registration to ensure that the email is real. The email prompts the child to finalize the registration. In some embodiments, the email includes a final registration button that the child can click on to complete registration. Upon finalizing registration, the child becomes a member of the online platform, and the member can enter information into the member's profile, as described below.

In some embodiments, the above description can apply to children in any designated age range, not just between 14 and 18 years old.

Child Protection Controls

In addition to the above requirements for registering a child under the age of 18, the online platform uses a number of child protection controls and safeguards. For example, children under the age of 18 need parental consent to create a profile and chat on the online platform; administrator modules of the online platform will automatically scan sites for inappropriate content, such as inappropriate language or inappropriate pictures; users can report abuse on sites throughout the platform, and inappropriate content can be deleted by site administrator modules; groups can determine the level of openness of the group and who is permitted to chat with whom, e.g., depending upon whether a member is validated, or the age of the member; the online platform can ensure groups are familiar with useful and free monitoring software, such as Windows Live Family Safety Setting or Zephyr; the online platform can enforce strict adherence to the Children's Online Privacy Protection Act (COPPA) by informing parents and legal guardians about how personal information is collected, used, and disclosed; and professional monitoring services can be made available to monitor websites, emails, and messaging for inappropriate material, and remove user profiles of known offenders.

User Profiles

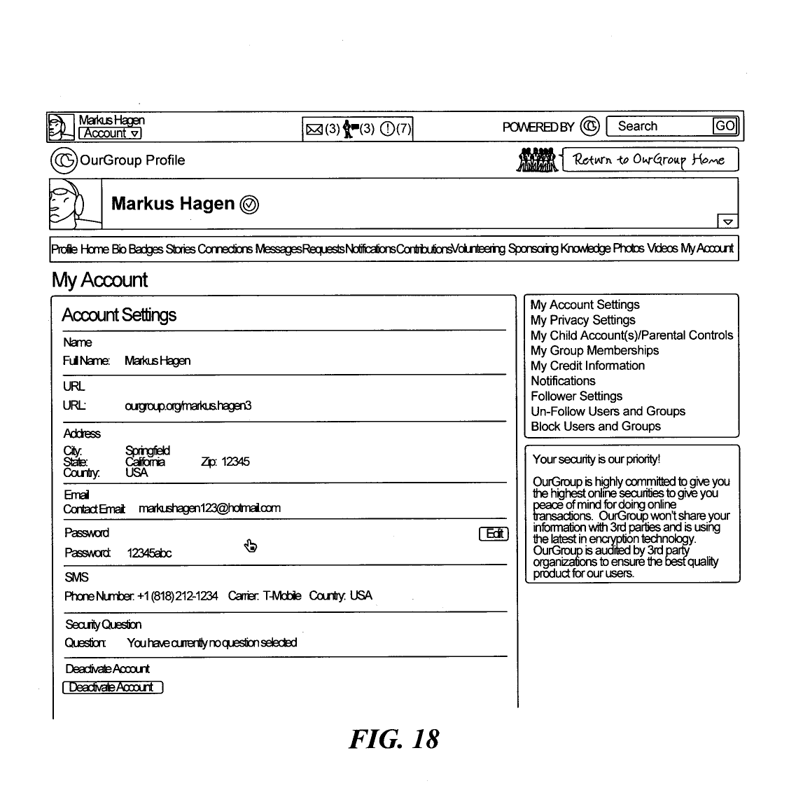

In some embodiments, the host server 120 includes the profile module 153. FIG. 1B-8 depicts a block diagram illustrating an example of components in the profile module 153. The profile module 153 can include, for example, a profile receiving module 153a and/or a profile page generation module 153b. The profile receiving module 153a queries an individual client and receives information about an individual who is registered with the online platform. FIG. 18 shows an example screenshot of account information maintained by the profile receiving module 153a that can be entered and/or edited by the member client. For example, the profile receiving module 153a can store and maintain, but is not limited to, the following information in an individuals database 182: name; URL; address; email address; password; phone number and country for receiving short message service texts (SMS); a selected security question; and whether the member wants to deactivate the member's account.

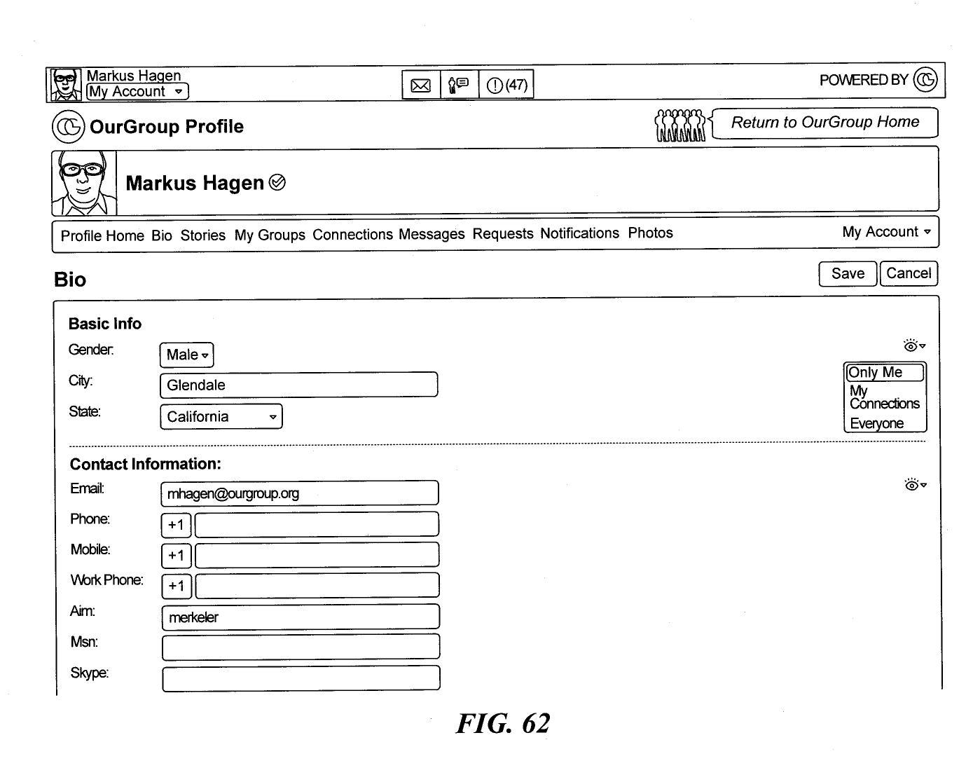

The profile receiving module 153a makes a subset of the profile information available on the individual's landing page, such as gender, city and state where the member client is located, and various contact information, such as email, and phone number. FIG. 62 shows an example page where profile information associated with a member client is listed. The profile receiving module 153a can also allow the member client to specify who can access the profile information, for example, just the member client, the member client's connections on the online platform, or every client who requests the information on the profile page of the member client. Based on the specification of the member client, the profile receiving module 153a adjusts the accessibility of the information to various clients.

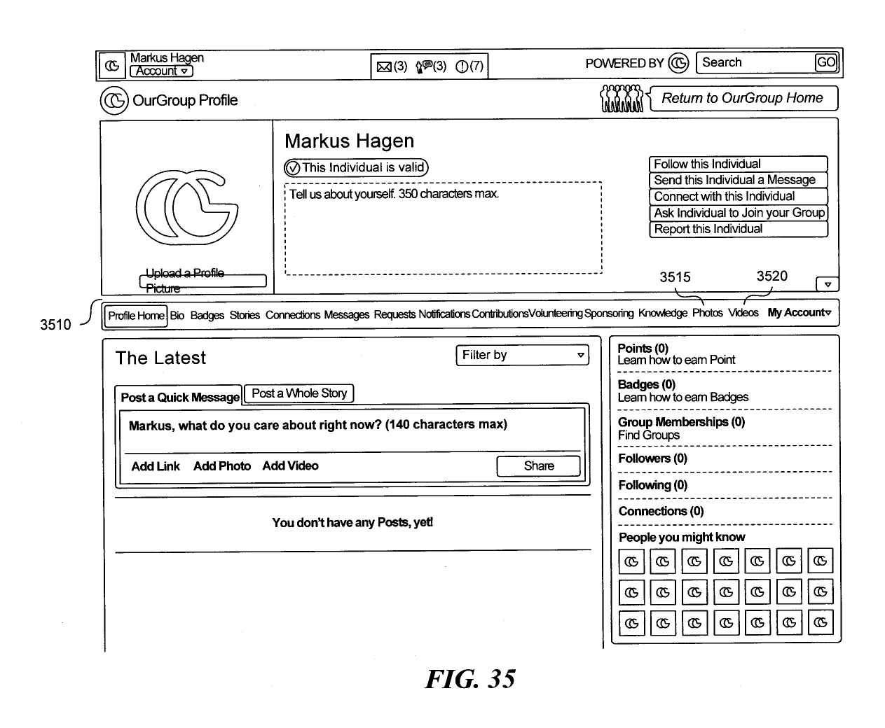

The profile page generation module 153b generates a profile page associated with the online platform for each registered member. The first time a member visits the member's URL within the online platform, the landing page or profile page will look like the example of FIG. 35. Actions that the member can take include uploading a profile photo, adding a statement about himself, finding groups, and posting a quick message. The quick message can include a link, a photo, and/or a video. Uploaded information and posted messages are received by the profile module 153 and stored in the appropriate database, for example, photos and videos are stored in the photos/videos database 186, statements are stored in the individuals database 182, and messages are stored in the messaging database 194. Posted quick messages are displayed on the member client's landing page.

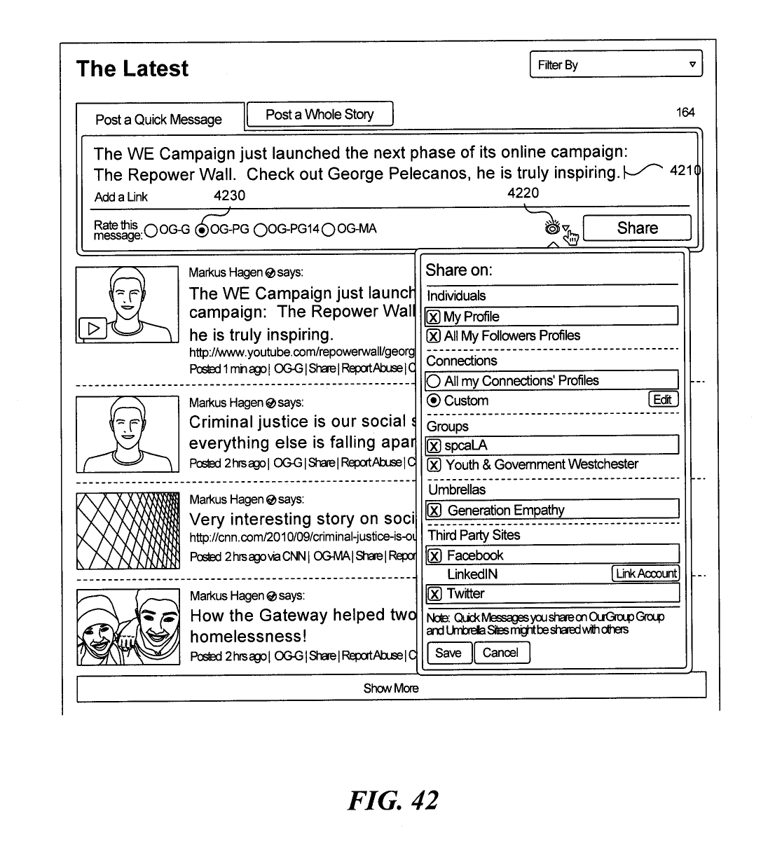

The example of FIG. 42 shows part of a profile page generated by the profile page generation module 153b where the member client is in the process of posting a quick message 4210 to the client's activity feed via the profile module 153.

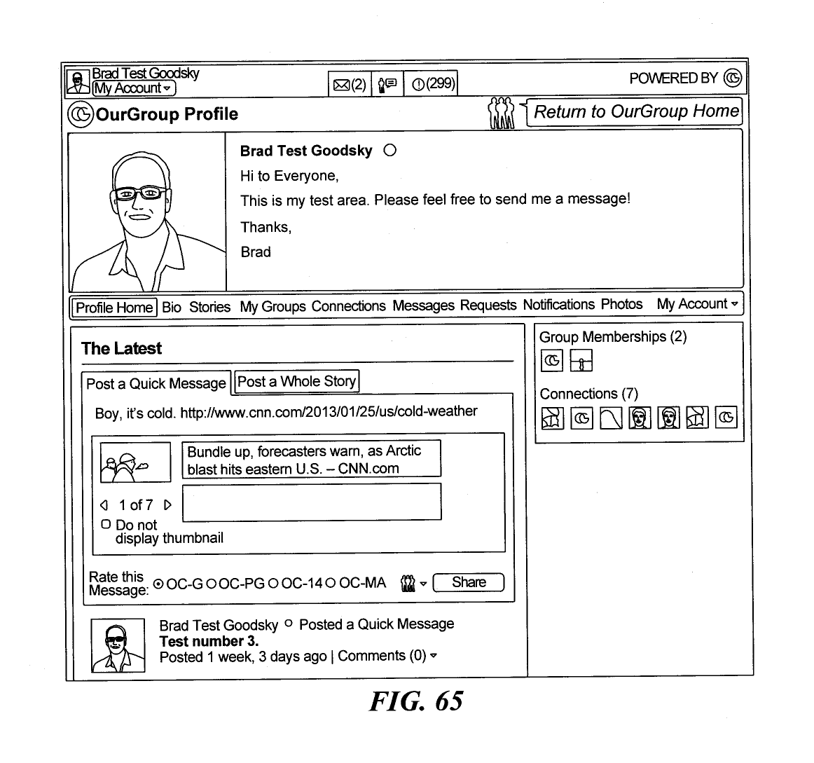

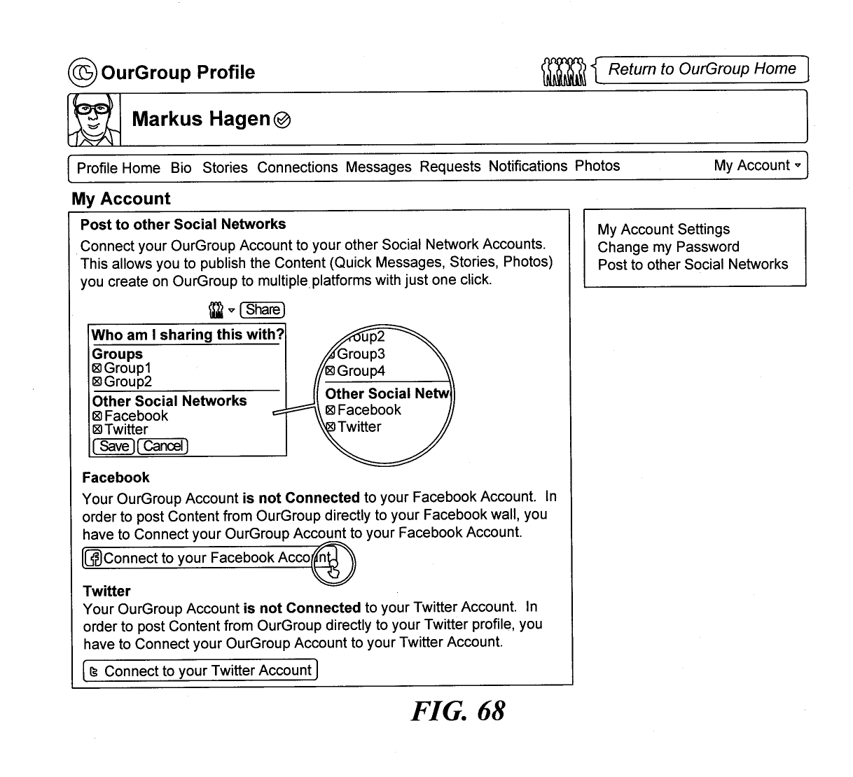

As shown in FIG. 65, when the quick message includes a link, the profile module 153 can show a preview of the link. The preview can include whatever tagged information is pulled in when the profile module 153 scrapes the content of the linked page. By clicking on the eye icon button 4220, the member client is prompted by the profile module 153 to select where the message should be posted for sharing. For example, the prompt can include selections such as the member's own profile and the member's followers' profiles; the member's connections' profiles; the landing page for groups that the member has joined; the umbrella groups for the groups that the member has joined; and third party sites such as social networking sites Facebook, LinkedIn, Twitter, and others. As shown in the example webpage of FIG. 68, the profile module 153 provides links to a member client for connecting the member's account with the online platform to the member's account of the appropriate third party social networking site. Subsequently, the member client can publish content, such as quick messages, stories, and photos that are uploaded to the online platform to the other connected social network accounts via the profile module 153.

Before the message is posted by the profile module 153 to the selected locations of the online platform, the member client also needs to enter a rating 4230 for the submitted message, as for all content posted to the online platform. The member's message is subsequently reviewed for an appropriate content rating by an administrator module of the online platform or of the group page where the member wishes to post the message via the content review module 157.

The member client can upload a profile photo by clicking on the ‘upload a profile picture’ button and selecting a picture file to upload. In some embodiments, the member client has the option to crop the uploaded photo. The member is also asked to rate the member's profile picture as, for example, G, PG, 18, or MA (mature audiences). Finally, the member must certify that the rights to use the photo are held by the member before the profile picture will be saved to the individuals database 182.

The member client can also upload photos and videos by clicking on the ‘photos’ button and ‘videos’ button, respectively. The process is described more below.

Account information associated with the member and stored in the individuals database 182 can include privacy settings that can be edited. Information maintained by the profile module 153 in the individuals database can include: people permitted to see the member's posts (including status updates, stories, photos, and videos), although privacy settings of a group to which a story is posted may override the member's privacy settings; people permitted to see the member's connections list, where the connections list allows the member to connect with people based on common friends; people permitted to see the member's bio, where the bio can help connect the member with classmates and colleagues as well as discover new professional opportunities; people permitted to see the member's current city, where the city can help the member get in touch with friends and old neighbors as well as find volunteer opportunities in the area; people who can see content that the members ‘likes’, where ‘likes’ express the member's interest and experiences as well as connect with people who like the same things; people who can see the member's volunteer hours; people who can see the member's contribution of resources; people who can see the member's group memberships; people who can see the member's badges; people who can search for the member on the online platform; people who can send the member connection requests; people who can send the member messages, where the messages can help identify a person before adding the person as a connection; people who can send the member invites to join their group; and people who can comment on the member's profile. Some options for the privacy settings include permitting everyone, just the member's connections, or nobody (just the member) to perform an action.

The stored account information provides information on any active child accounts, the ability to modify settings for an active child account, and the ability to create a new child account.

Further, the account information can include the member's active memberships with the option to click a button to cancel each membership. The information can also include canceled memberships with the option to click a button to re-join each group.

Payment information, such as credit card information or bank account with bank routing number, can also be maintained and edited in the account information for a member. By having payment information on file, a contribution can be made to any group registered with the online platform with the click of a button.

The member's account information also include notification options. For example, the member can select to be notified by online platform notifications, email or SMS when the member successfully makes a contribution, successfully uploads a video/story, successfully joins a group, or gets volunteer hours confirmed.

The member can select to be notified by online platform notifications, email, or SMS when someone, for example, comments on one of the member's stories/videos, comments on a story/video in the member's profile, comments on the member's links, comments on the member's profile, comments after the member on someone else's link, comments after the member on someone else's profile story, comments after the member on someone else's video, comments on a post that the member was tagged in, confirms a connection request, tags the member in a video, tags one of the member's videos, tags the member in a post, suggests a friend the member might know, has a birthday coming up, joins the online platform after the member's invite.

The member can also select to be notified by online platform notifications, email, or SMS when, for example, a group administrator module approves the member's request to join the group, changes the name of one of the member's groups, asks to join a group the that the member is the administrator for, a group makes the member group administrator, and changes the privacy setting of one of the member's groups.

The member can select to be notified by online platform notifications, email, or SMS when the online platform has a new feature update or has a group to recommend, and a new celebrity, athlete, or musician joins the online platform, or a disaster occurs.

A member's account can also have an editable follower setting, where the member can allow either everyone or just the member's connections to follow him. When a first member follows a registered user, the first member client receives status updates and stories from the registered user. A member can also ‘un-follow’ a specific user. Once a person is un-followed, that person no longer receives status updates and stories from the member. If the un-followed person is one of the members' connections, the connection status remains unaffected. It is also possible to un-follow a group so that the member will no longer receive status updates or stories from that group. If the member is a member of that group, the group membership remains unaffected.

Account information can also include users or groups that are blocked. Once a user is blocked, that person can no longer be the member's connection or interact with the member. Similarly, once a member blocks a group, that group can no longer interact with the member.

The profile module 153 also maintains a bio in the individuals database 182 for each member. Example bio information includes basic information, such as sex and city of residence; contact information, such as email and America Online Instant Messenger (AIM); education and work information, such as profession, employer, college, and high school; a biography; interests, and favorite quote. A member can select whether to share each of the portions of the bio with everyone, just the member's connections, or no one.

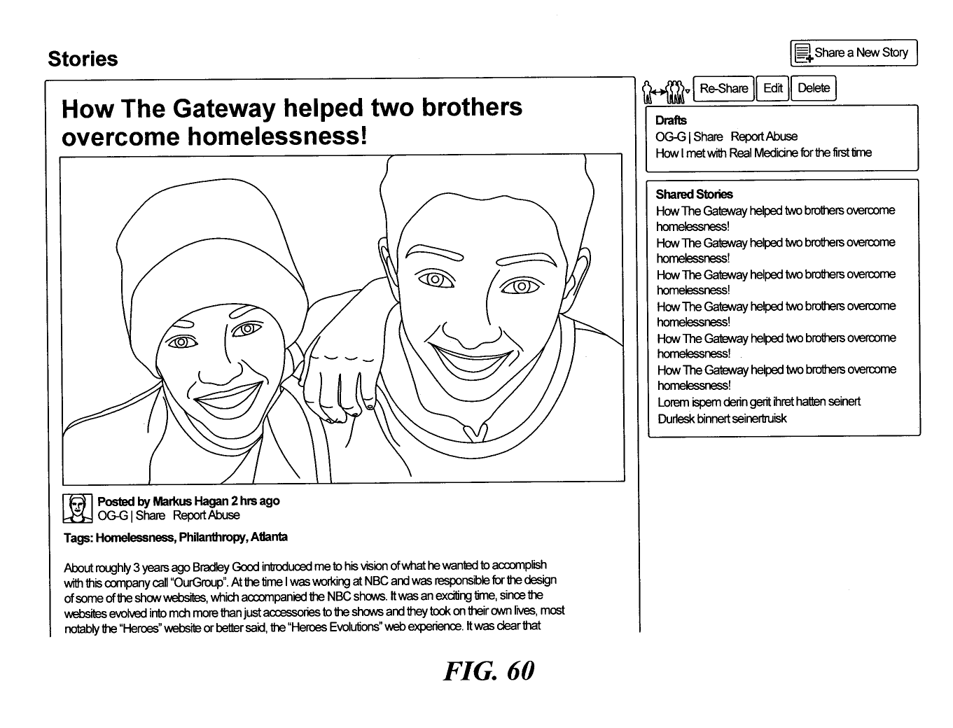

In some embodiments, the profile module 153 maintains a stories page for each member, where the member can upload stories, as shown in the example of FIG. 60. The member can upload photos and/or videos in conjunction with a story and add tags to the story. As with all other content uploaded to the online platform, the member must rate the content. The content may also undergo review by the administrator module of the group and/or the administrator module of the online platform.

In some embodiments, information pertaining to all registered individuals is stored in the individuals database 182.

In some embodiments, the profile module 153 performs the function of logging a member client into the online platform. The profile module 153 can verify that a user name and password provided by a member client match before allowing the member client access to the features associated with being logged in to the online platform.

Badges

In some embodiments, the profile module 153 awards badges and maintains badge information in the individuals database 182 pertaining to badges that a member has earned within the online platform. Badges are viewable by other members of the online platform. For example, a validation badge can be awarded after the platform cross-checks the member's information with credit card information provided by the member. The validation badge can indicate to other members that the identity of the badge holder has been confirmed. As another example, a first time donor badge can be awarded to a member upon the member's first contribution made on the online platform.

Awards

The online platform can issue awards and hold a ceremony to bestow the awards on a regular basis, for example annually. Non-limiting examples of awards include the most effective volunteer organization, the person who volunteered the greatest number of hours for a particular time period, the most successful supporter, the platform's “I Changed The World Today!” award for extraordinary acts of service, etc.

Connections

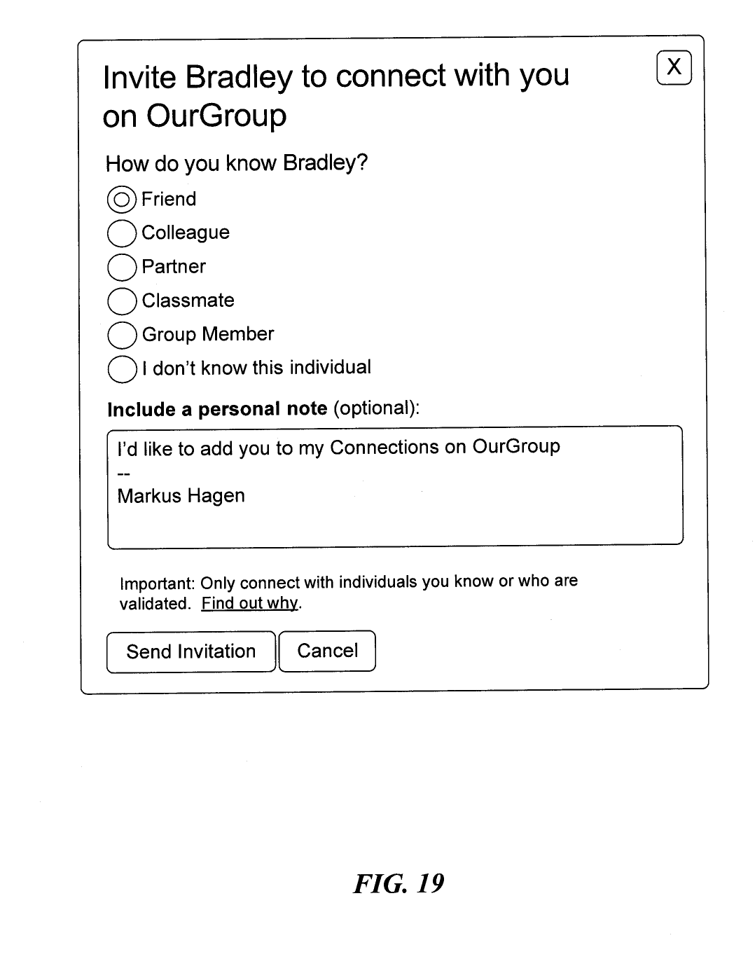

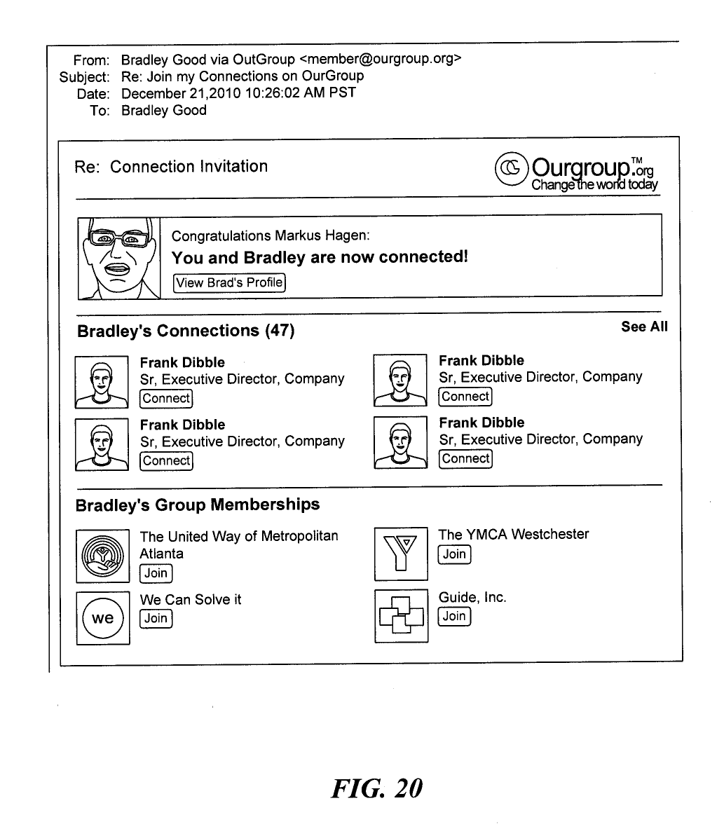

In some embodiments, the profile module 153 maintains connections for each member in the individuals database 182, and the invitation module 158 supports the ability of member clients to connect. In some embodiments, a ‘connect with individual’ button is provided on each member's profile page by the invitation module 158. As shown in the screenshot example FIG. 19, when a user client clicks on the button to initiate a connection with a member, the user may be queried by the invitation module 158 how the user knows the member, with possible selections including: friend, colleague, partner, classmate, group member, and the user does not know the member. The user client can include a personal note before sending the invitation via the invitation module 158 to the member. The invited member receives an invitation email or request from the user requesting a connection, and the member client is provided with clickable buttons in the email or request to either accept or ignore the invitation. In some embodiments, if the member client accepts the invitation, the user client is sent a return email indicating that the user and the member are now connected. Further, as shown in the example of FIG. 20, the email can include information from the member's bio, for example, some of the member's other connections and some of the member's group memberships.

In some embodiments, the invitation module 158 tracks the status of invitations sent by each member or group head or administrator module, such as whether an invitation was accepted, has not yet been accepted, as not delivered, or was deleted. Then, the member client can select invitations according to the status of the invitation. For example, a member client can select all recipients whose invitations that have not yet been accepted, and re-send the invitations to just those recipients.

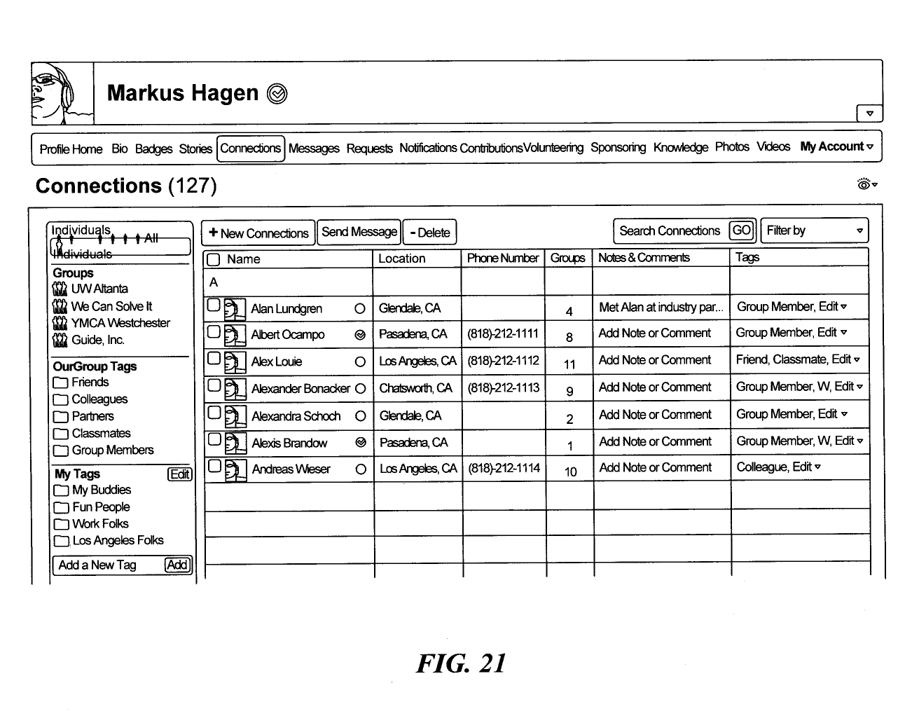

In the member's profile, the profile module 153 maintains a connections list for the member in the individuals database 182. For example, as shown in FIG. 21, all of the other members of the online platform to which the member is connected to are listed with information such as location, phone number, number of group memberships, notes/comments, and tags. Tags provided by the online platform, such as friend, colleague, partner, classmate, group member, can be used. The member can also create custom tags for other connected members, such as my buddies, fun people, work folks, Los Angeles folks. Additionally, there are clickable tabs to add a new connection, send a message to a selected connection, or delete a connection. Connections can also be searched by tags and filtered. Examples of filters include location, interests, any tag word, animals, children, cancer research, and common friends.

Events

In some embodiments, the host server 120 includes the events module 154 which receives, stores, and tracks information about events listed by or supported by groups or organizations. An administrator module of a registered group can enter information about an upcoming event, and the events module 154 receives and stores the event information in an event database 189. Information that can be provided and stored in the event database 189 and listed in the event center include the name of the event, where and when the event will take place, who the event is for, the number of people needed, and any other information the event organizer wishes to provide. Additionally, after the event, people who attended the event can rate and/or review the event and upload photos/videos from the event to share. The events module 154 receives the event ratings and reviews and stores them in the event database 189, and the photo/video module 166 receives the uploaded photos and/or videos and stores them in the photos/videos database 186. The respective modules, the events module 154 and the photo/video module 166, then make the provided information available on a webpage accessible from the group's home page.

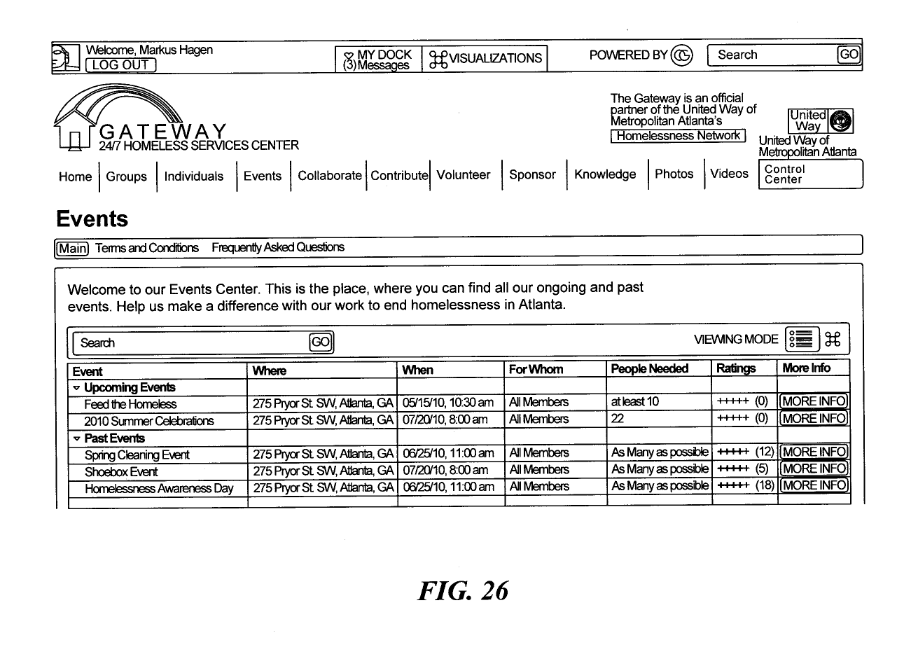

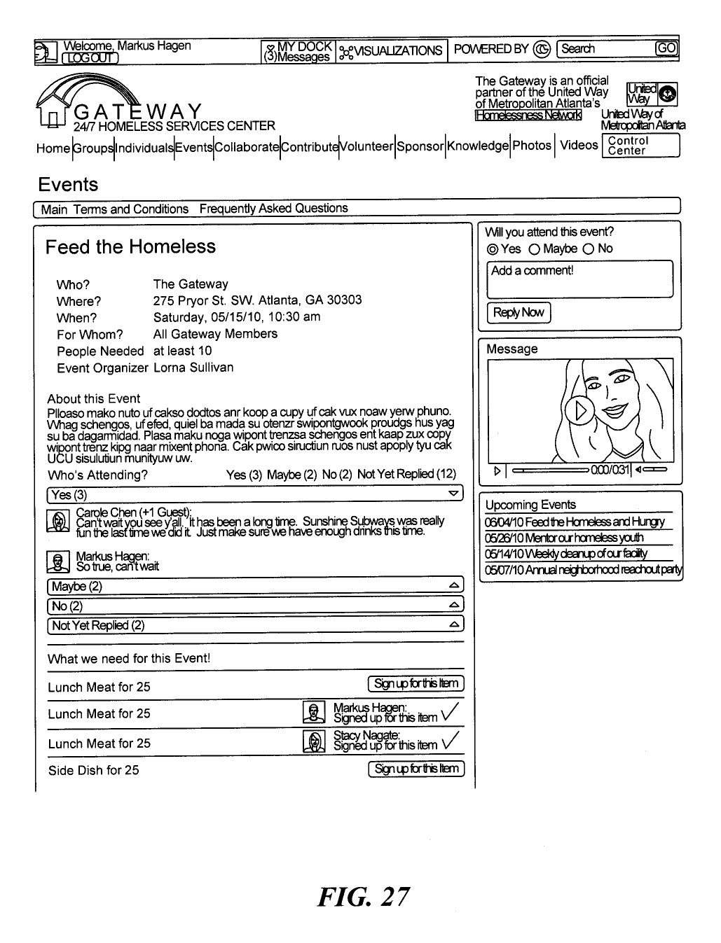

An events center can be accessed for each group by clicking on the ‘Events’ button on the toolbar 2240 on the landing page of the group. The example of FIG. 26 shows an example events center page for The Gateway, where upcoming events and past events are listed. If the event organizer provides further information, a link is provided for the event that provides more information. For example, FIG. 27 shows more information about the event, such as who has signed up to attend, the items needed for the event, and who has signed up to bring the items needed.

Collaboration

In some embodiments, the host server 120 includes the collaboration module 155. FIG. 1B-10 depicts a block diagram illustrating an example of components in the collaboration module 155. The collaboration module 155 can include, for example, a collaboration center webpage module 155a, a discussion tools module 155b, a scheduling tools module 155c, and/or a polling tools module 155d.

The collaboration center webpage module 155a generates the collaboration webpage and provides tools such as discussion tools, scheduling tools, and polls/voting tools, to enable member clients and groups to interact and collaborate. The collaboration center webpage module 155a provides links to different tools on a collaboration webpage available from the landing page for any registered group.

In some embodiments, the discussion tools module 155b provides a forum within the online platform for member clients of a group or member clients of all sub-groups under an umbrella group to have an online discussion, typically about topics related to the group or groups.

In some embodiments, the scheduling tools module 155c provides scheduling tools to allow members clients of a group to schedule meetings or other events involving multiple members.

In some embodiments, the polling tools module 155d provides polls/voting tools to allow a group to survey member clients of a group or any user client that visits the group's web page on the online platform.

In an example of how the collaboration tools can be used, one group can agree to let another group send a message to all of its members without releasing email addresses for its members. Essentially, the collaboration module 155 can act as an escrow agent.

Further, third party application developers can provide other online tools for groups and/or member clients of the online platform to use.

Marketing Tools

In some embodiments, the host server 120 includes the marketing module 165 which supports advertisement campaigns within the online platform. In some embodiments, the online platform is directed toward member interested in volunteerism and philanthropy who are registered with the online platform and use the tools provided by the online platform. Members of the online platform are an attractive audience segment, and groups such as United Way can target marketing campaigns directly at them using the online platform. For example, United Way can place advertisements on any or all of the pages of the sub-groups and supporter pages that use the tools offered by the United Way, the umbrella organization.

In some embodiments, the marketing module 165 accepts text, images, photos, and/or videos for advertisements from an advertiser along with target audience information and any other information associated with the ads, such as dates the campaign an advertisement campaign should run. The marketing module 165 then stores the ads and associated information in the marketing database 184. The marketing module 165 places the ads on the appropriate pages with the online platform, such as group pages, individual pages, and supporter pages.

Advertising

The online platform offers umbrella organizations the use of an advertising platform distinct from traditional marketing channels. Properly placed ads targeted at member who have expressed interests in philanthropy and even more specifically, the particular volunteer organization's cause, are likely to have significantly high than average response rates. Moreover, if the ads are created properly, they can have an important impact on evolving an individual's sense of unselfish concern and help evolve peoples' mindset toward volunteerism and providing resources. Umbrella volunteer organizations have an advertising platform that enables them to cement their brand identity online with the appropriate target audience. Additionally, online ad distribution has a relatively lower cost compared to traditional advertisement channels.

Community-Based Campaigns

In some embodiments, umbrella organizations can conduct community-based campaigns using the marketing module 165. For example, the United Way of Metropolitan Atlanta can conduct an Atlanta-wide community challenge. To heighten the prominence of this event and make it more fun, the United Way can solicit the involvement of celebrities, athletes, and musicians. These individuals can form groups and compete for points on their ability to successfully meet challenges. Other groups can set up to compete as well. This type of campaign is an effective way to involve individuals and groups on an ongoing basis, rather than having contact with contributors only once a year during a workplace campaign. Also once an individual signs up for a competition, the individual becomes a member of that umbrella organization and will become familiar with the online tools and applications. Finally, after the campaign is over, individuals will be accustomed to the functionality and the relationship with the umbrella organization and can spark ideas to start their own group. The community-based campaign can also be attractive to sponsors. For example, a sponsor like Coca-Cola can be integrated into the campaign which could result in substantial matching resources provided from the sponsor.

Contributing Resources

In some embodiments, the host server 120 includes the resource contribution module 156 which facilitates receiving information related to resources provided by users of the online platform and stores information relating to contributed resources in a resources database 188. FIG. 1B-11 depicts a block diagram illustrating an example of components in the resource contribution module 156. The resource contribution module 156 can include, for example, a resource tracking module 156a, a resource contribution distribution module 156b, a tributes module 156, and/or a resource contribution report card module 156d.

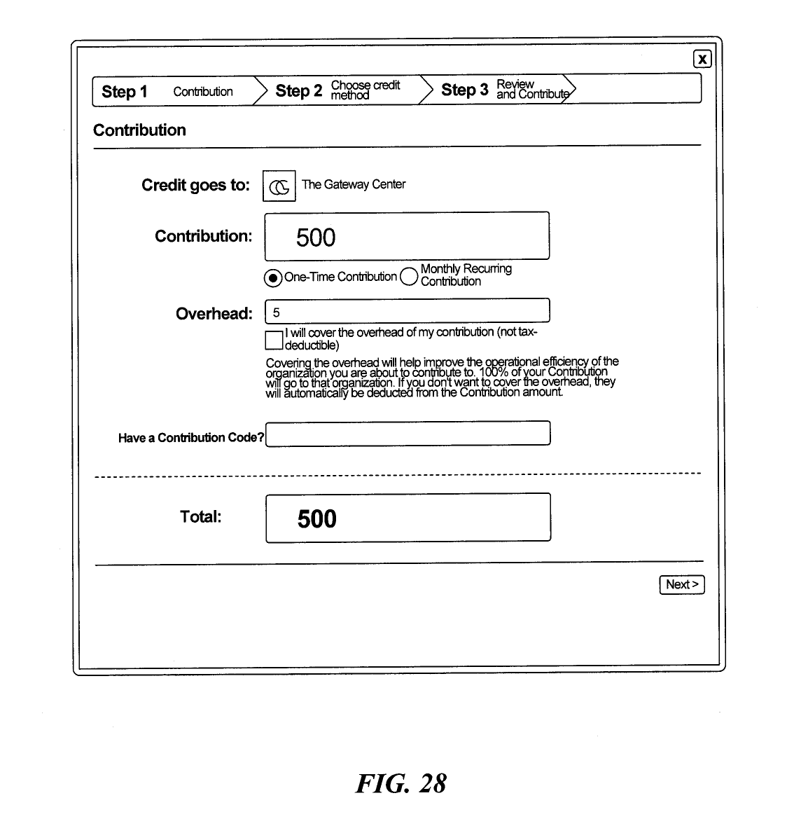

The resource tracking module 156a provides links for a member client to contribute resources from a webpage accessible from the member client's group's home page. On each group home page there is a clickable button for contributing resources to the group, for example the ‘contribute’ button 2255 in FIG. 22. An example of the screenshot shown to the user in the first step of the contribution process is shown in FIG. 28. The user is requested to enter the amount of resources to be provided to the group associated with the group page on which the user clicked the ‘contribute’ button. The user is also asked whether the contribution is a one-time contribution or a recurring contribution, for example, monthly or annually. There may also be overhead associated with making a contribution so the user is asked if the user wishes to cover the overhead for the contribution. The overhead can include charges associated with processing the method of contribution. Additionally, overhead credit can be recovered by the online platform to cover supporting the software tools provided by the online platform to the groups. The resource tracking module 156a tracks the resource contributions made by member clients, receives the resource contributions, and stores the resource contribution information in the resources database 188.

In some embodiments, the online platform can collect membership credits from individuals and/or groups via the resource tracking module 156a.

In some embodiments, a group may prefer not to have banner advertising on its website and can pay an opt-out credit to the online platform via the resource tracking module 156a.

In some embodiments, the online platform can levy a credit if a large amount of bandwidth is used by a group and/or its members via the resource tracking module 156a.

In some embodiments, the online platform can reserve the right to some higher profile URL (Uniform Resource Locator) properties, e.g. www/OurGroup.Org/Coke. These URL properties can be either leased or purchased by a customer via the resource tracking module 156a.

In some embodiments, outside parties and/or campaigners for accumulating credit can set up online tools for others and deduct their own processing credit via the resource distribution module 156b.

Tribute Pages

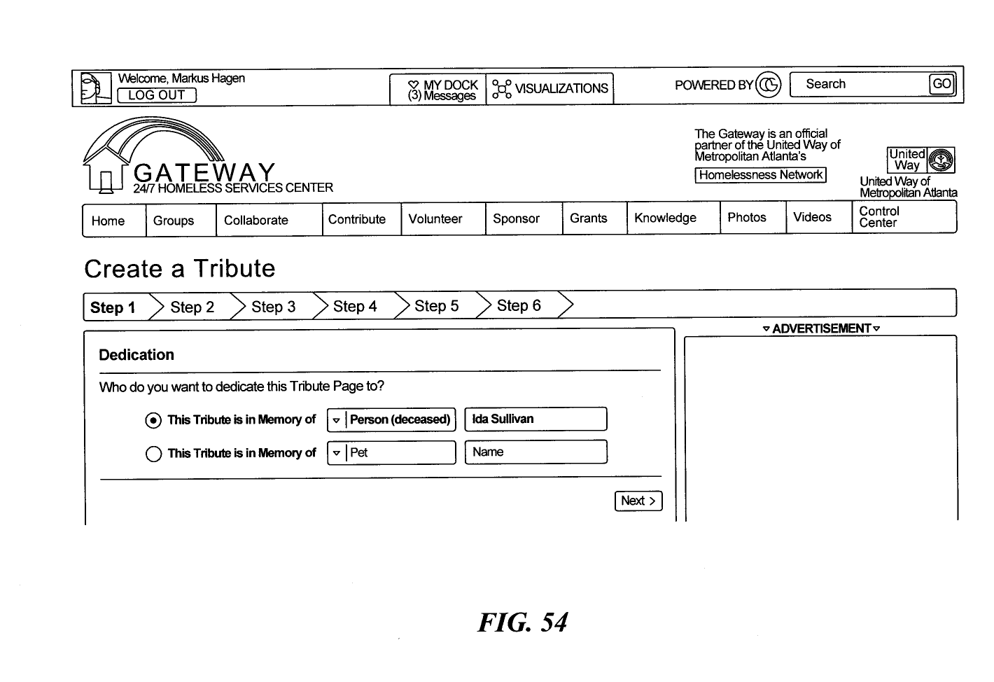

The tributes module 156c prompts and receives information for and establishes tribute pages on the online platform. Tribute pages are a way of honoring somebody's memory while also encouraging philanthropy. A tribute page can be created by a member client on the online platform with a few steps, beginning by clicking on a ‘create a tribute page’ button on a landing page of a group. Initially, the tributes module 156c requests that the member client provide information as to who the tribute page should be dedicated to. A screenshot of this step is shown in the example of FIG. 54. The member client can select a category of the entity that the page will be dedicated to, for example a deceased person or a pet. The name of the honoree should also be provided. Next, the member client is asked whether a resource contribution will be made, and if so, the details of the resource contribution, and whether the contribution is a one time contribution or a recurring contribution, billing information, and confidentiality information regarding whether the client member wants to publicly disclose the resource contribution.

The member client will then be prompted by the tributes module 156c to design the tribute page by entering a message for the tribute page, uploading a photo of the honoree, and providing a description of the honoree. The member client will be able to preview the tribute page via the tributes module 156c prior to posting the page live on the online platform.

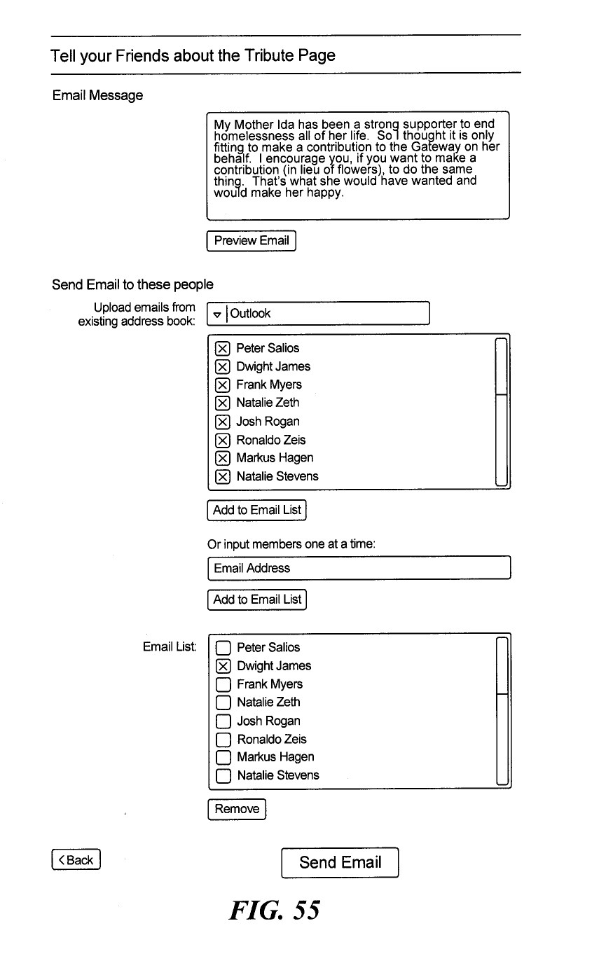

The next step is for the member client to inform people about the tribute page by email. An example of the web page used by the tributes module 156c to prompt the member client for information, such as the email message and email addresses of people to send the message to, is shown in FIG. 55.

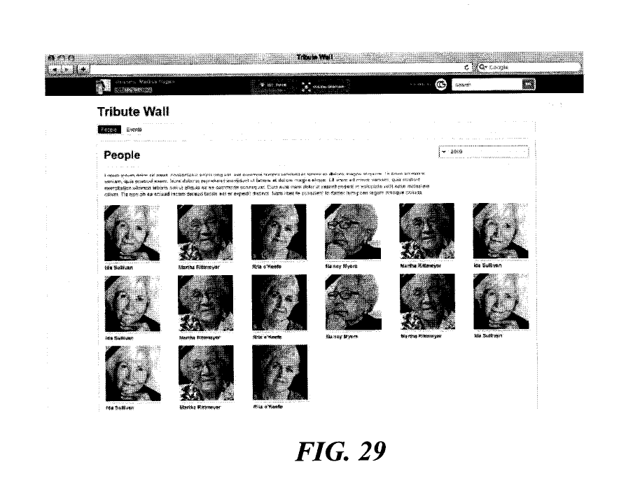

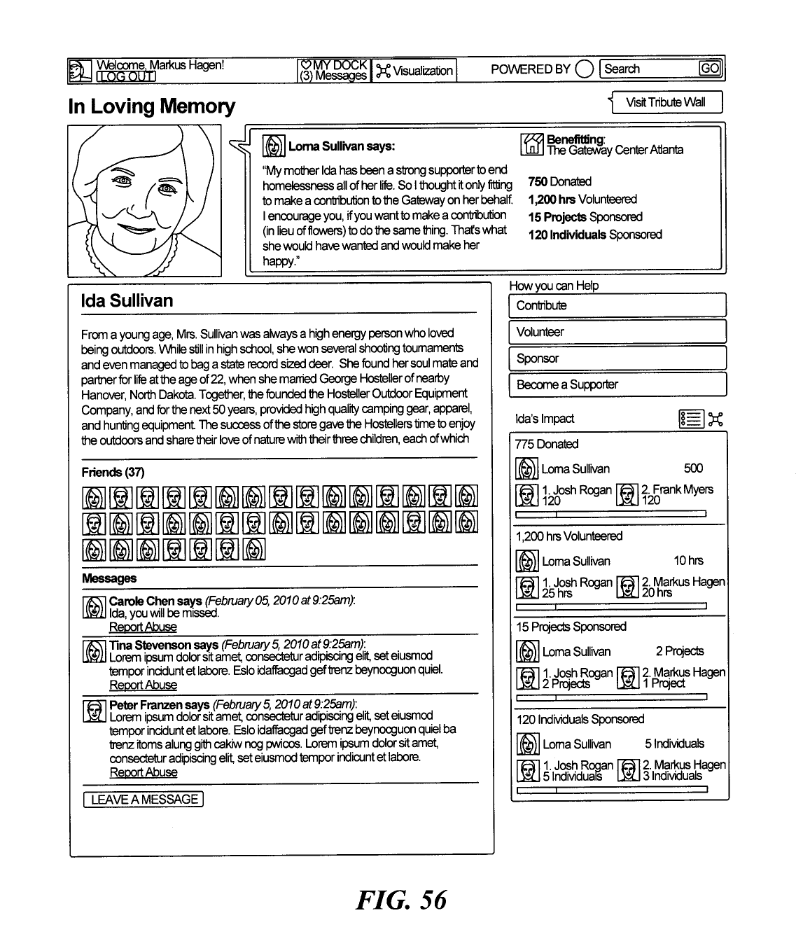

An example of a tribute page is shown in FIG. 56. The page can include the profile photos of people who contribute to the memory of the honoree, comments from viewers of the tribute page, and a summary of statistics related to provided resources attributed to the tribute page, for example the total amount of resources contriuted, the number of volunteer hours contributed, the number of projects sponsored, and the number of individuals sponsored. All of the information uploaded to the tribute page is stored in a tributes database 187. Each individual tribute is automatically rolled up into the group's Tribute Wall, where all tributes are displayed. An example Tribute Wall is shown in FIG. 29. The Tribute Wall encourages healthy competition.

In some embodiments, tribute pages can also be used for other special events, such as birthdays, weddings, rites of passage, etc.

In some embodiments, the resource contribution module 156 stores the information received about each contribution toward a tribute page in the resources database 188.

Resource Contribution Report Card

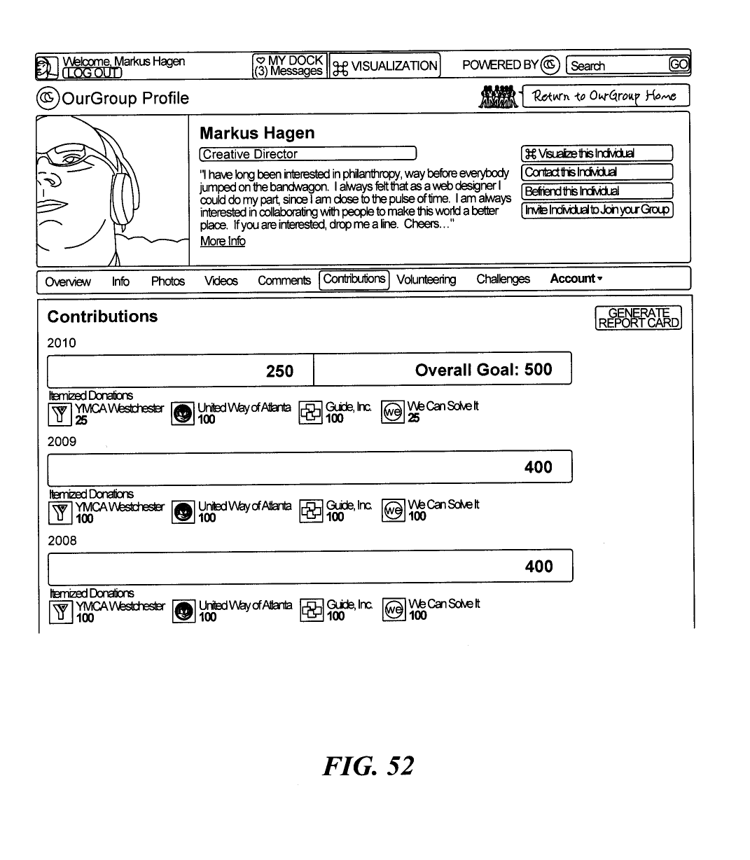

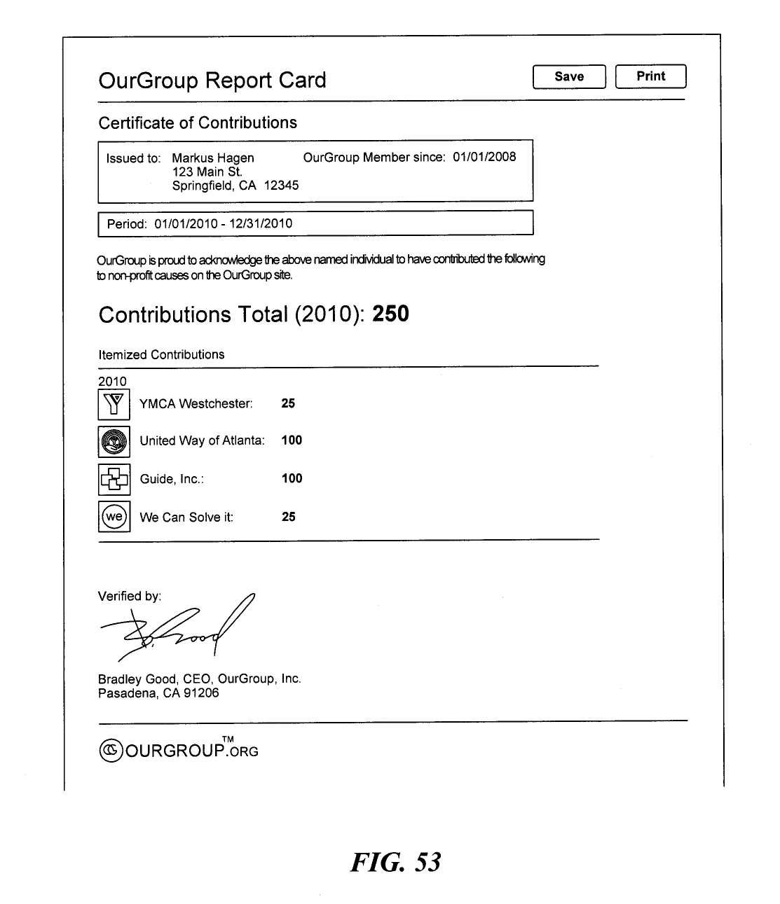

The toolbar 3510 on the user profile page includes a clickable ‘contributions’ button provided by the resource tracking module 156a. Clicking on this button takes the member client to a page maintained by the resource tracking module 156s that lists the amount of the resources that the member has contributed, which groups those resources were given to, and the amount of the contributions. The page can list the history of resources provided by the member, year after year. An example resource listing page is shown in FIG. 52. The member can set goals for providing resources that are tracked on this page. The member client can also click on the button “generate report card’ to get an itemization of the member's resources provided to the various groups and the date the resources were provided so that no receipts need to be kept, as shown in the example of FIG. 53. The report card is generated by the resource contribution report card module 156d using data stored in the resources database 188 and is also verified by the resource contribution report card module 156d.

Content Review

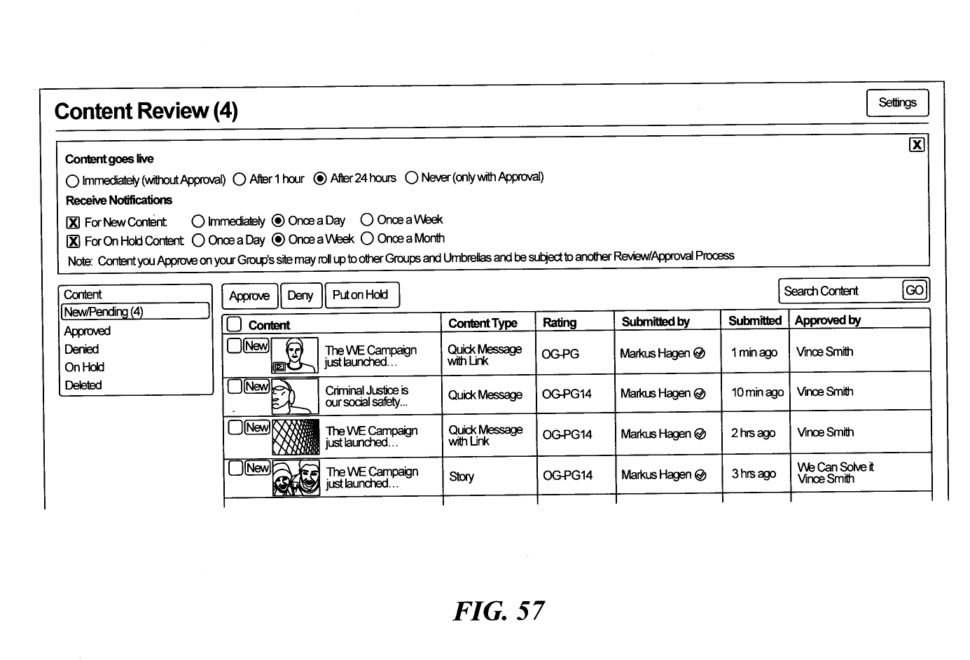

In some embodiments, the host server 120 includes the content review module 157 which maintains a content review center that allows administrator modules of a group or an administrator module of the online platform to review content submitted for posting before it becomes posted on the online platform. Review of submitted content to be posted on the online platform is a safety measure for providing an environment where members can safely interact with validated members. When a member client submits information for posting on the online platform within the member client's group, such as a story, photo, video, or knowledge file, the content review module 157 sends the content to the administrator module of the group for review and/or rating. The example of FIG. 57 shows a content review webpage provided by the content review module 157. A group administrator module can access the content review center to approve, deny, or put submitted content on hold after review, and the content review module 157 receives the review information and responds accordingly. That is, approved content is posted under the appropriate webpage of the group (e.g., under the knowledge, photos, or videos tab of the group's homepage), denied content is not posted, and content put on hold is not posted and awaits further review and input from the administrator module.

The administrator module can also change the submitter's rating of submitted content, if the submitter's rating is not appropriate, and the administrator module can optionally send a message to the submitter regarding the change in rating.

Also, the administrator module can modify review settings via the content review module 157. Examples of review settings that can be modified include the period of time submitted content goes live on the platform after submission, i.e., the amount of time the administrator is given to review the content prior to being published; how often the administrator module receives notifications for new content; how often the administrator module receives notifications for content put on hold; how long to keep approved content; how long to keep denied content; how long to keep content on hold; and how long to keep deleted content. The review settings are received by the content review module 157, and the content review module 157 follows the settings in notifying the administrator module of submitted content for review.

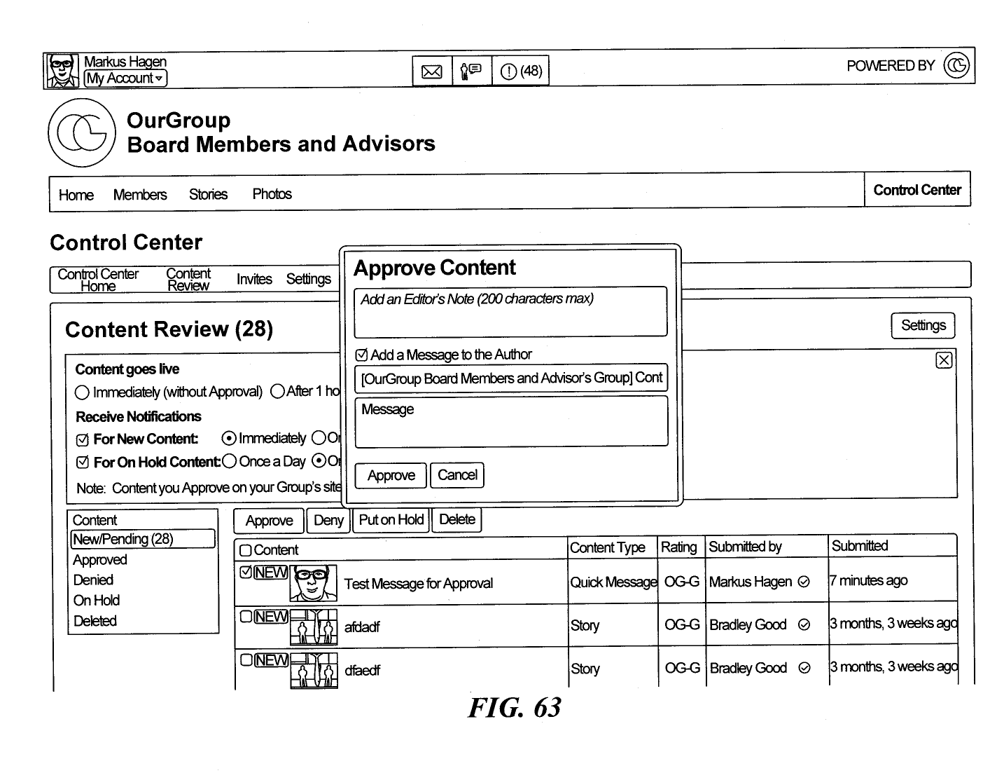

FIG. 63 shows an example webpage provided by the content review module 157 where the administrator module can send a message to a submitter of content regarding the administrator's modules review. The administrator module is provided an area to send a note to the submitter about the content, for example, stating comments about content that is approved for posting or reasons why content is denied approval for posting. Once the note has been sent by the administrator module, the content review module 157 sends the message as a notification or email to the submitter of the content in conjunction with the notifications module 171 or the email module 170.

Volunteering

In some embodiments, the host server 120 includes the volunteer module 159 which requests, receives, stores, and maintains information in the volunteer database 191 related to volunteering for each group on the online platform.

A group can provide its volunteer needs to the volunteer module 159. The volunteer module 159 then makes the provided information available on a webpage accessible from the group's home page, where the volunteer needs are listed in the group's volunteer center. Information that can be stored in the volunteer database 191 and listed in the volunteer center include the name of the opportunity, where and when the opportunity will be, who the opportunity is for, the number volunteers needed, and any other information the group wants to provide about the volunteer opportunity. Additionally, after volunteering, the individual can rate and/or review the organization on a number of different criteria, such as how efficient the organization is.

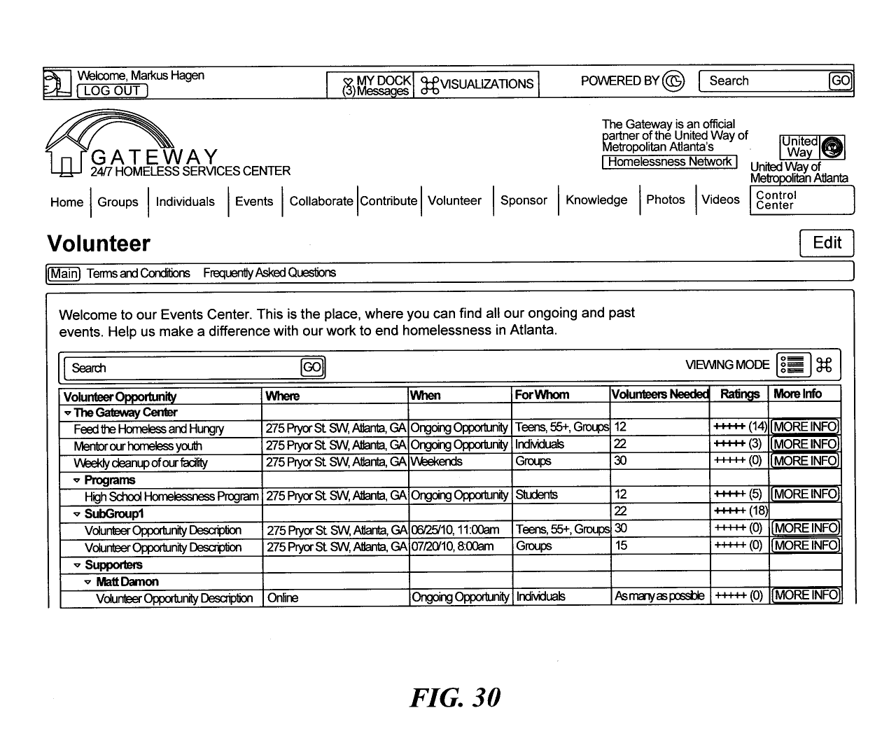

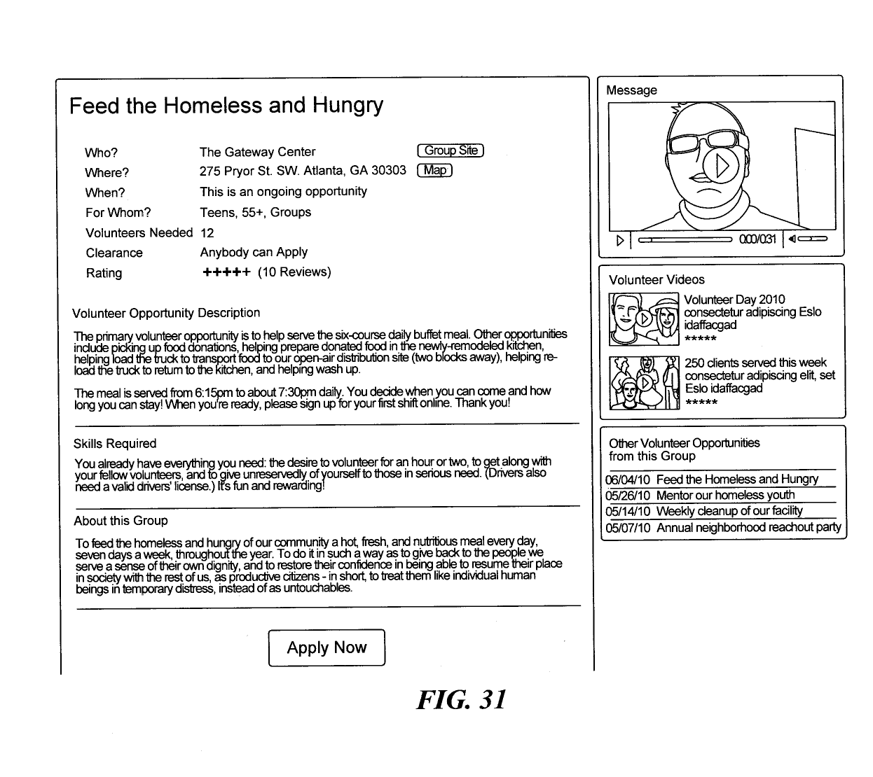

A volunteer center can be accessed for each group by a user client by clicking on the ‘volunteer’ button on the toolbar 2240 on the landing page of the group. The example of FIG. 30 shows an example volunteer center page for The Gateway, where volunteer opportunities are listed. Individual user clients can sort the volunteer opportunities using different criteria, review details about the opportunity, and apply to volunteer. If the group provides further information about the volunteer opportunity, a link is provided for the event that provides more information. When user clients visit the volunteer center, the reviews can also be accessed. The reviews provided by volunteers are an incentive for each group to be productive and effective. This information is also useful for individuals to determine if they would like to contribute to a particular group. The example of FIG. 31 shows a listing with more information about a volunteer opportunity that includes a clickable button for applying to volunteer.

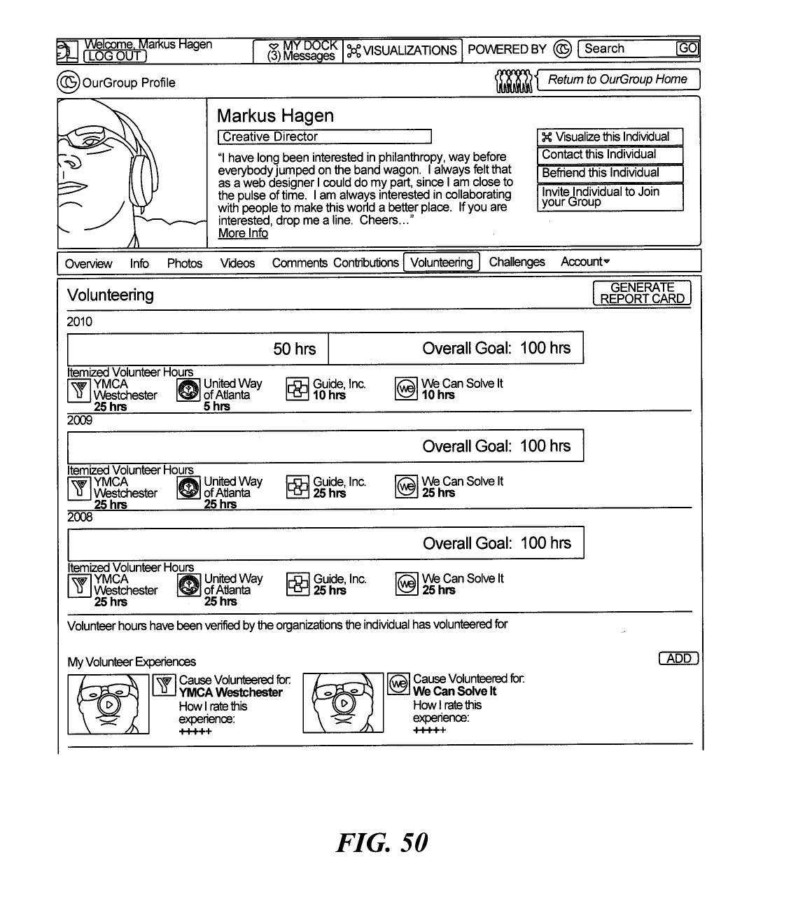

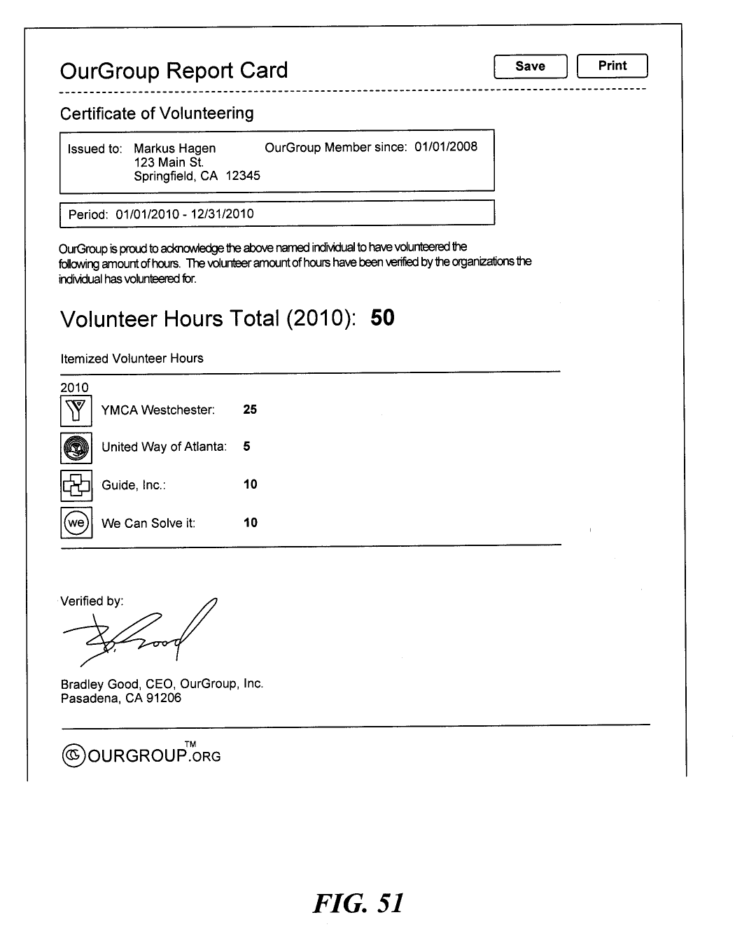

The toolbar 3510 on the user profile page includes a clickable ‘volunteering’ button. Clicking on this button by a user client takes the user client to a page maintained by the volunteer module 159 that lists the volunteer work that the member has performed, which groups the member has volunteered with, and how many hours the member has volunteered with each group. The page can list the volunteer history of the member, year after year. An example volunteering summary page is shown in FIG. 50. The member can set volunteer goals that are tracked on this page. Then an administrator module associated with the group that the member volunteers with will validate that the member has volunteered and the number of hours volunteered with the group. Validation information for volunteer hours is stored in the volunteer database 191. Once the volunteer hours are validated, they will automatically register in the user's profile. The user client can also click on the button “generate report card’ to get from the volunteer module 159 an authenticated verification of the hours volunteered that can be printed, as shown in the example of FIG. 51.

Sponsorships

In some embodiments, the host server 120 includes the sponsor module 160 which requests, receives, stores, and maintains information in a sponsor database 192 related to sponsorships made via the online platform.

A group can provide information to the sponsor module 160 about an individual who is working to help the group or a project associated with the group. The sponsor module receives the information and stores it in the sponsor database 192. The information can include the name of the individual or project, the location of the individual or project, and information about the individual or project. Individuals, companies, and foundations can access the sponsor center for groups for individuals and projects that are seeking sponsorship. The sponsor module 160 then provides information about the available individuals and projects looking for sponsorship in a sponsor center webpage for the group that can be accessed from the home page for the group.

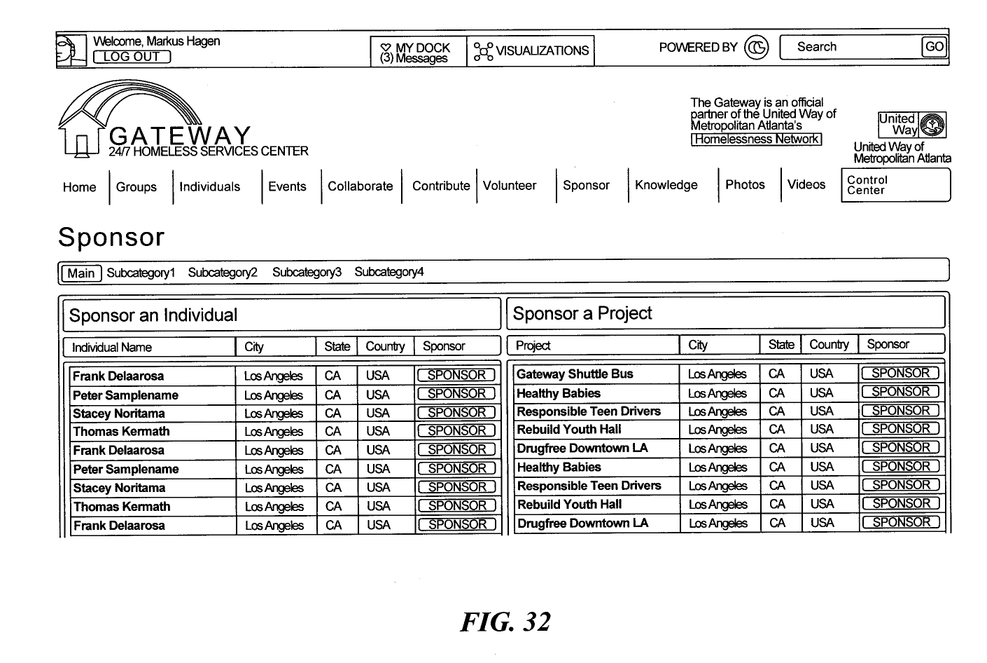

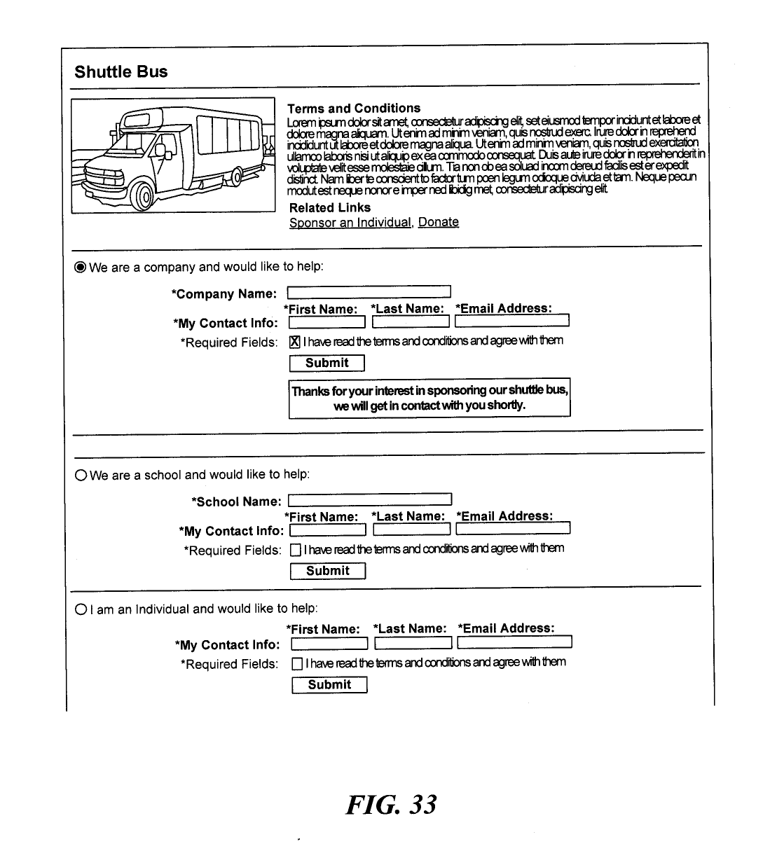

A sponsor center can be accessed for each group by a user client by clicking on the ‘sponsor’ button on the toolbar 2240 on the landing page of the group. The example of FIG. 32 shows a sponsor center web page for The Gateway where individuals and projects that can be sponsored are listed along with the location of the individual or project and a link to sponsor the individual or project. Upon clicking the ‘sponsor’ button, more information can be obtained by a user client, as shown in the example of FIG. 33 which has information about a shuttle bus project that can be sponsored and includes an online form for entering information to sponsor the project. The link for sponsoring an individual is similar.

Sharing Knowledge

In some embodiments, the host server 120 includes the knowledge module 161 which requests, receives, stores and maintains knowledge information in a knowledge database 185, such as documents and other types of content, for sharing with others.

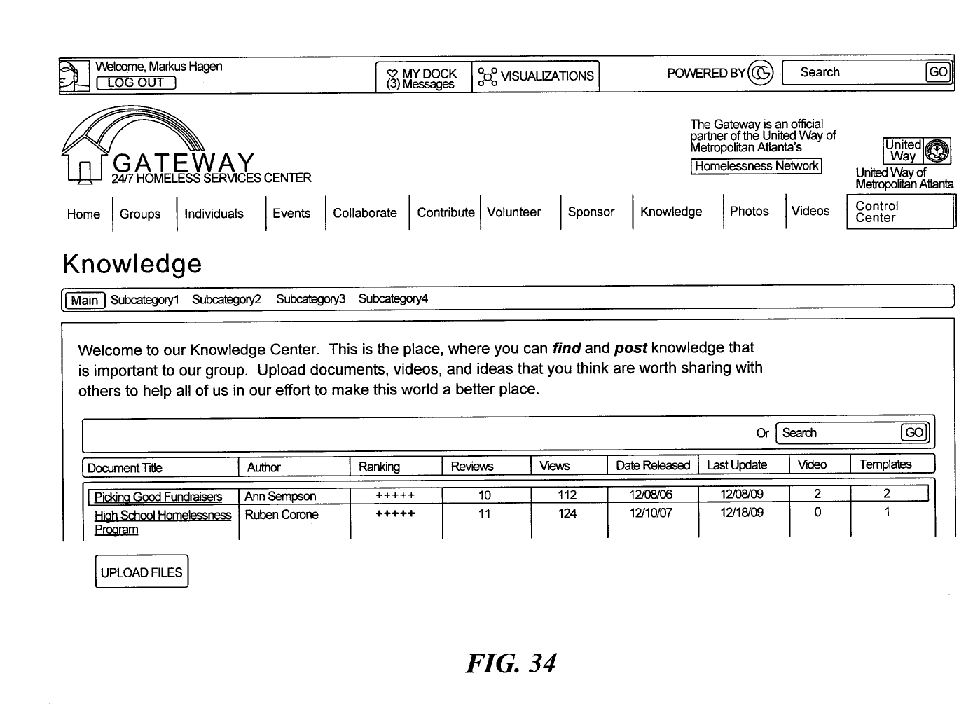

A group can provide the documents or other content to the knowledge module 161, and the knowledge module 161 then provides the available documents/content in a knowledge center webpage for the group, where the knowledge center webpage is accessible from the home page for the group. For example, The Gateway has a very successful High School Homelessness program that it may want to share for use with other homeless shelters. In another example, the coaches at the YMCA can share lesson plans. Information deposited in the knowledge center can be made available to everyone, or limited to validated members of the group. FIG. 34 shows an example knowledge center page for The Gateway. Each document can list information such as author, ranking, number of reviews, number of views, date released, last update, number of videos and number of templates. A clickable button is provided for uploading files by a member client to the knowledge center via the knowledge module 161.

Photos and Videos

In some embodiments, the host server 120 includes the photo/video module 166 which receives photos and videos uploaded to the online platform and stores and maintains them in a photos/videos database 186. The photo/video module 166 makes the provided photos and videos available on a photos webpage and a videos webpage, respectively, that is accessible from the group's home page. A photos center and a videos center can be accessed for each group by a user client by clicking on the ‘photos’ button and the ‘videos’ button, respectively, on the toolbar 2240 on the landing page of the group. Any client with authority can upload photos to the group for sharing. The administrator module of the group can determine who can upload photos and videos. For example, uploading of photos and videos may be limited to validated group members. In one scenario, a validated member may wish to post photos, videos, and/or stories from the member's experience volunteering with the group to share with others. The member will also be able to elect to post the member's photos, videos, and/or stories on other social networking sites, such as Facebook and Twitter.

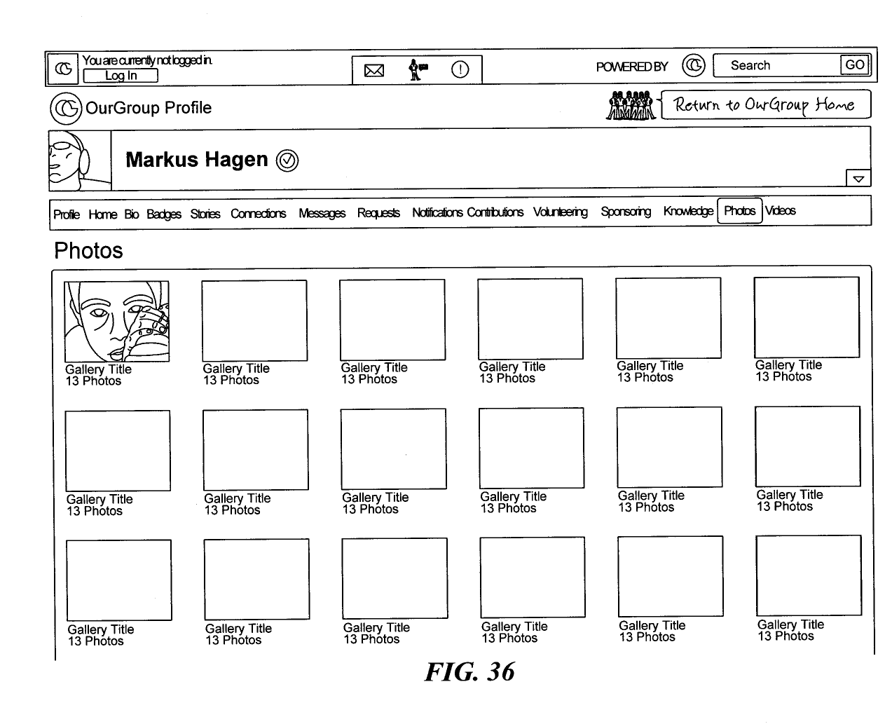

Additionally, a photos center and a videos center can be accessed on the landing page of a member by clicking on the ‘photos’ button 3515 or ‘videos’ button 3520 as shown in FIG. 35. The owner of the individual landing page can upload photos to the owner's photos center page. The photos center web page of an individual in FIG. 36 shows a list of thumbnails of the different available photo galleries, provided the visitor to the photos center web page meets the privacy settings for viewing the galleries. The member client can upload photos to the photos page by clicking on the ‘upload photos’ button 3630 shown in FIG. 36 to select photos stored on a computer for uploading. Along with uploading photos, the member client can name the gallery, set privacy settings for the gallery, and rate the photos. Tags can also be added to each photo. The member client can also delete any of the photo galleries by rolling over the gallery thumbnail and selecting the delete option.

Upon clicking the photo gallery thumbnail of a specific photo gallery on the photos center web page, the visitor client is taken to the photo gallery page where the visitor client can navigate through the photo gallery. If the visitor client is not a member of the online platform or is not logged in, the visitor client cannot comment, ‘like’ a photo, or report abuse, for example, the photo is not properly rated. However, the visitor client can share the page even if the visitor client is not a member or is not logged in to virally spread information from the online platform. Moreover, if the visitor is not a member or is not logged in, only photos rated G and PG will be displayed to the visitor client.

Control Center

In some embodiments, the host server 120 includes the control center module 162. FIG. 1B-9 depicts a block diagram illustrating an example of components in the control center module 162. The control center module 162 can include, for example, a group information receiving module 162a, a filtering module 162b, a statistics tools module 162c, a permissions module 162d, a control center webpage generation module 162e, an invitation tracking module 162f, and/or a control center display module 162g. The group information receiving module 162a queries an administrator module in the form of webpage requests, receives provided group information, and stores and maintains the information regarding each group in the groups database 181. Information maintained by the group information receiving module 162a are accessible at the control center web page and includes details on the group profile, members of the group, and statistics pertaining to resource contribution, access/viewing controls, etc.

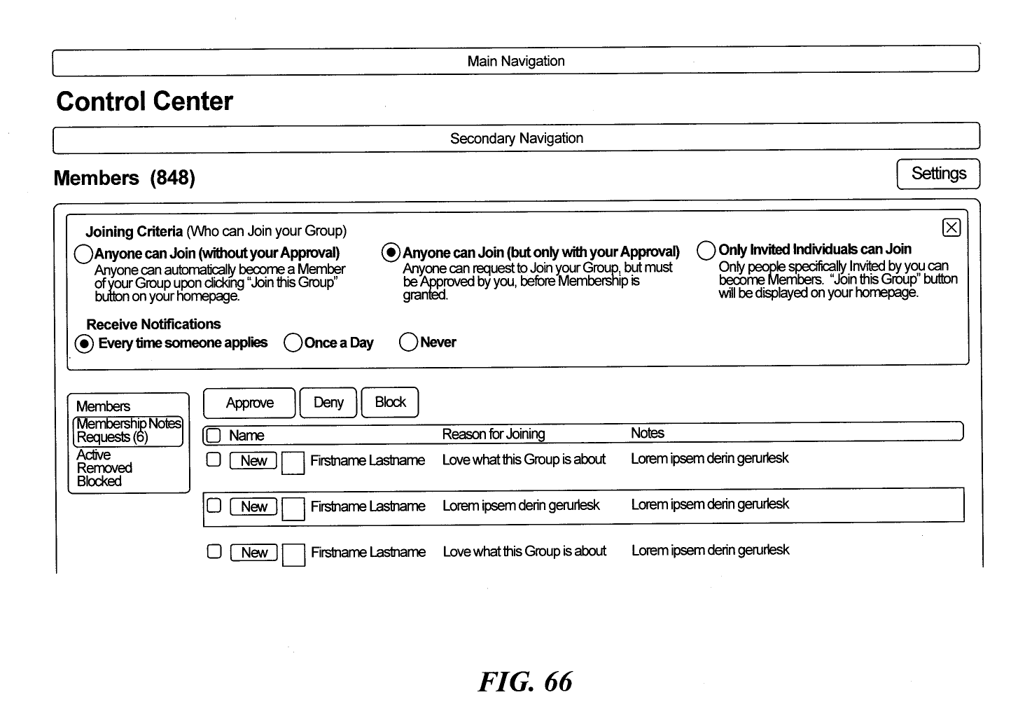

In some embodiments, the group information receiving module 162a can request from the administrator module of a group whether the group will be moderated or unmoderated, as shown in FIG. 66. With an unmoderated group, clients can automatically join the group without approval of the administrator module of the group. With a moderated group, there are two different types. For the first type of moderated group, clients can join the group but member clients are approved by the administrator module. For the second type of moderated group, only member clients invited by the administrator module can join the group. Once the permission module 162d receives the information regarding the type of group, the information can be stored in the groups database 181 and applied when a member client submits a request to join the group.

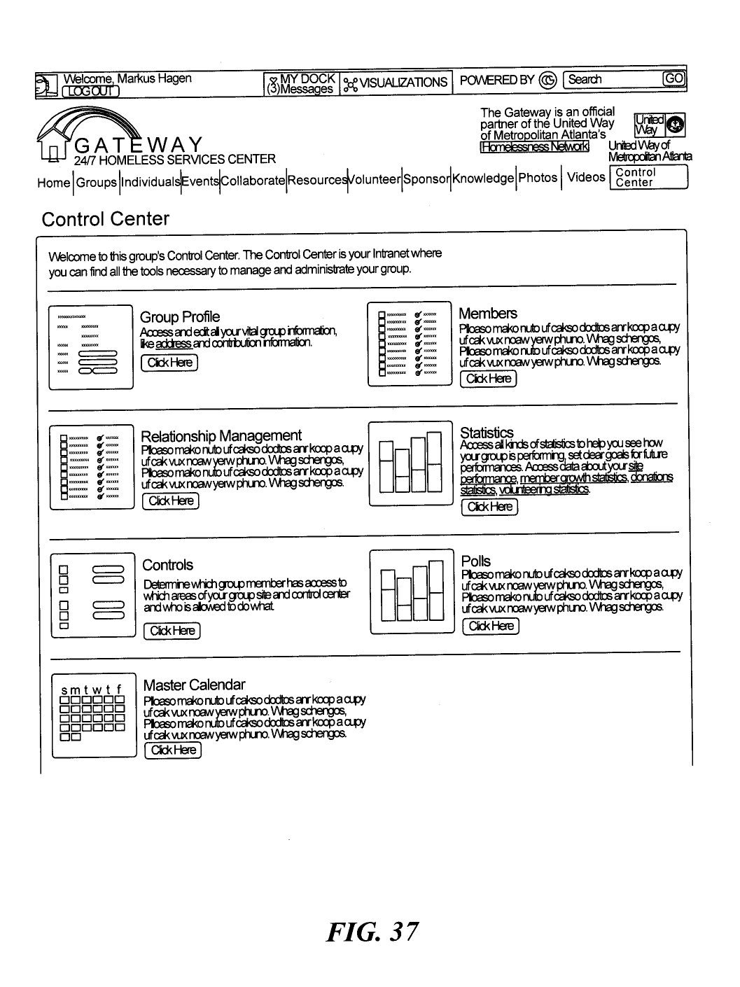

Groups information obtained by the group information receiving module 162a can be used by an administrator module or a designated member client of the group to enable professional management of the group. An example of a control center web page is shown in FIG. 37.

The control center webpage generation module 162e generates the control center webpage and provides tools for managing and administrating a group in the control center webpage for the group. The control center webpage generation module 162e also provides links to the tools and the control center webpage for a group that are accessible from the group's home page. The control center web page can be accessed for each group by clicking on the ‘control center’ button on the toolbar 2240 on the landing page of the group.

In some embodiments, the control center web page includes contact information for the group, such as physical address and phone number, and account information, such as bank name, routing number, and account number. The group administrator module can edit the information.

In some embodiments, the control center web page includes membership information for the group. Members of the group and each sub-group can be listed with information such as status (group head, validated, not activated), the date that a member joined the group, the URL for a member's profile page, and a link to contact information for the member.

In some embodiments, the filtering module 162b filters the information stored in any of the databases used by the online platform, the groups database 181, the individuals database 182, the supporters database 183, the marketing database 184, the knowledge database 185, the photos/videos database 186, the tributes database 187, the resources database 188, the event database 189, the feedback database 190, the volunteer database 191, the sponsor database 192, the help database 193, and the messaging database 194. The filtering module 162b can filter the stored information based on specific criteria selected by the administrator module or member client accessing the control center webpage. In some embodiments, the filtering module 162b can perform filtering based on standard filters, for example, member growth for a group, or member growth for all sub-groups of a particular umbrella group.

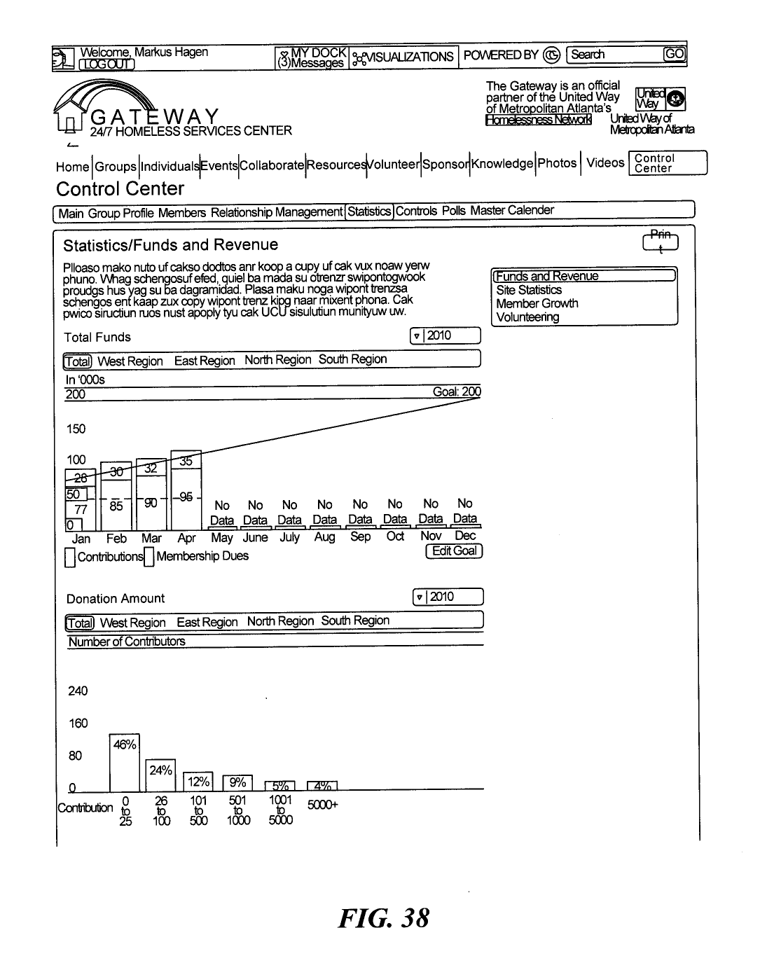

In some embodiments, the statistics tools module 162c works in conjunction with the filtering module 162b to provide access to statistical tools on the control center web page that can be applied to information stored in one or more of the databases, such as to evaluate resource contribution, as shown in the example of FIG. 38. For example, total resource contribution is broken out into provided resources and membership dues. In some embodiments, the statistics tools module 162c and the filter module 162b work in conjunction with the control center display module 162g to provide the information requested by the administrator module or member client. For example, the control center display module 162g can plot resources contributed to a group on a monthly basis or the total number of contributors by resource contribution. Additionally, the number of member contributing certain amounts of resources can be plotted. Each of the plots can be selected for different regions, such as west, east, north, and south. Different regions may be used for tracking members of a group, for example, within a particular swim team at a particular YMCA, individuals from different regions or areas can be set up to foster competition.

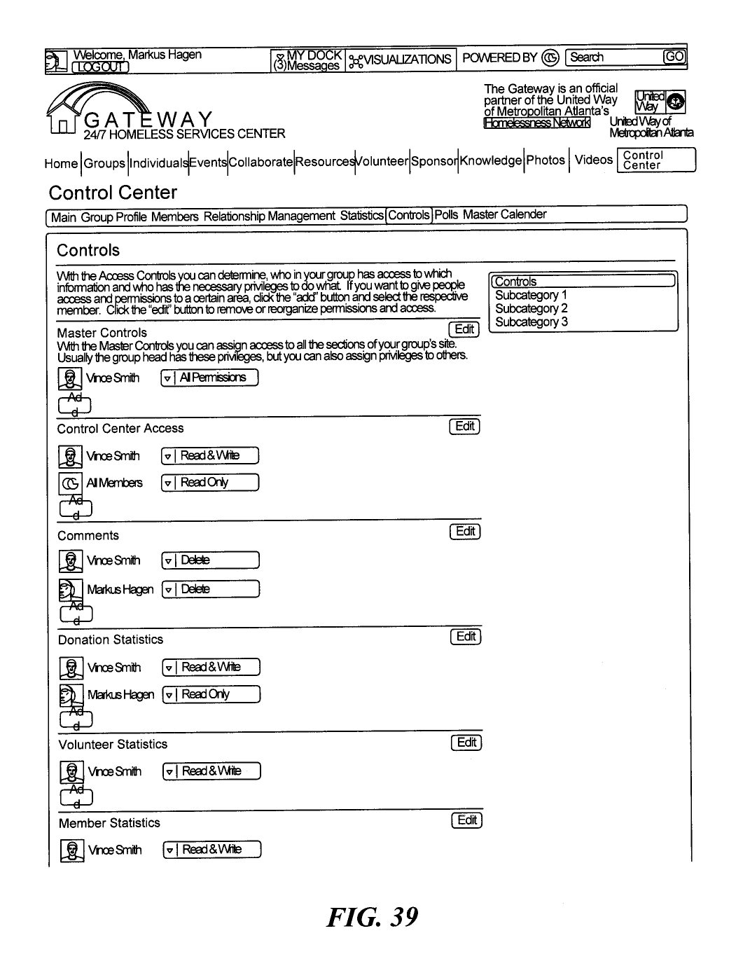

In some embodiments, the permissions module 162d provides access controls on the control center web page to determine who in the group has access to which information and who has the necessary privileges to do what, as shown in the example of FIG. 39. Access and permissions can be added and edited by the administrator module or designated member clients of the group. Master controls permission allows a member client with this permission to access all sections of the group's site. Other categories include control center access, comments, resource contribution statistics, volunteer statistics, and member statistics. Permissions can include ‘read only’ and ‘read and write’.

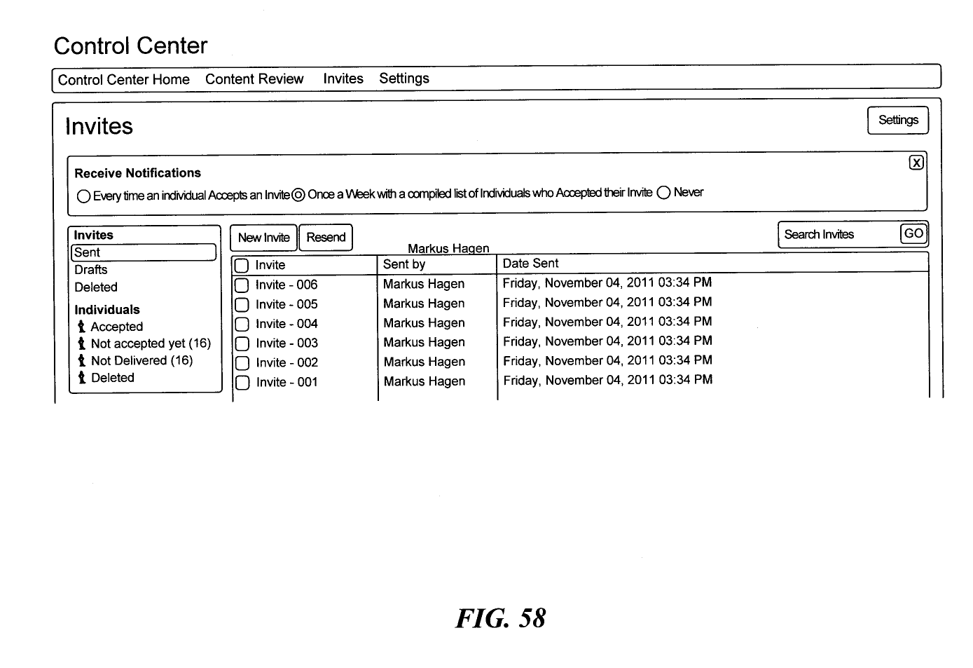

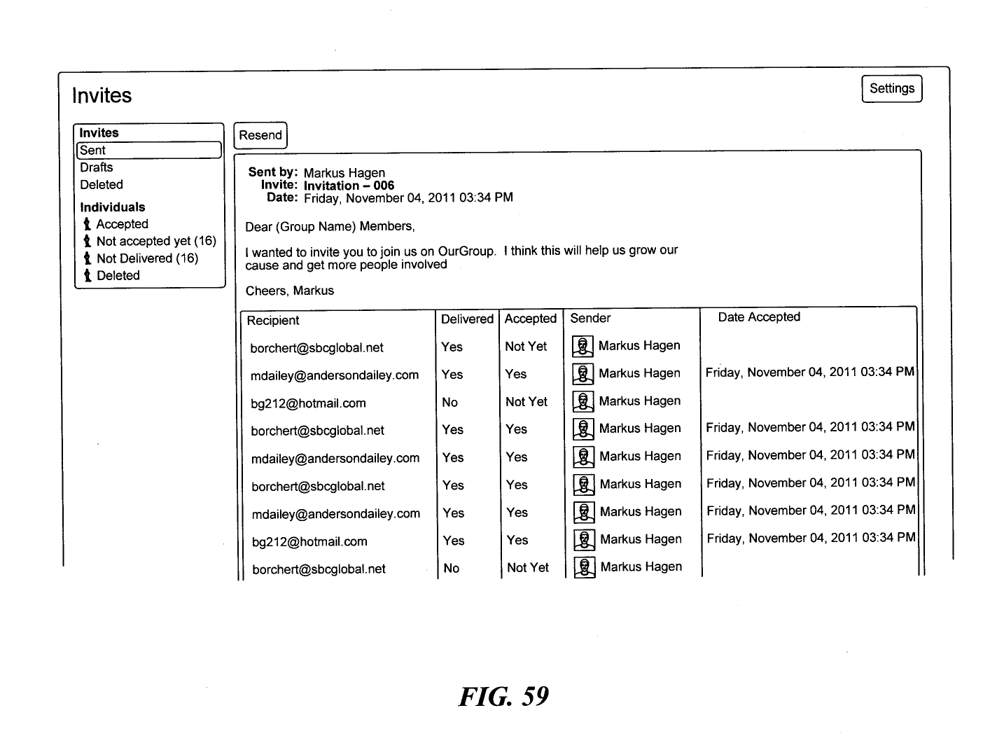

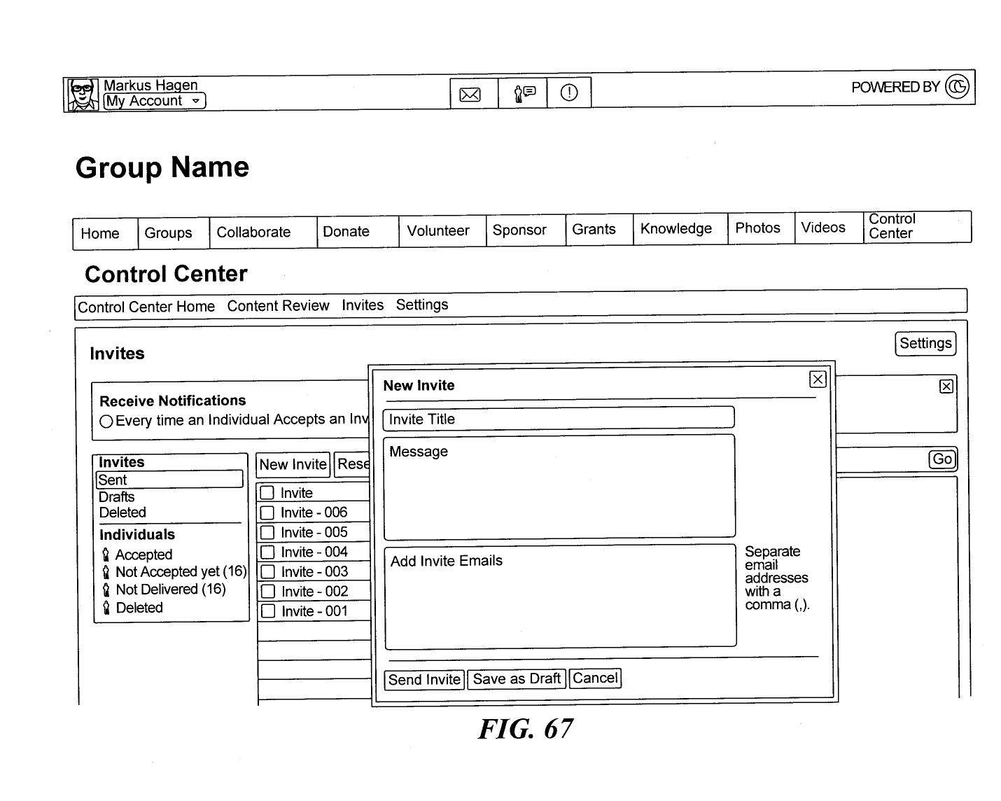

In some embodiments, the invitation tracking module 162f tracks invitations that have been sent from the online platform by the administrator module of a group and which member clients responded to the invitations. For example, invitations sent by a group administrator module to individual member clients to join the group can be tracked, as shown in the example of FIG. 58. In this example, six invitations have been sent by the administrator module on Nov. 4, 2011. The administrator module can request a listing of member client recipients to whom a particular invitation was sent, and the control center module 162 can provide the listing along with information such as whether the invitation was delivered, whether the invitation was accepted by the member client recipient and if so, the date it was accepted, and the sender, as shown in the example of FIG. 59. In some embodiments, the administrator module can select a listing of member client recipients according to whether the invitation was accepted, not accepted yet, not delivered, or deleted. For example, the administrator module can re-send the invitation to the recipients who have not yet accepted the invitation and to the recipients to whom the invitation was not delivered. FIG. 67 shows an example window opened by the control center module 162 to facilitate the sending of a new invitation or the re-sending of a previously sent invitation to member clients.

In some embodiments, the invitation tracking module 162f also tracks invitations that have been sent by member clients of the online platform, in a similar manner that invitations tracked by an administrator module are tracked.

Feedback from Users

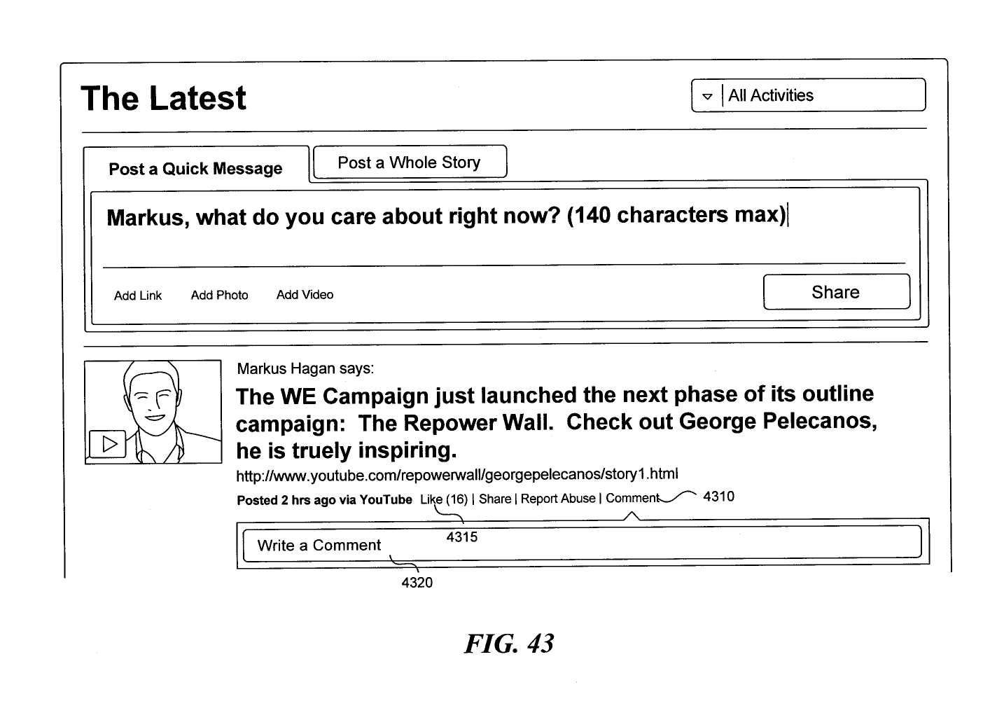

In some embodiments, the host server 120 includes the feedback module 163 which receives, stores, and maintains in a feedback database 190 feedback from users, such as ‘like’, ‘share’, reporting abuse, and comments for content posted on the online platform, such as photos, videos, documents, stories, and messages. All content posted on the online platform have a feedback bar that includes links to ‘like’ ‘share’, report abuse, and provide comments regarding the content. An example of a feedback bar 4310 is shown for messages posted to a member's profile page in FIG. 43. A similar feedback bar can be used for content posted to the online platform. The feedback module 163 tracks the number of people who select the ‘like’ button for an uploaded content and indicates this number 4315 next to the ‘like’ button for the content, shown for example in FIG. 43.

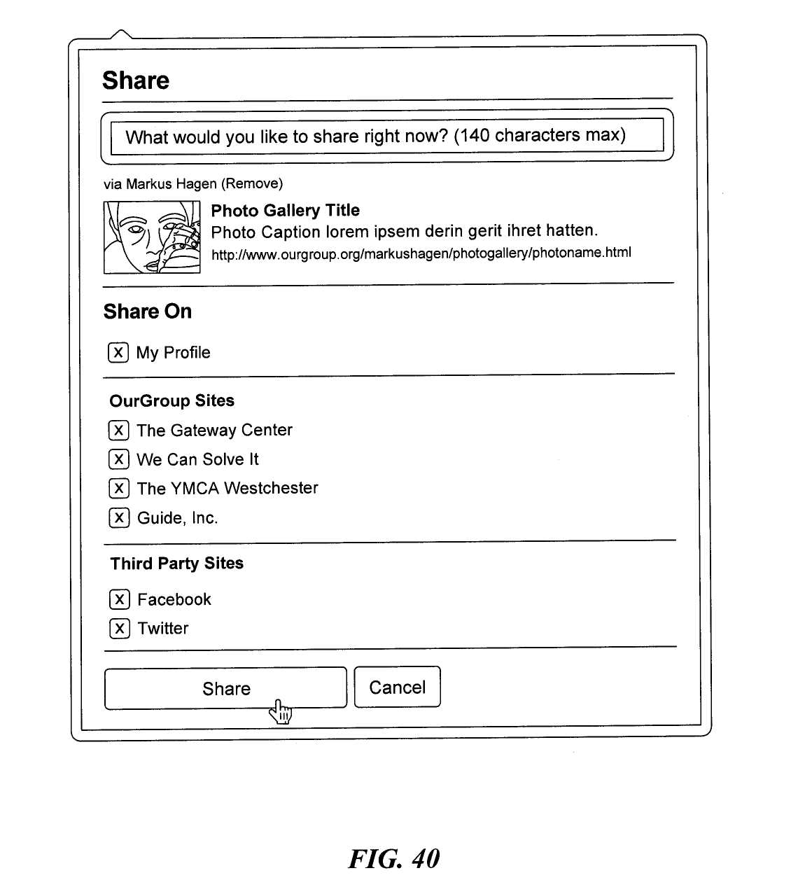

Upon clicking on the ‘share’ button, the user client is presented with the option of sharing the content on the user's profile, on sites within the online platform that the user is a member of, and on sites external to the online platform that the user client can select, for example, Facebook, MySpace, and Twitter. An example of the options presented to the user client is shown in FIG. 40.

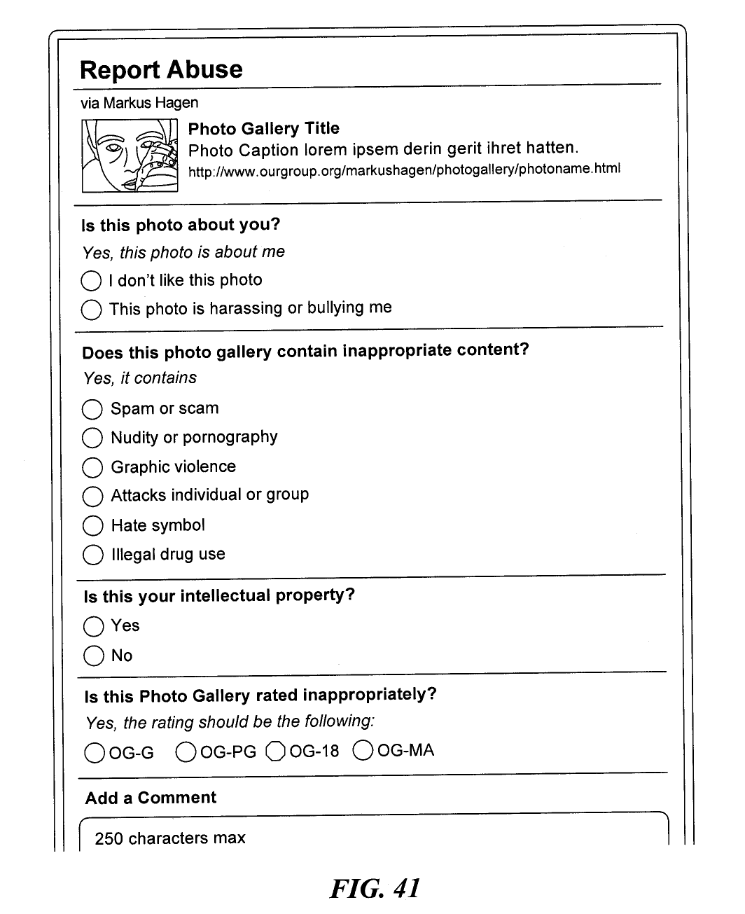

Upon clicking the ‘report abuse’ button, the user client is presented with queries. For example, if the user client is reporting abuse regarding a posted photo, the user client is asked whether the photo is about the user; if the photo gallery contains inappropriate content and what that inappropriate content is, for example, spam or scam, nudity or pornography, graphic violence, attacks individual or group, hate symbol, and illegal drug use; whether the photo is the user's intellectual property, and whether the photo gallery is rated inappropriately and what the rating should be. An example of the options presented to the user regarding a posted photo shown in FIG. 41.

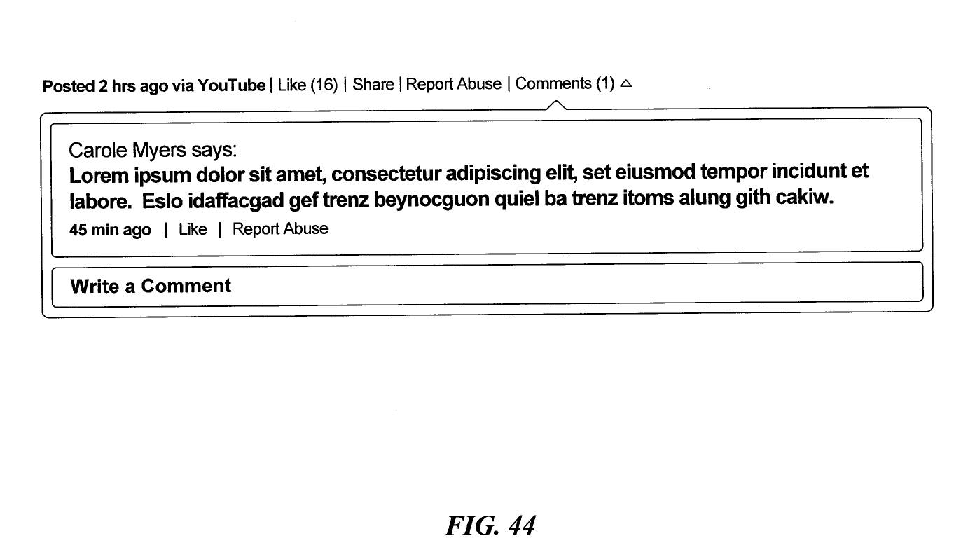

Upon clicking the ‘comment’ button, for example button 4310 in FIG. 43, a comment field 4320 is shown to the user client where the user can enter a comment. Similar to other content posted to the online platform, the comments can also have a feedback bar that may include functions such as the ‘like’ and ‘report abuse’ button and a field to enter a comment to the first comment, shown in the example of FIG. 44.

Supporters

In some embodiments, the host server 120 includes the supporter module 164 which queries and receives, stores, and maintains information in a supporters database 183 about a member who wishes to become a supporter. A supporter page is intended for individuals who feel strongly about an organization and want to support it without setting up a sub-group. The supporter page provides a quick way for an individual to tap into the individual's pool of friends for philanthropic purposes. The supporter page can be personalized by the supporter member client, for example, the supporter member client can include a statement about why of the member is interested in the group and upload relevant videos and photos. The information is maintained in a supporter web page by the supporter module 164 and stored in the supporters database 183.

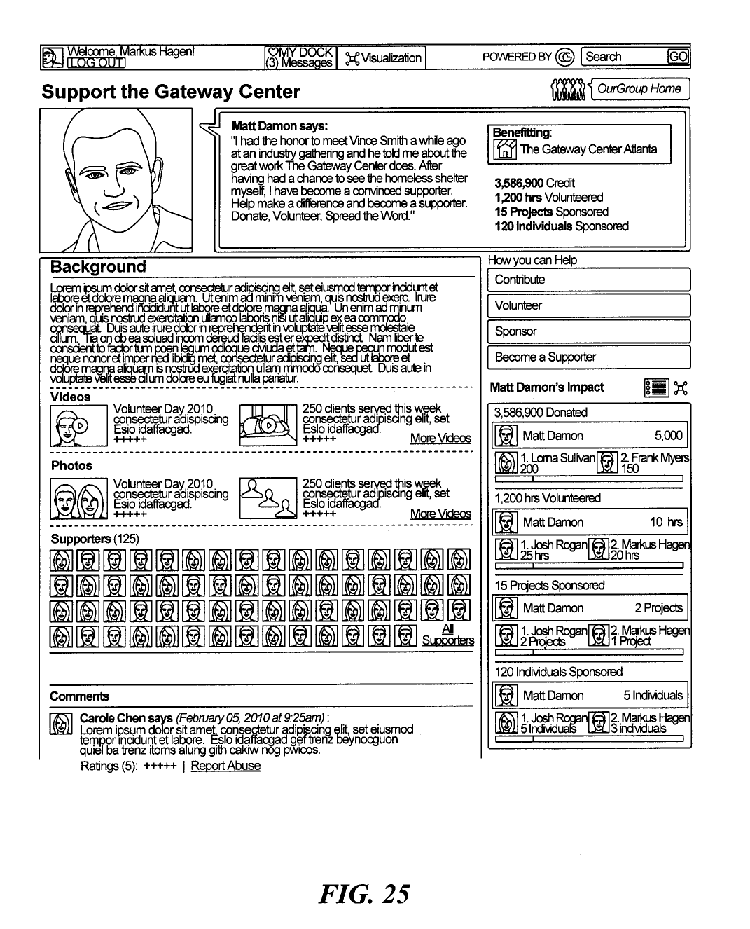

An example of a supporter page is shown in FIG. 25, where the supporter is Matt Damon. If Matt Damon publicizes, for example through a television or magazine advertisement, that he is a supporter of The Gateway, he can let people know that they can go to his supporter page at The Gateway to help the organization through him. Then people who go to his supporter page can contribute resources, volunteer, sponsor, and become a supporter, and all of these activities are tracked through Matt Damon's supporter page. In some embodiments, statistics of Matt Damon's impact can be included on the supporter page, for example, total amount of resources contributed through the page, total number of volunteer hours provided through the page, total number of projects sponsored through the page, and number of individuals sponsored through the page. The supporter and others can closely monitor the impact that the supporter has generated, such as resources contributed, volunteered hours, and projects and people sponsored. This tool can be useful to enable friendly competitions between supporters as to who can raise the most resources or encourage the largest number of volunteers for a given volunteer organization.

Thumbnail images of supporters of the main supporter (for example, Matt Damon) can be shown on the supporter page, and comments from people can also be listed on the page. Additionally, photos and/or videos can be uploaded to the supporter page by supporters and volunteers. The main supporter will be able to review the uploaded content and edit or delete any uploaded content.

The supporter page can also provide a button for the supporter client to click to publish contributed resources, volunteer hours generated or general affiliation with a cause and/or to recruit others to joining the cause by publishing the information on a social media networking site, such as Facebook, MySpace, and Twitter. By publishing the information, the supporter can virally grow the online platform's number of users.

Messaging within the Online Platform

In some embodiments, registered members are assigned email addresses by the registration module 152 for use between member clients within the environment of the online platform. The email module 170 facilitates the sending and receiving of emails within the online platform. As shown in FIG. 1B-5, the email module 170 can include, for example, an email transmission module 170a and/or an email receiving module 170b. In some embodiments, a member client can send and access received emails via a link provided on the collaboration webpage of a registered group. The email transmission module 170a can receive an online platform destination email address from a member client along with a message and deliver the email to the designated recipient member client. The email receiving module 170b can provide a listing of emails sent to a member client from other member clients. The email transmission module 170a and the email receiving module 170b work in conjunction to allow a member client to respond to a received email or forward a received email, as with a typical email system.

In some embodiments, a notifications module 171 can send notifications to a member client when another member client comments on information posted by the first member client. As shown in FIG. 1B-6, the notifications module 171 can include, for example, a comment monitoring module 171a, a notifications transmission module 171b, and/or a notifications receiving module 171c. The comment monitoring module 171a monitors comments provided by member clients through the webpages supported by the online platform. As discussed above, member clients can leave comments for posted items such as photos, videos, documents, stories, a tribute page, and messages. When the comment monitoring module 171 detects that a comment has been left by a member client, the member client that posted the item to which the comment pertains is sent a notification by the notifications transmission module 171b. The notification can include a name of the member client who left the comment, the item that was commented on, the comment, and how long ago the comment was left.

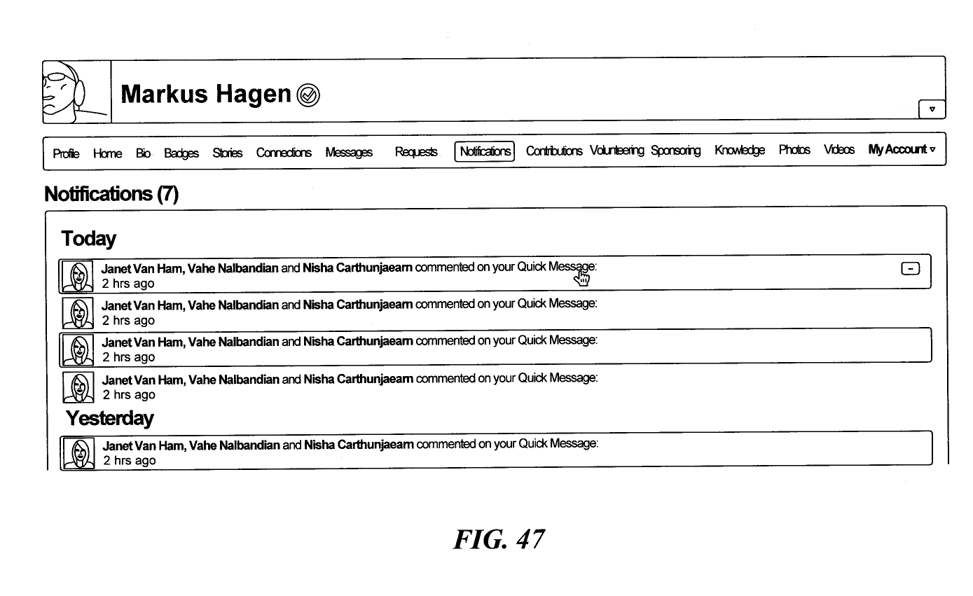

In some embodiments, a member client can receive notifications via a link provided on the collaboration webpage of a registered group. The notifications receiving module 171c can provide a chronological listing of notifications sent to a member client, as shown, for example, in FIG. 47.

In some embodiments, a request module 172 can send requests to a member client, such as an invitation to join a group or an invitation to connect with another member client. As shown in FIG. 1B-7, the request module 172 can include, for example, an invitation monitoring module 172a, a connection monitoring module 172b, a request transmission module 172c, and/or a request receiving module 172d.

The invitation monitoring module 172a works in conjunction with the request receiving module 152a to identify invitations sent by an administrator module of a group to a member client to join the group. When the invitation monitoring module 172a identifies that an invitation has been sent to a member client, the request transmission module 172c sends the request to the member client. The request can include an identification that a request has been issued to join a group, and the name of the group to which the member client is invited to join, and how long ago the invitation was issued.

The connection monitoring module 172b works in conjunction with the invitation module 158 to identify when a first member client has requested to connect with another member client. When the connection monitoring module 172b identifies that a connection request has been sent to a member client, the request transmission module 172c sends the request to the member client. The request can include an identification that a request has been issued to connect with the first member client, and the name of the first member client to which the member client is invited to connect, and how long ago the connection request was issued.

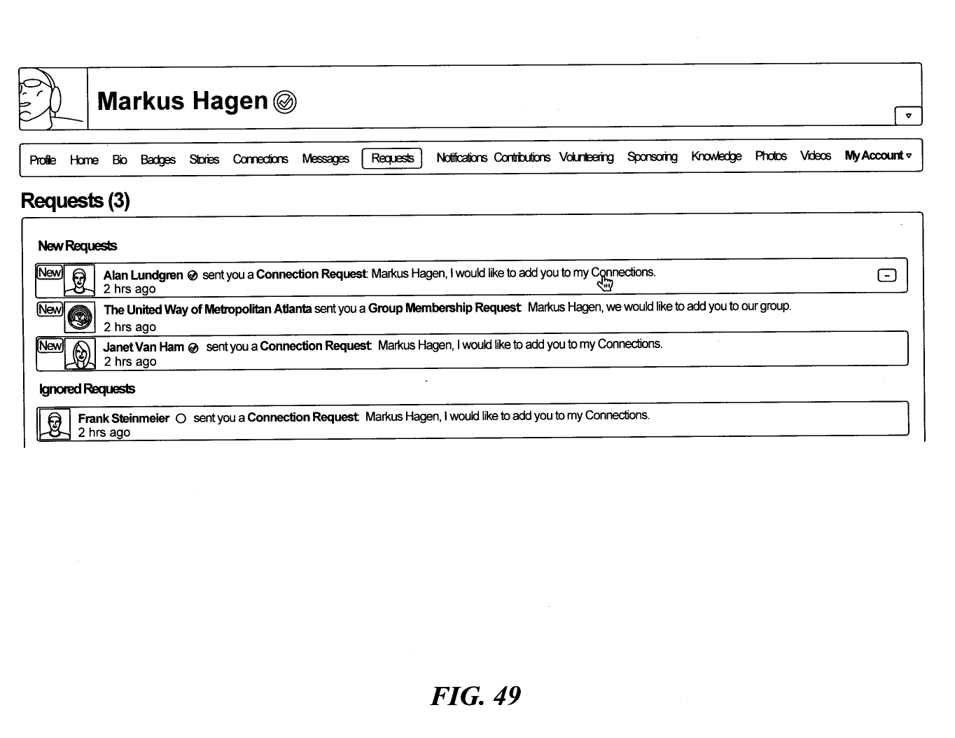

In some embodiments, a member client can receive requests via a link provided on the collaboration webpage of a registered group. The request receiving module 172d can provide a chronological listing of requests sent to a member client, as shown, for example, in FIG. 49.

The Dock

In some embodiments, the host server 120 includes the dock module 167 which supports each member client's personalized dock. FIG. 1B-4 depicts a block diagram illustrating an example of components in the dock module 167. The dock module 167 can include, for example, a dock display module 167a, a dock email menu module 167b, a profile receiving module 167c, and/or a profile page generation module 167d.

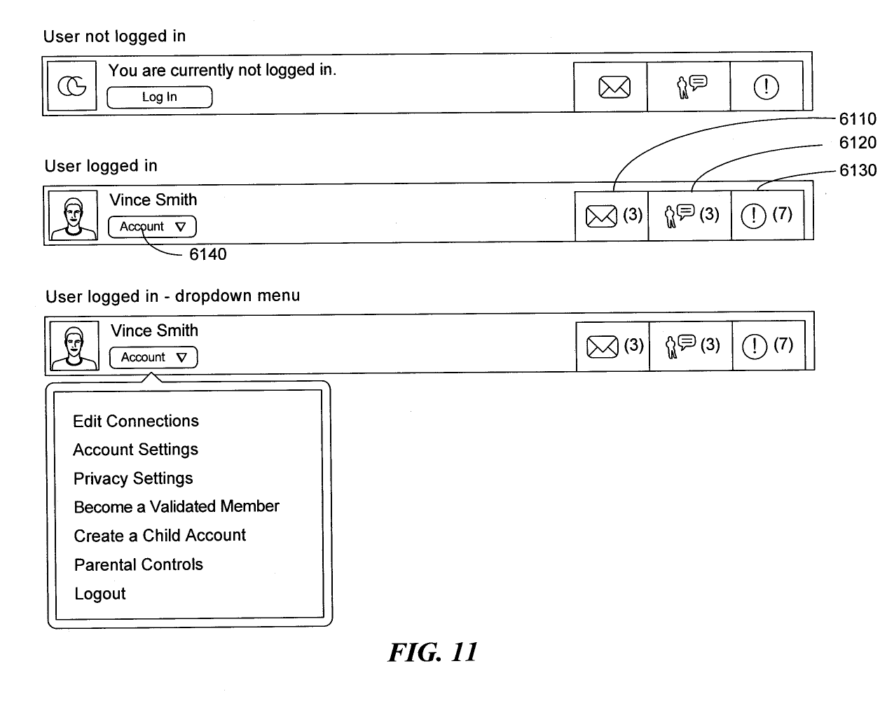

The dock display module 167a works in conjunction with the profile module 153 to determine when a client member has logged in to the online platform. When a member client signs in to the online platform, the dock display module 167b generates a personalized dock for the member client and causes it to be displayed at the top of the web page of the online platform that has been transmitted to the member client for viewing. The personalized dock has useful functionality that the member client can access without leaving the web page that was requested via the online platform. A dock 111 is shown in the example of FIG. 2 at the top of the screenshot. Example magnified views of the dock are shown in FIG. 11. When the member client is not logged in to the online platform, the dock is quiescent. When a member client logs in to the online platform, the dock display module 167a causes to be displayed a profile photo associated with the member and the members name on the left of the dock.

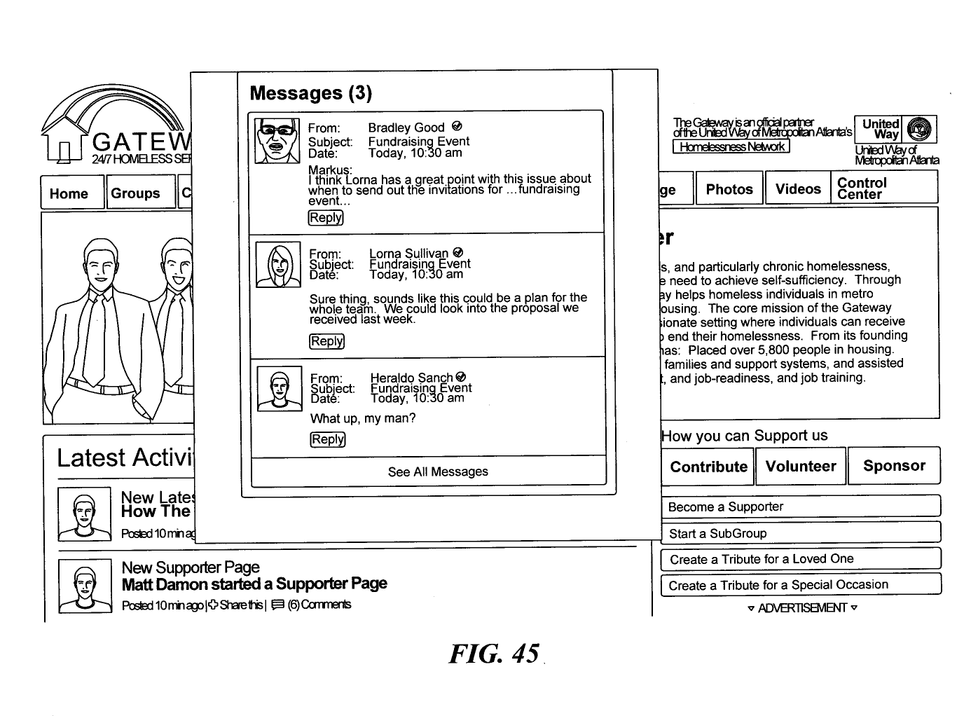

Additionally, the dock can include a clickable email button 6110 that shows the number of unread email messages received from other member clients within the online platform. Upon clicking the email button 6110, the dock display module 167a shows the messages in a dropdown format so that the member client does not leave the web page that is being viewed. An example is shown in FIG. 45. Upon clicking on an email message, the dock email menu module 167b provides the member client with a menu of email options, for example, replying, replying to all, forwarding, deleting, and printing the email message. The email menu module 167b works in conjunction with the email module 170 to allow the member client to perform the email options provided in the menu.

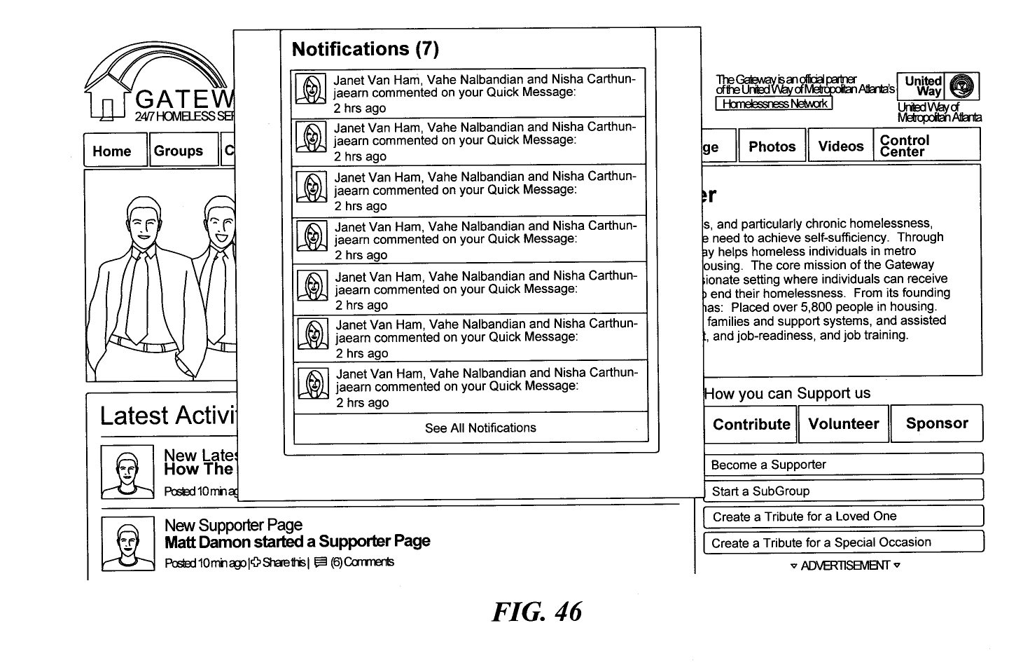

The dock can also include a clickable ‘notifications’ button 6130 that shows the number of new notifications received from within the online platform, such as another member client commenting on a message or other content that the member posted to the online platform. Upon clicking the ‘notifications’ button 6130 by the member client, the dock shows the notifications in a dropdown format. An example is shown in FIG. 46. By clicking on the button ‘see all notifications’ in the dropdown list, the member client is taken to a web page with a listing of notifications provided by the notifications receiving module 171c that can be ordered chronologically, as shown in the example of FIG. 47.

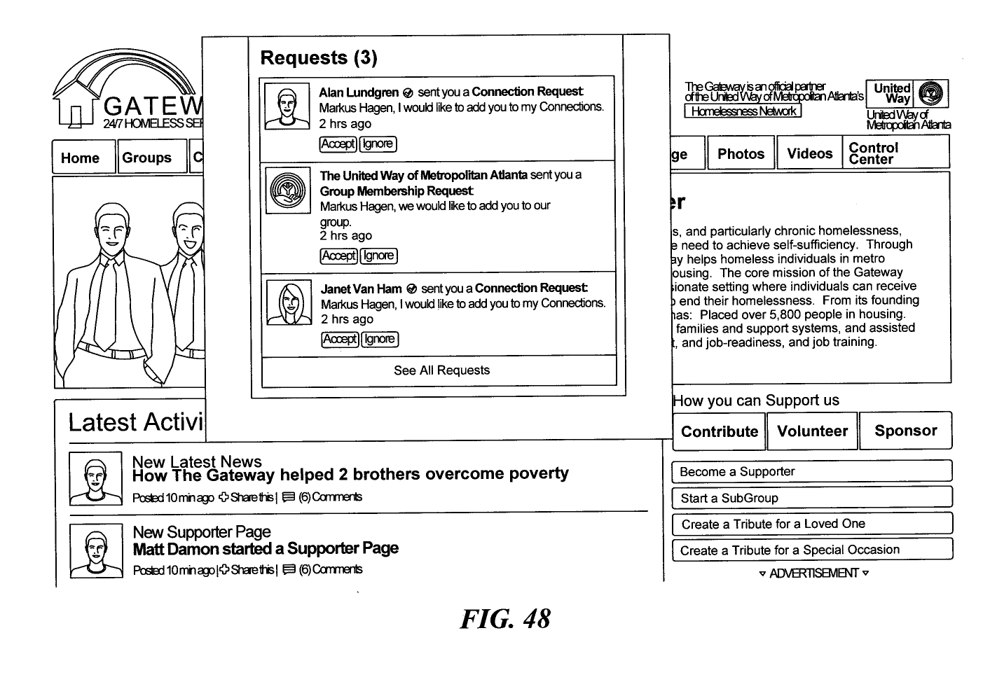

Similarly, the dock can include a clickable ‘requests’ button 6120 that shows the number of new requests, such as a connection request or a group membership request, in a dropdown format, as shown in FIG. 48. Upon clicking on the button ‘see all requests’ in the dropdown list, the member client is taken to a web page with a listing of requests provided by the request receiving module 172d that can be categorized by new requests and ignored requests, as shown in the example of FIG. 49.

In some embodiments, the dock can include a clickable ‘account’ button 6140 that, upon clicking, shows a dropdown menu of account options that the member client can select, for example, edit connections, account settings, privacy settings, become a validated member, create a child account, parental controls, and logout.

In some embodiments, by clicking on the dock 111, for example, on or near the profile photo, the member client is taken to the member's own landing page or user profile page on the online platform. As shown in the example of FIG. 35, the landing page includes basic information about the member client that other may be interested in knowing, for example, the types of badges the member has earned, the groups the member has joined, the members followers, who the member is following, the member's connections, and people the member may know.

From the member's landing page, the member client can access the toolbar 3510, shown in the example of FIG. 35. The toolbar 3510 includes clickable buttons for ‘messages’ which takes the member client to a full page that shows the members email messages, ‘requests’ which shows a full page with the member's requests from other member clients and groups of the online platform, and ‘notifications’ which shows a full page with notifications received by the member client. An example of the requests page is shown in FIG. 49.

Using the Online Platform

All of the software tools of the online platform described above are available to any group or organization that registers with the online platform. For example, a company can use the online platform as an umbrella group, and employees can join as members of the company. Then the company can automatically track the employees' validated volunteering hours and contributed resources. Additionally, when an employee shares a volunteering story, it can be posted to the company site as well, and the company can use it for public relations. Further, matching resource contribution, commonly provided by companies can be captured using the online platform tools. Like all groups, the company can be organized as an umbrella group and have a series of sub-groups beneath it hierarchically, organized to meet the company's needs.

Schools and students can also use the same online platform. The school can be organized as an umbrella group for sub-groups such as sports teams, classes, and academic clubs.

Non-profit organizations, like the YMCA, can also make use of the same online platform. The umbrella feature operates in the same way as described above, but with an additional function. For example, within the YMCA Westchester, if a user client clicks the ‘groups’ button on the landing page, all of the sub-groups that have been set up for different activities can be seen. As described above, all of the photos, videos, volunteer needs, etc. of the sub-groups will roll up to the umbrella organization. The function of the online platform is not just to raise resources for philanthropy, it also serves as a utility that enables group members to collaborate to get things done.

Assistance with the Online Platform

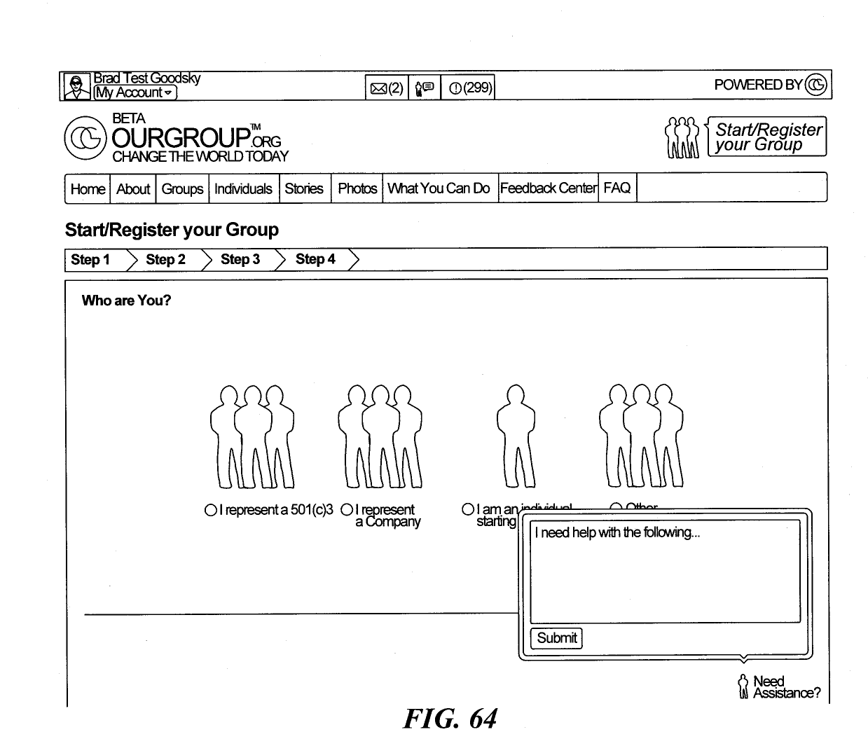

The help module 169 provides a link to assistance at the bottom of each webpage supported by the online platform, as shown in the example webpage in FIG. 64. When a user client clicks on the assistance link, the help module 169 opens a window where the user client can type in the type of assistance that is needed. Upon receiving a submission of needed assistance, the help module 169 can send the message as a notification or email to the administrator module of the online platform. Upon receiving a response from the administrator module, the help module 169 displays the response to the user client. Alternatively, the help module 169 can access an index of help files stored in the help database 193 and attempt to automatically provide the requested information.

Third-Party Support

In some embodiments, the online platform can develop close relationships with a few key vendors, such as IBM and Accenture, to provide consulting services to volunteer organizations and foundations to help develop business initiatives that use the software tools provided by the online platform. Alternatively or additionally, the third-party vendors can perform system integration work requested by clients. Thus, the third-party vendors become distributors for applications associated with the online platform.

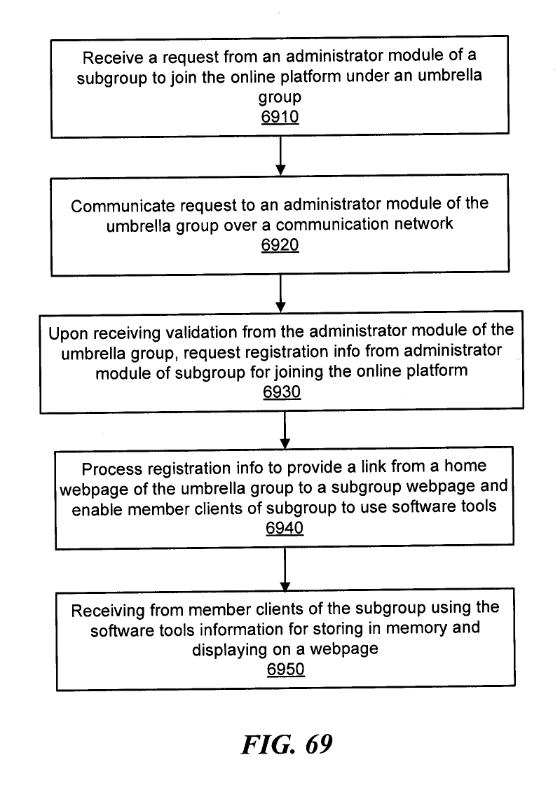

FIG. 69 depicts a flow diagram illustrating an example process performed by the host server of the online platform for permitting a first administrator module of an umbrella group to validate over a communication network a request by a subgroup to join the online platform under the umbrella group.

At block 6910, the server receives the request from a second administrator module of the subgroup to join the online platform under the umbrella group. Then at block 6920, the server communicates the request to the first administrator module over a communication network. Upon receiving over the communication network validation from the first administrator module for the subgroup to join the online platform under the umbrella group, at block 6930, the server requests registration information for joining the online platform from the second administrator module. The registration information may include a selection of a uniform resource locator for the second webpage.

Next, at block 6940, the server processes the registration information to provide a link from a first webpage associated with the umbrella group on the online platform to a second webpage associated with the subgroup on the online platform, and to enable member clients of the subgroup to use software tools available to member clients of registered groups of the online platform to facilitate communication of information among member clients of a given group and from member clients of the subgroup to member clients of the umbrella group. The second webpage is customizable by the second administrator module over the communication network via the server. Further, customization includes posting one or more items of subgroup news related to the subgroup on the second webpage, and further wherein a portion of each subgroup news item is automatically linked by the server to a news section on the first webpage, wherein the news section further includes one or more umbrella group news items posted by the first administrator module related to the umbrella group.

Then at block 6950, the server receives from member clients of the subgroup using the software tools information for storing in a memory and displaying on a specific webpage accessible directly from the second webpage. The information may include photos, videos, events supported by the subgroup, reviews of events supported by the subgroup, knowledge files, and/or resources provided by a member of the subgroup to the subgroup or an event supported by the subgroup. The information from member clients of the subgroup is available on one or more webpages accessible directly from the first webpage, and the one or more webpages are organized by topic to present related information. The information from member clients of other subgroups validated to join the online platform under the umbrella group is also available on the one or more webpages accessible directly from the first webpage.

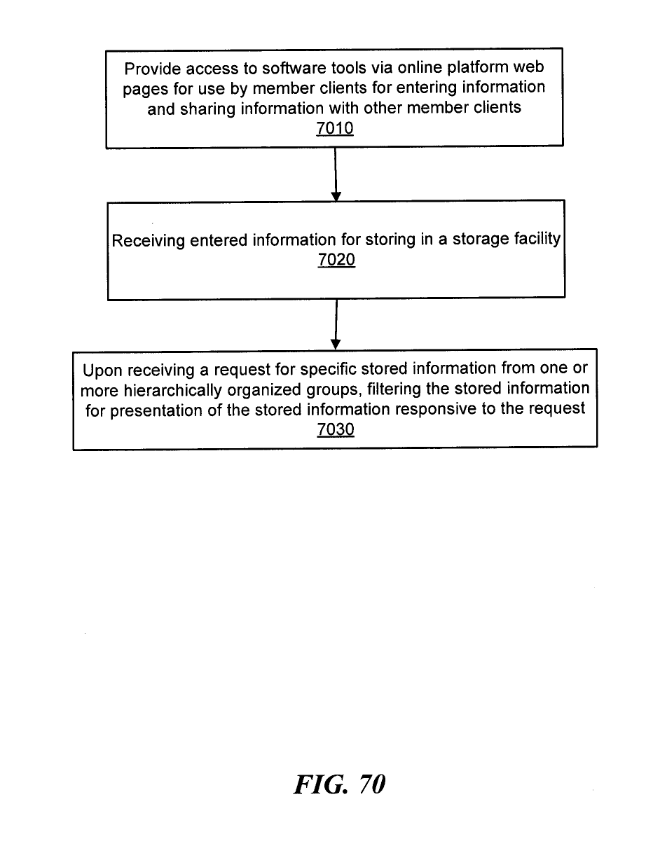

FIG. 70 depicts a flow diagram illustrating an example process performed by the host server of the online platform for aggregating and filtering information received from member clients of a plurality of groups registered with the online platform, wherein at least some of the groups are hierarchically organized.

At block 7010, the server provides access to software tools via webpages of the online platform for use by member clients of each of the plurality of groups to enter information for sharing with other member clients of a same group and member clients of groups in a hierarchy above the same group within the online platform.

Then at block 7020, the server receives the entered information for storing in a storage facility. Next, at block 7030, upon receiving a request for specific stored information aggregated over one or more hierarchically organized groups, the server filters the stored information for presentation of the specific stored information responsive to the request.

When a second group is hierarchically organized under an umbrella group, at least some of the information entered by member clients of the second group is accessible via webpages of the online platform associated with the umbrella group. The request for specific stored information aggregated over one or more hierarchically organized groups is restricted to member clients of a specific group hierarchically organized above the other one or more hierarchically organized groups whose member clients entered the information. The information entered by the member clients of each of the plurality of groups includes resources provided by a respective member to one or more of the plurality of groups. A request is received at the server via one of the webpages provided by the online platform. Further, the entered information may include photos, videos, events supported by a particular group, reviews of events sponsored by particular group, knowledge files and/or one or more resources provided by a member of a given group to the given group or an event sponsored by the given group.

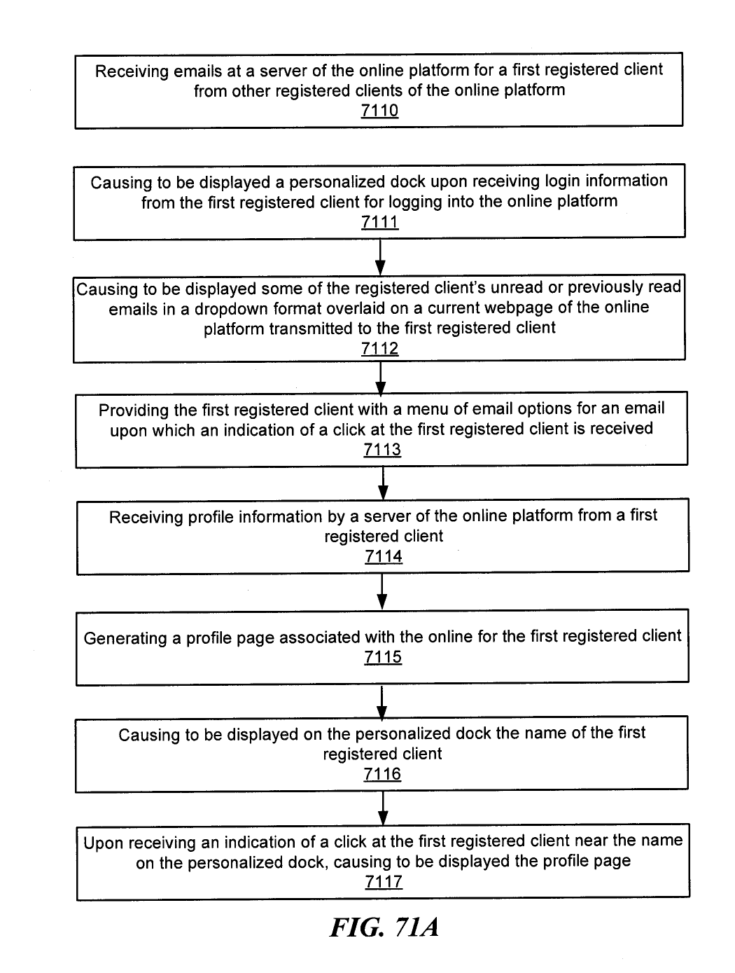

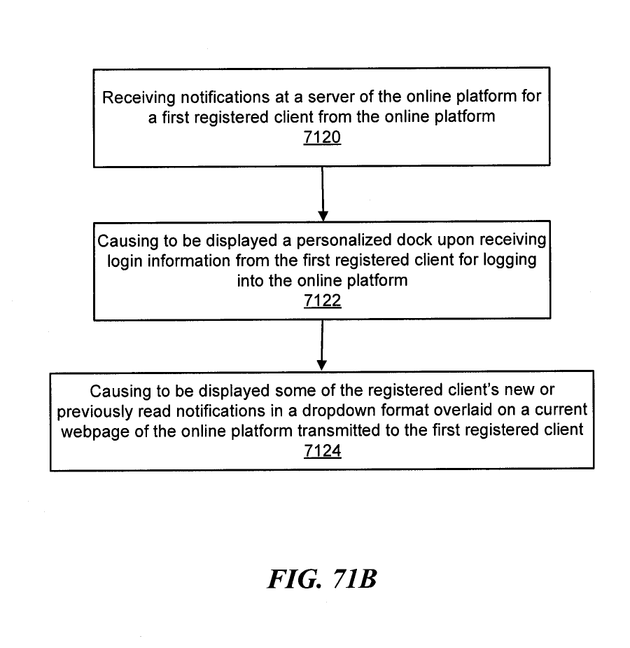

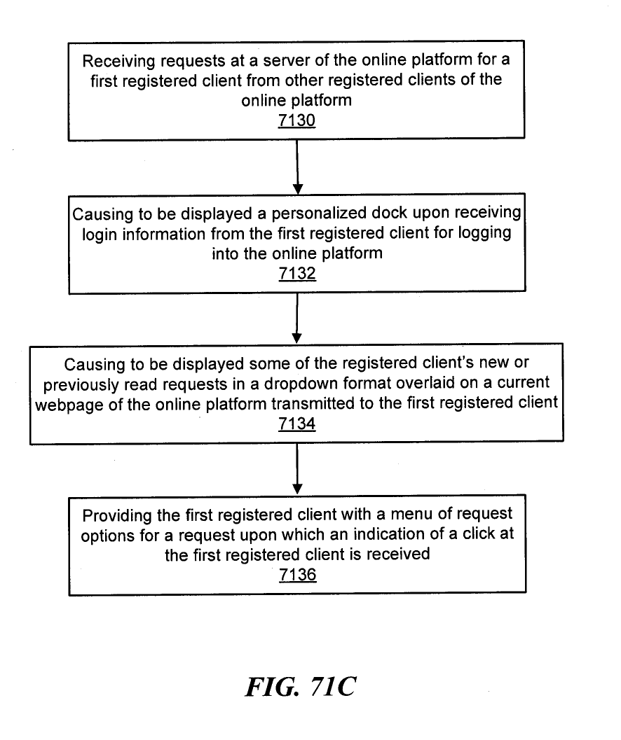

FIG. 71A depicts a flow diagram illustrating an example process performed by the host server of the online platform for providing access to emails intended for a registered client of an online platform to the registered client on each webpage associated with the online platform transmitted to the registered client.

At block 7110, the server of the online platform receives emails for a first registered client from other registered client of the online platform. Then at block 7111, upon receiving by the server login information from the first registered client for logging into the online platform, causing to be displayed a personalized dock, wherein the personalized dock is displayed on each webpage of the online platform transmitted to the first registered client, and further wherein the personalized dock provides an indication of a first number of unread emails that have been sent to the first registered client from other registered clients and a first clickable button for viewing emails.

Next, at block 7112, upon receiving an indication by the server of a click at the first registered client on the first clickable button, the server causes to be displayed at least some of the first registered client's unread or previously read emails in a dropdown format overlaid on a current webpage of the online platform being transmitted to the first registered client.

At block 7113, upon receiving an indication by the server of a click at the first registered client on one of the emails in the dropdown format, the server provides the first registered client with a menu of email options for the one of the emails. The dropdown format includes a clickable option to see all email messages for the first registered client on a separate webpage.

Then at block 7114, the server receives profile information from the first registered client, wherein profile information includes a name of the first registered client. And at block 7115, the server generates a profile page associated with the online platform for the first registered client.

Next, at block 7116, the server causes to be displayed on the personalized dock the name of the first registered client. Then, upon receiving an indication by the server of a click at the first registered client near the name on the personalized dock, the server causes to be displayed the profile page.

FIG. 71B depicts a flow diagram illustrating an example process performed by the host server of the online platform for providing access to notifications intended for a registered client of an online platform to the registered client on each webpage associated with the online platform transmitted to the registered client.

At block 7120, the server of the online platform receives notifications for a first registered client from the online platform. Then at block 7122, upon receiving by the server login information from the first registered client for logging into the online platform, causing to be displayed a personalized dock, wherein the personalized dock is displayed on each webpage of the online platform transmitted to the first registered client, and further wherein the personalized dock provides an indication of a first number of new notifications that have been sent to the first registered client from the system and a first clickable button for viewing emails.

Next, at block 7124, upon receiving an indication by the server of a click at the first registered client on the first clickable button, the server causes to be displayed at least some of the first registered client's new or previously read notifications in a dropdown format overlaid on a current webpage of the online platform being transmitted to the first registered client.

FIG. 71C depicts a flow diagram illustrating an example process performed by the host server of the online platform for providing access to requests intended for a registered client of an online platform to the registered client on each webpage associated with the online platform transmitted to the registered client.

At block 7130, the server of the online platform receives requests for a first registered client from other registered client of the online platform. Then at block 7132, upon receiving by the server login information from the first registered client for logging into the online platform, causing to be displayed a personalized dock, wherein the personalized dock is displayed on each webpage of the online platform transmitted to the first registered client, and further wherein the personalized dock provides an indication of a first number of unread requests that have been sent to the first registered client from other registered clients and a first clickable button for viewing requests.

Next, at block 7134, upon receiving an indication by the server of a click at the first registered client on the first clickable button, the server causes to be displayed at least some of the first registered client's new or previously read requests in a dropdown format overlaid on a current webpage of the online platform being transmitted to the first registered client.

At block 7136, upon receiving an indication by the server of a click at the first registered client on one of the requests in the dropdown format, the server provides the first registered client with a menu of request options for the one of the requests. The dropdown format includes a clickable option to see all requests for the first registered client on a separate webpage.

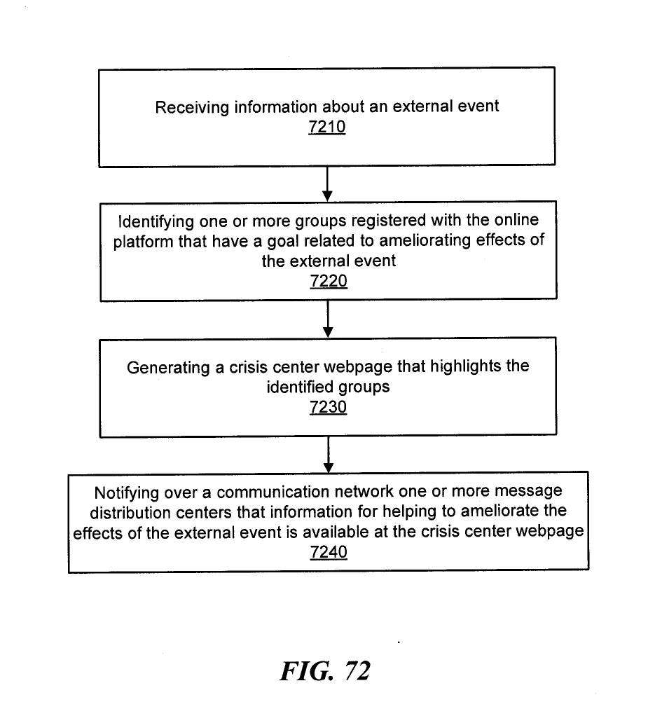

FIG. 72 depicts a flow diagram illustrating an example process performed by the host server of the online platform for selecting one or more groups registered with an online platform for highlighting on a crisis center webpage associated with an external event.

At block 7210, the server receives information about the external event. Then at block 7220, the server identifies one or more groups registered with the online platform that has a goal related to ameliorating effects of the external event. Next, at block 7230, the server generates the crisis center webpage that highlights the identified one or more groups. Then, at block 7240, the server notifies one or more message distribution centers over a communication network that information for helping to ameliorate the effects of the external event is available at the crisis center webpage.

The crisis center webpage can list information about other external events, include information for joining the identified one or more groups, and/or include information for providing resources to the identified one or more groups. Further, users not registered with the online platform can access the crisis center webpage.

Summary

The online platform and its tools are designed to help causes involve members, grow supporters, and conduct marketing campaigns. The security and confidentiality of member information can be guaranteed by a partner and audited by a third-party. Further, the online platform provides a safe environment for people to interact with each other, and members can choose to have their identities validated by the platform.

Machine System

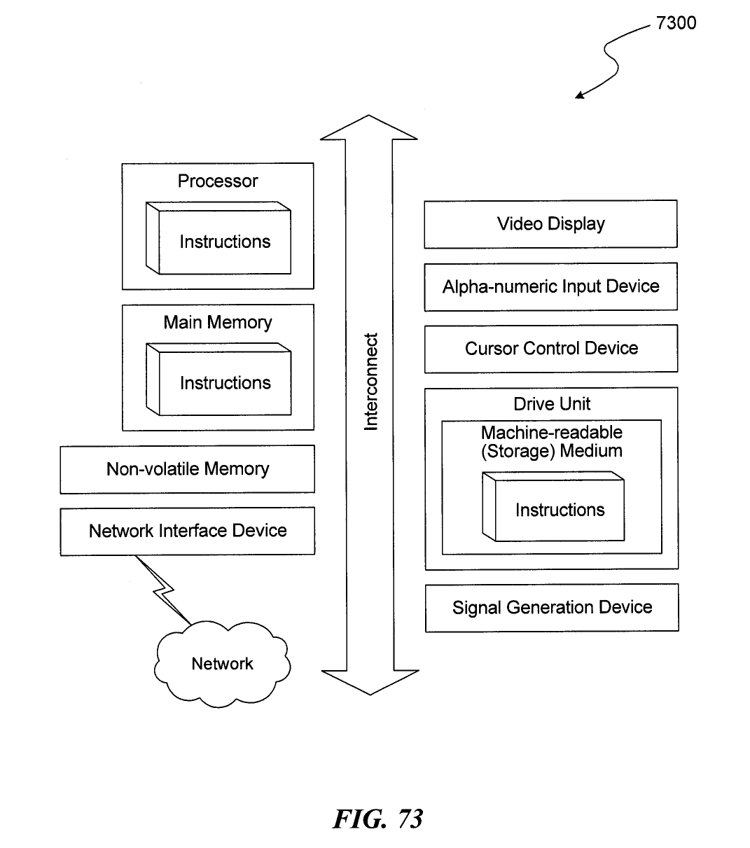

FIG. 73 shows a diagrammatic representation of a machine 7300 in the example form of a computer system within which a set of instructions, for causing the machine to perform any one or more of the methodologies discussed herein, may be executed

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a user device, a tablet PC, a laptop computer, a set-top box (STB), a personal digital assistant (PDA), a cellular telephone, a smart phone, a tablet, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device enables the machine 6200 to mediate data in a network with an entity that is external to the host server, through any known and/or convenient communications protocol supported by the host and the external entity. The network interface device can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

### CONCLUSION

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or subcombinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention.

What is claimed is:

1. A method of providing access to information intended for a registered client of an online platform to the registered client on each webpage associated with the online platform transmitted to the registered client, the method comprising:
receiving one or more emails at a server of the online platform for the first registered client from one or more other registered clients of the online platform;
upon receiving by the server login information from the first registered client for logging into the online platform, causing to be displayed a personalized dock, wherein the personalized dock is displayed on each webpage of the online platform transmitted to the first registered client, and further wherein the personalized dock provides an indication of a first number of unread emails that have been sent to the first registered client from other registered clients and a first clickable button for viewing emails;
upon receiving an indication by the server of a click at the first registered client on the first clickable button, causing be displayed at least some of the first registered client's unread or previously read emails in a dropdown format overlaid on a current webpage of the online platform being transmitted to the first registered client.

2. The method of claim 1, further comprising:
upon receiving an indication by the server of a click at the first registered client on one of the emails in the dropdown format, providing the first registered client with a menu of email options for the one of the emails.

3. The method of claim 1, wherein the dropdown format includes a clickable option to see all email messages for the first registered client on a separate webpage.

4. The method of claim 1, further comprising:
receiving one or more notifications at the server for the first registered client of the online platform, wherein a notification is a result from one or more other registered clients of the online platform on content the first registered client posted to the online platform, wherein the personalized dock further includes an indication of a second number of new notifications for the first registered client and a second clickable button for viewing notifications;
upon receiving an indication by the server of a click by the first registered client on the second clickable button, causing to be displayed at least some of the first registered client's new or previously read notifications in the dropdown format overlaid on the current webpage of the online platform being transmitted to the first registered client.

5. The method of claim 4, wherein the dropdown format includes a clickable option to see all notifications for the first registered client on a separate webpage.

6. The method of claim 1, further comprising:
receiving one or more requests at the server for the first registered client of the online platform, wherein a request includes a connection request from another registered client of the online platform or a group membership request to join a particular group associated with the online platform, wherein the personalized dock further includes an indication of a third number of new requests for the first registered client and a third clickable button for viewing the requests;
upon receiving an indication by the server of a click at the first registered client on the third clickable button, causing to be displayed at least some of the first registered client's new or previously read requests in the dropdown format overlaid on the current webpage of the online platform being transmitted to the first registered client.

7. The method of claim 6, wherein the dropdown format includes a clickable option to see all requests for the first registered client on a separate webpage.

8. The method of claim 1, further comprising:
receiving by the server profile information from the first registered client, wherein profile information includes a name of the first registered client;
generating by the server a profile page associated with the online platform for the first registered client;
causing to be displayed by the server on the personalized dock the name of the first registered client;
upon receiving an indication by the server of a click at the first registered client near the name on the personalized dock, causing to be displayed the profile page.

9. A server for providing access to information intended for a registered client of an online platform to the registered client on each webpage associated with the online platform transmitted to the registered client, the server comprising:
an email receiving module configured to receive one or more emails for the first registered client from one or more other registered clients of the online platform;
a dock display module configured to cause to be displayed a personalized dock upon receiving login information from the first registered client for logging into the online platform, wherein the personalized dock is displayed on each webpage of the online platform transmitted to the first registered client, and further wherein the personalized dock provides an indication of a first number of unread emails that have been sent to the first registered client from other registered clients and a first clickable button for viewing emails,
wherein the dock display module is further configured to cause to be displayed at least some of the first registered client's unread or previously read emails in a dropdown format overlaid on a current webpage of the online platform being transmitted to the first registered client upon receiving an indication of a click at the first registered client on the first clickable button.

10. The server of claim 9, further comprising:
a dock email menu module configured to, upon receiving an indication by the server of a click at the first registered client on one of the emails in the dropdown format, provide the first registered client with a menu of email options for the one of the emails.

11. The server of claim 9, wherein the dropdown format includes a clickable option to see all email messages for the first registered client on a separate webpage.

12. The server of claim 9, further comprising:
a notifications receiving module configured to receive one or more notifications for the first registered client of the online platform, wherein a notification is a result from one or more other registered clients of the online platform on content the first registered client posted to the online platform, wherein the personalized dock further includes an indication of a second number of new notifications for the first registered client and a second clickable button for viewing notifications,
wherein the dock display module is further configured to, upon receiving an indication of a click by the first registered client on the second clickable button, cause to be displayed at least some of the first registered client's new or previously read notifications in the dropdown format overlaid on the current webpage of the online platform being transmitted to the first registered client.

13. The server of claim 12, wherein the dropdown format includes a clickable option to see all notifications for the first registered client on a separate webpage.

14. The server of claim 9, further comprising:
a request receiving module configured to receive one or more requests for the first registered client of the online platform, wherein a request includes a connection request from another registered client of the online platform or a group membership request to join a particular group associated with the online platform, wherein the personalized dock further includes an indication of a third number of new requests for the first registered client and a third clickable button for viewing the requests,
wherein the dock display module is further configured to, upon receiving an indication by the server of a click at the first registered client on the third clickable button, cause to be displayed at least some of the first registered client's new or previously read requests in the dropdown format overlaid on the current webpage of the online platform being transmitted to the first registered client.

15. The server of claim 14, wherein the dropdown format includes a clickable option to see all requests for the first registered client on a separate webpage.

16. The server of claim 9, further comprising:
a profile receiving module configured to receive profile information from the first registered client, wherein profile information includes a name of the first registered client;
a profile page generation module configured to generate a profile page associated with the online platform for the first registered client,
wherein the dock display module is further configured to cause to be displayed on the personalized dock the name of the first registered client, and
further wherein the dock display module is further configured to, upon receiving an indication of a click at the first registered client near the name on the personalized dock, cause to be displayed the profile page.
